(19) United States
(12) Patent Application Publication
(10) Pub. No.: US 2006/0172232 A1
(43) Pub. Date: Aug. 3, 2006

(54) Stabilization processing composition of silver halide light-sensitive color photographic material and processing method using the same

(75) Inventor: Kenji Ishida, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/337,923

(22) Filed: Jan. 23, 2006

(30) Foreign Application Priority Data
Jan. 31, 2005 (JP) JP2005-022543

(51) Int. Cl. G03C 1/46

(52) U.S. Cl. 430/502

(57) ABSTRACT

A stabilization processing composition for processing a silver halide light-sensitive color photographic material, wherein the stabilization processing composition contains a compound represented by Formula (I); and a molar ratio of ammonium ions in the stabilization processing composition to a total mole of cations in the stabilization processing composition is less than 50 mol %.

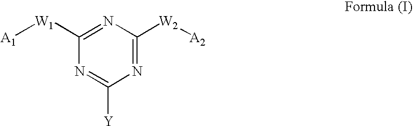

This application is based on Japanese Patent Application No. 2005-022543 filed on Jan. 31, 2005 in Japanese Patent Office, the entire content of which is hereby incorporated by reference.

### TECHNICAL FIELD

The present invention relates to a stabilization processing composition of silver halide light-sensitive color photographic materials employed in the stabilization process for silver halide light-sensitive color photographic material (hereinafter also referred to as light-sensitive material) and a processing method using the same, and in more detail, to a stabilization processing composition which minimizes jamming and abrasion of silver halide light-sensitive color photographic materials due to solids formed in the interior and exterior of the stabilization processing tank and also retards formation of yellow stains during storage of images at high temperature, and a processing method using the same.

### BACKGROUND

The photographic processing of silver halide light-sensitive color photographic materials is generally and primarily composed of a color development process, a desilvering process, and a stabilization process. Of these, the stabilization process is a necessary process so that silver halide light-sensitive color photographic materials after the development process result in stable quality. Consequently, listed as performance required for the stabilization process are improvement of retention property over an extended period of time and enhancement of background whiteness.

On the other hand, in recent years, it has become common that on-site photo-finishing services called a mini-lab shop are produced. For such services, essentials of the automatic processor, which performs the photographic processing, are a decrease in overall-size and elimination of a washing process which is plumbing-free for washing. In order to eliminate the washing process, it is typical that the conventional washing process is replaced with a stabilization process, and its replenishment rate is decreased. However, realization of such a system results in the drawback that the retention time of a stabilizer tends to be prolonged in the stabilization process. Such prolonged retention time results in degradation of components in the processing solution, and further degradation of quality of silver halide light-sensitive color photographic materials. Specifically, in recent years, due to an appearance of too many mini-labs and a marked decrease in print orders per shop caused by digitization, a decrease in the order amount per shop has been pronounced. As a result, extension of the retention time of the processing solution is unavoidable, for which demanded is enhancement of the stability of the processing solution itself. In order to overcome the above drawbacks, it has become necessary to incorporate preservers (being commonly antioxidants) to enhance the stability of the processing solution itself.

As noted above, various kinds of performance are required for the stabilization process and the addition of various additives makes it possible to result in such performance.

However, when the salt concentration of a stabilizer increases due to the addition of such additives, solids of the stabilizer or rinsing solution were formed at the liquid boundary of a stabilization processing tank and on the racks, causing problems of jamming in the automatic processors during conveyance, or the maximum density of silver halide light-sensitive color photographic materials after drying decreased due to adhesion of the resulting solids to the above silver halide light-sensitive color photographic materials which had been processed. Further, such an increase in the salt concentration of the stabilizer resulted in problems in which when processed silver halide light-sensitive photographic materials were stored at relatively high temperature over an extended period of time, yellow stain resulted. The present situation is such that it is extremely difficult to overcome the above problems of the stabilizer.

Further, in recent years, in the digital image processing market, a rapid print system is a differentiated item. Consequently, each mini-lab shop desires to achieve rapid finishing. Under such circumstance, the ion concentration in the stabilizer tends to increase, whereby the above problems have become more critical.

To minimize the generation of sludge in the stabilizer and the formation of stains described above, various methods have been proposed. For example, proposed are a processing method (refer, for example, to Patent Document 1) in which the generation of sludge is decreased under conditions in which cyclic aldehyde is incorporated in a stabilizer, and the contact area with air in a processing tank employing the above stabilizer for processing is specified, a processing method (refer, for example, to Patent Document 2) which minimizes the generation of sludge and the formation of stain by incorporating 2-methyl-4,5-trimethylene-4-isothiazoline-3-one into the processing solution, a processing method (refer, for example, to Patent Document 3) which minimizes the generation of sludge by employing nonionic surface active agents in a processing solution, or a processing method which minimizes the generation of sludge and the formation of stain by incorporating novel chelating agents as well as bactericides and fungicides. In the present situation in which rapid processing or reduced replenishment processing has progressed, the above-proposed methods do not simultaneously minimize the generation of sludge and the formation of stain, whereby it is urgent to develop an improvement method.

(Patent Document 1) Japanese Patent Publication Open to Public Inspection (hereinafter referred to as JP-A) No. 5-80477

(Patent Document 2) JP-A No. 10-10694

(Patent Document 3) JP-A No. 2002-323741

(Patent Document 4) JP-A No. 6-12395474

### SUMMARY

In view of the above problems, the present invention was achieved. An object of the present invention is to provide a stabilization processing composition for a silver halide light-sensitive color photographic material, which decreases solids formed in the stabilization process and minimizes degradation of print quality due to the solids, and retards the formation of yellow stain when the processed silver halide light-sensitive color photographic material is stored at high temperature, and a processing method using the same.

The above object of the present invention is achieved by employing the following embodiments.

(1) An embodiment of the present invention includes a stabilization processing composition of a silver halide light-sensitive color photographic material, which is employed in a photographic process of a silver halide light-sensitive color photographic material, a stabilization processing composition comprising the compound represented by following Formula (I) in which the ammonium ion ratio is less than 50 mol percent with respect to the total comprised cations. 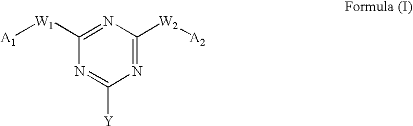
wherein A₁ and A₂ each independently represent a hydrogen atom, a halogen atom, an aryl group, a heterocyclic group, or an alkyl group; Y represents a hydrogen atom, a thiol group, a halogen atom, a carboxyl group, a sulfo group, a hydroxylamino group, a —NR₁R₂, —SR₃, or —OR₃; W₁ represents a single linking means, —O—, —S—, or —NR₄—; W₂ represents —O—, —S—, or —NR₄—; and R₁, R₂, R₃, and R₄ each represent a hydrogen atom, an alkyl group, an alkenyl group, an aryl group, or a heterocyclic group. R₁ and R₂, R₄ and A₁, as well as R₄ and A₂ bond to each other to form a ring. However, an azo group or a diaminostilbene structure is not included in the molecule represented by above Formula (I).

(2) Another embodiment of the present invention includes a stabilization processing composition of a silver halide light-sensitive color photographic material described in the above-mentioned item 1 wherein the compound represented by said Formula (I) is the one represented by following Formulas (II) or (III). 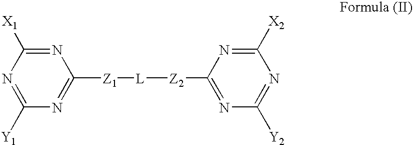
wherein X₁, X₂, Y₁, and Y₂ each, independently represent —N(R₁)R₂, —OR₃, —SR₃, a heterocyclic group, a hydroxyl group, a hydroxylamino group, or a halogen atom; Z₁ and Z₂ each represent —NR₄—, —O—, or —S—; L represents an arylene group, an alkylene group, an alkenylene group, or a heterocyclic group; R₁ and R₂ each represent a hydrogen atom, an alkyl group, an aryl group, or a heterocyclic group; R₃ represents an alkyl group, an aryl group, or a heterocyclic group; and R₄ represents a hydrogen atom, an aryl group, a heterocyclic group, or an alkyl group. R₁ and R₂ may bond to each other to form a nitrogen-containing ring. However, neither an azo group nor a diaminostilbene structure is included in the molecule represented by above Formula (II). 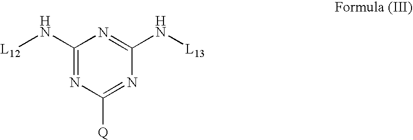
wherein L₁₂ and L₁₃ may be the same or different and each represent an aryl group or a heterocyclic group; Q represents a hydrogen atom, a thiol group, a carboxyl group, a sulfo group, —NR₅R₆, —OR₇, a hydroxylamino group, or a halogen atom; and R₅, R₆, and R₇ each represent a hydrogen atom, an alkyl group, an aryl group, or a heterocyclic group. R₅ and R₆ may bond to each other to form a ring. However, in the molecule represented by said Formula (III), at least one of the groups represented by —SO₃M, —CO₂M, or —OH, wherein M represents a hydrogen atom, an alkaline metal, an alkaline earth metal, ammonium, or pyridinium. However, an azo group or a diaminostilbene structure is not included in the molecule represented by above Formula (III).

(3) Another embodiment of the present invention includes a stabilization processing composition of a silver halide light-sensitive color photographic material described in the above-mentioned item 2 wherein the compound represented by said Formula (II) is at least one of those selected from the compounds represented by following Formulas (II-1)-(II-4). 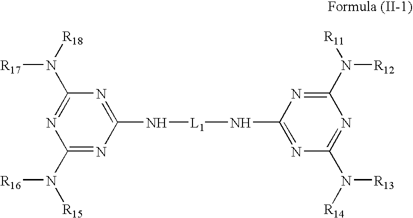
wherein R₁₁-R₁₈ each independently represent a hydrogen atom, an alkyl group, an aryl group, or a heterocyclic group, and L₁ represents a phenylene group or a naphthylene group. At least 3 of R₁₁-R₁₈ are aryl groups. Further, R₁₁ and R₁₂, R₁₃ and R₁₄, R₁₅ and R₁₆, as well as R₁₇ and R₁₈ may bond to each other to form a ring. However, in the molecule represented by Formula (II-1), comprised is at least one of the groups represented by —SO₃M, —CO₂M, and —OH, wherein M represents an alkaline metal ion, or an ammonium ion. Further, neither the group represented by —N═N— nor a diaminostilbene structure is included in the molecule represented by Formula (II-1). 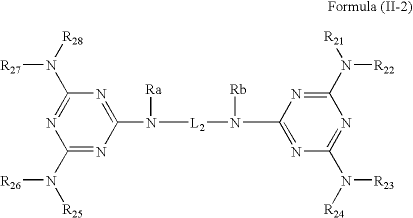
wherein R₂₁-R₂₈ each independently represent a hydrogen atom, an alkyl group, an aryl group, or a heterocyclic group; L₂ represents a phenylene group, a naphthylene group, an alkylene group, or a heterocyclic group; Ra represents an alkyl group, an aryl group, or a heterocyclic group; and Rb represents a hydrogen atom, an alkyl group, or an aryl group. R₂₁ and R₂₂, R₂₃ and R₂₄, R₂₅ and R₂₆, as well as R₂₇ and R₂₈ may bond to each other to form a ring. However, in the compounds represented by Formula (II-2) comprised in the molecule is at least one of the groups represented by —SO₃M, —CO₂M, and —OH, wherein M represents an alkaline metal ion, or an ammonium ion. Further, neither —N═N— nor a diaminostilbene structure is included in the molecule represented by above Formula (II-2). 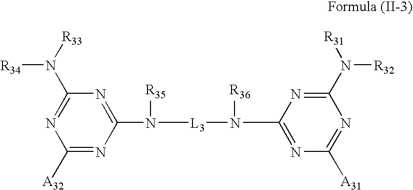
wherein R₃₁-R₃₄ each independently represent a hydrogen atom, an alkyl group, an aryl group, or a heterocyclic group; L₃ represents a phenylene group, a naphthylene group, an alkylene group, or a heterocyclic group; A₃₁ and A₃₂ each independently represent an alkoxy group, an aryloxy group, a heterocyclic oxy group, an alkylthio group, an arylthio group, a heterocyclic thio group, or a hydroxylamino group; and R₃₅ and R₃₆ each independently represent a hydrogen atom, an alkyl group, an aryl group or a heterocyclic group. R₃₁ and R₃₂, as well as R₃₃ and R₃₄ may bond to each other to form a ring. However, in the compounds represented by Formula (II-3) comprised in the molecule is at least one of the groups represented by —SO₃M, —CO₂M, and —OH, wherein M represents an alkaline metal ion, or an ammonium ion. Further, neither —N═N— nor a diaminostilbene structure is included in the molecule of the compound represented by above Formula (II-3). 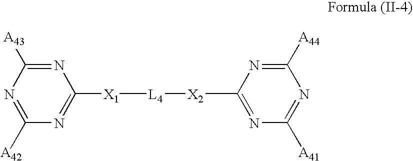
wherein L₄ represents a phenylene group a naphthylene group, or an alkylene group; X₁ represents a oxygen atom or a sulfur atom; X₂ represents an oxygen atom, a sulfur atom, or —NH—; and A₄₁, A₄₂, A₄₃, and A₄₄ each independently represent an alkoxy group, an aryloxy group, a heterocyclic oxy group, an alkylthio group, an arylthio group, a heterocyclic thio group, a hydroxylamino group, or —NR₄₁R₄₂ (R₄₁ and R₄₂ each independently represent a hydrogen atom, an alkyl group, an aryl group, or a heterocyclic group, and R₄₁ and R₄₂ may bond to each other to form a ring). However, in the compounds represented by Formula (II-4) comprised in the molecule is at least one of the groups represented by —SO₃M, —CO₂M, and —OH, wherein M represents an alkaline metal ion, or an ammonium ion. Further, neither —N═N— nor a diaminostilbene structure is included in the molecule represented by above Formula (II-4).

(4) Another embodiment of the present invention includes a stabilizing processing solution for a working solution comprising the stabilization processing composition in any one of the above-mentioned item 1-3,

wherein an amount of the compound represented by Formula (I) is from 0.1 to 20 mmol per liter.

(5) Another embodiment of the present invention includes a stabilization processing composition of a silver halide light-sensitive color photographic material, described in any one of the above-mentioned items 1-4, comprising the compound represented by the following Formula (IV). 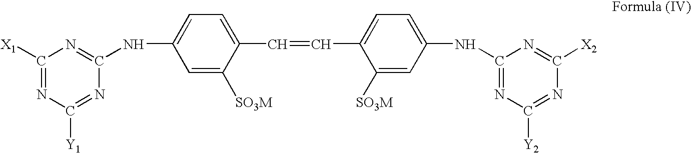
wherein X₁, X₂, Y₁, and Y₂ each represent a hydroxyl group, a halogen atom, a morpholino group, an alkoxy group, an aryloxy group, an alkyl group (for example, methyl or ethyl), an aryl group, an amino group, an alkylamino group, or an arylamino group, and M represents a hydrogen atom, sodium, potassium, ammonium, or lithium.

(6) Another embodiment of the present invention includes a stabilization processing composition of a silver halide light-sensitive color photographic material, described in any one of the above-mentioned items 1-5, wherein said stabilization processing composition is in the form of a solid processing agent.

(7) Another embodiment of the present invention includes a processing method of a silver halide light-sensitive color photographic material in which said silver halide light-sensitive color photographic material is processed via a color development process, a desilvering process, and a stabilization process, wherein a stabilizer employed in said stabilization process comprises the compound represented by following Formula (I), the ammonium ion ratio is less than 50 mol percent with respect to all the comprised cations, and the replenishment rate of a stabilizer replenisher in said stabilization process is at most 400 ml per m² of said silver halide light-sensitive color photographic material. 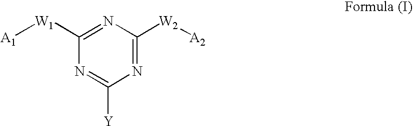
wherein A₁ and A₂ each independently represent a hydrogen atom, a halogen atom, an aryl group, a heterocyclic group, or an alkyl group; Y represents a hydrogen atom, a thiol group, a halogen atom, a carboxyl group, a sulfo group, a hydroxylamino group, a —NR₁R₂, —SR₃, or —OR₃; W₁ represents a single linking means, —O—, —S—, or —NR₄—, W₂ represents —O—, —S—, or —NR₄—; and R₁, R₂, R₃, and R₄ each represent a hydrogen atom, an alkyl group, an alkenyl group, an aryl group, or a heterocyclic group. R₁ and R₂, R₄ and A₁, R₄ and A₂ bond to each other to form a ring. However, neither an azo group nor a diaminostilbene structure is included in the molecule represented by above Formula (I).

(8) Another embodiment of the present invention includes a processing method of a silver halide light-sensitive color photographic material, described in the above-mentioned item 7, wherein the compound represented by said Formula (I) is represented by the compound represented by following Formulas (II) or (III). 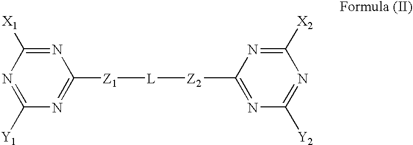
wherein X₁, X₂, Y₁, and Y₂ each independently represent —N(R₁)R₂, —OR₃, —SR₃, a heterocyclic group, a hydroxyl group, a hydroxylamino group, or a halogen atom; Z₁ and Z₂ each represent —NR₄—, —O—, or —S—; L represents an arylene group, an alkylene group, an alkenylene group, or a heterocyclic group; R₁ and R₂ each represent a hydrogen atom, an alkyl group, an aryl group, or a heterocyclic group, R₃ represents an alkyl group, an aryl group, or a heterocyclic group; and R₄ represents a hydrogen atom, an aryl group, a heterocyclic group, or an alkyl group. R₁ and R₂ may bond to each other to form a nitrogen containing ring. However, neither an azo group nor a diaminostilbene structure is included in the molecule represented by above Formula (II). 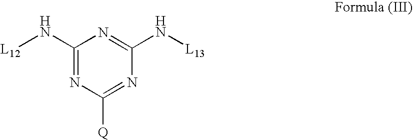
wherein L₁₂ and L₁₃ may be the same or different and each represent an aryl group or a heterocyclic group; Q represents a hydrogen atom, a thiol group, a carboxyl group, a sulfo group, —NR₅R₆, —OR₇, a hydroxylamino group, or a halogen atom; and R₅, R₆, and R₇ each represent a hydrogen atom, an alkyl group, an aryl group, or a heterocyclic group. R₅ and R₆ may bond to each other to form a ring. However, incorporated in the molecule represented by said Formula (III) is at least one of the groups represented by —SO₃M, —CO₂M, or —OH, wherein M represents a hydrogen atom, an alkaline metal, an alkaline earth metal, ammonium, or pyridinium. However, neither an azo group nor a diaminostilbene structure is included in the molecule represented by above Formula (III).

(9) Another embodiment of the present invention includes a processing method of a silver halide light-sensitive color photographic material, described in the above-mentioned item 8, wherein the compound represented by said Formula (II) is at least one selected from the compounds represented by following Formulas (II-1)-(II-4). 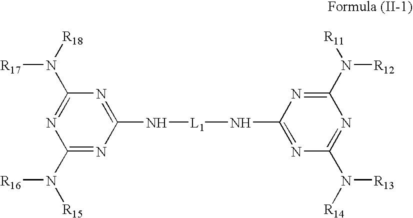
wherein R₁₁-R₁₈ each independently represent a hydrogen atom, an alkyl group, an aryl group, or a heterocyclic group, and L₁ represents a phenylene group or a naphthylene group. At least 3 of R₁₁-R₁₈ are aryl groups. Further, R₁₁ and R₁₂, R₁₃ and R₁₄, R₁₅ and R₁₆, as well as R₁₇ and R₁₈ may bond to each other to form a ring. However, in the molecule represented by Formula (II-1) comprised is at least one of the groups represented by —SO₃M, —CO₂M, and —OH, wherein M represents an alkaline metal ion, or an ammonium ion. Further, neither the group represented by —N═N— nor a diaminostilbene structure is included in the molecule represented by above Formula (II-1). 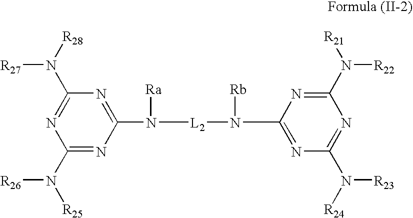
wherein R₂₁-R₂₈ each independently represent a hydrogen atom, an alkyl group, an aryl group, or a heterocyclic group; L₂ represents a phenylene group, a naphthylene group, an alkylene group, or a heterocyclic group; Ra represents an alkyl group, an aryl group, or a heterocyclic group; and Rb represents a hydrogen atom, an alkyl group, or an aryl group. R₂₁ and R₂₂, R₂₃ and R₂₄, R₂₅ and R₂₆, as well as R₂₇ and R₂₈ may bond to each other to form a ring. However in the compounds represented by Formula (II-2) comprised in the molecule is at least one of the groups represented by —SO₃M, —CO₂M, and —OH, wherein M represents an alkaline metal ion, or an ammonium ion. Further, neither —N═N— nor a diaminostilbene structure is included in the molecule of the compounds represented by above Formula (II-2). 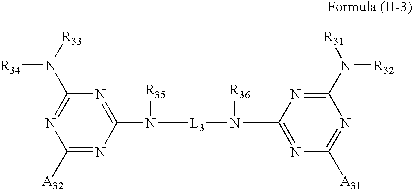
wherein R₃₁-R₃₄ each independently represent a hydrogen atom, an alkyl group, an aryl group, or a heterocyclic group; L₃ represents a phenylene group, a naphthylene group, an alkylene group, or a heterocyclic group; A₃₁ and A₃₂ each independently represent an alkoxy group, an aryloxy group, a heterocyclic oxy group, an alkylthio group, an arylthio group, a heterocyclic thio group, or a hydroxylamino group; and R₃₅ and R₃₆ each independently represent a hydrogen atom, an alkyl group, an aryl group or a heterocyclic group. R₃₁ and R₃₂, as well as R₃₃ and R₃₄ may bond to each other to form a ring. However, in the compounds represented by Formula (II-3) comprised in the molecule is at least one of the groups represented by —SO₃M, —CO₂M, and —OH, wherein M represents an alkaline metal ion, or an ammonium ion. Further, neither —N═N— nor a diaminostilbene structure is included in the molecule of the compound represented by above Formula (II-3). 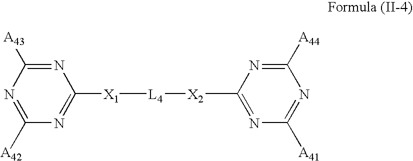
wherein L₄ represents a phenylene group, a naphthylene group, or an alkylene group; X₁ represents a oxygen atom or a sulfur atom; X₂ represents an oxygen atom, a sulfur atom, or —NH—; and A₄₁, A₄₂, A₄₃, and A₄₄ each independently represent an alkoxy group, an aryloxy group, a heterocyclic oxy group, an alkylthio group, an arylthio group, a heterocyclic thio group, a hydroxylamino group, or —NR₄₁R₄₂ (R₄₁ and R₄₂ each independently represent a hydrogen atom, an alkyl group, an aryl group, or a heterocyclic group, and R₄₁ and R₄₂ may bond to each other to form a ring). However, in the compounds represented by Formula (II-4) comprised in the molecule is at least one of the groups represented by —SO₃M, —CO₂M, and —OH, wherein M represents an alkaline metal ion, or an ammonium ion. Further, neither —N═N— nor a diaminostilbene structure is included in the molecule of the compound represented by above Formula (II-4).

### DESCRIPTION OF THE PREFERRED EMBODIMENTS

Preferred embodiments to realize the present invention will now be detailed.

In view of the above problems, the inventors of the present invention conducted diligent investigation and discovered the following, whereby the present invention was achieved. Employed as a stabilization processing composition of silver halide light-sensitive color photographic materials, was (1) a stabilization processing composition incorporating the compound represented by above Formula (I), in which the ammonium ion ratio was controlled to less than 50 mol percent with respect to the total incorporated cations, or employed was. (2) a processing method of silver halide light-sensitive color photographic materials in which a stabilizer, used in the stabilization process, incorporated the compound represented by above Formula (I), the ammonium ion ratio was less than 50 mol percent with respect to the total incorporated cations, and the replenishment rate of the stabilizer replenisher in the above stabilization process was controlled to be at most 400 ml per m² of the above silver halide light-sensitive color-photographic material. As a result, it was possible to reduce solids formed in the stabilization process, to minimize print quality degradation due to solids, and to retard the formation of yellow stain when processed silver halide light-sensitive color photographic materials were stored at high temperature.

The present invention will now be detailed.

It is preferable that the photographic processing of silver halide light-sensitive color photographic material according to the present invention is composed of at least a color development process, a desilvering process, and a stabilization process or a rinsing process. As used herein, the stabilization processing composition of silver halide light-sensitive photographic materials according to the present invention (hereinafter also referred simply to as the stabilization processing composition) refers to a stabilizer or a rinsing solution employed in the stabilization process, or the rinsing process (hereinafter also referred to as a stabilizer including both), and also refers to compositions to prepare those.

In the stabilization processing composition of silver halide light-sensitive color photographic material of the present invention, or the processing method (hereinafter also referred simply to as the processing method) of silver halide light-sensitive color photographic materials, one of the features is that the stabilizer incorporates the compounds represented by above Formula (I).

First, described are the compounds represented by Formula (I) according to the present invention.

In above Formula (I), A₁ and A₂ each independently represent a hydrogen atom, a halogen atom, an aryl group, a heterocyclic group, or an alkyl group; Y represents a hydrogen atom, a thiol group, a halogen atom, a carboxyl group, a sulfo group, a hydroxylamino group, a —NR₁R₂, —SR₃, or —OR₃; W₁ represents a single linking means, —O—, —S—, or —NR₄—; W₂ represents —O—, —S—, or —NR₄—; and R₁, R₂, R₃, and R₄ each represent a hydrogen atom, an alkyl group, an alkenyl group, an aryl group, or a heterocyclic group. R₁ and R₂, R₄ and A₁, as well as R₄ and A₂ bond to each other to form a ring. However, neither an azo group nor a diaminostilbene structure is included in the molecule represented by above Formula (I).

The compounds represented by Formula (I) according to the present invention will now be further detailed.

A₁ and A₂ each independently represent a hydrogen atom, a halogen atom, an aryl group, a heterocyclic group, or an alkyl group, and also represent an aryl group, a heterocyclic group, and an alkyl group having a substituent.

When Al and A₂ each represent an aryl group, the number of carbon atoms thereof is preferably 6-20, is more preferably 6-15, but is most preferably 6-10. Examples include a phenyl group, a 4-methoxyphenyl group, a 4-tolyl group, a naphthyl group, a 3-carboxyphenyl group, a 4-carboxyphenyl group, a 2-sulfophenyl group, a 4-sulfophenyl group, a 2-methyl-4-sulfophenyl group, a 2,5-disulfophenyl group, a 4-sulfo-1-naphthyl group, a 6,8-disulfo-2-naphthyl group, and a 6,7-sisuldo-2-naphthyl group.

When A₁ and A₂ each represent a heterocyclic group, the number of carbon atoms thereof is preferably 2-20, is more preferably 2-10, but is particularly preferably 3-8. The most preferable group is a univalent group which is formed by removing one hydrogen atom from a 5- or 6-membered aromatic- or non-aromatic heterocyclic compound. Examples include a 2-furyl group, a 2-thienyl group, a 2-pyrimidynyl group, and a 2-benzothiazolyl group.

When A₁ and A₂ each represent an alkyl group, the number of carbon atoms thereof is preferably 1-20, is more preferably 1-8, but is most preferably 1-4. Examples include a methyl group, an ethyl group, an isopropyl group, a 2-methoxyethyl group, a sulfomethyl group, a sulfoethyl group, a 1,2-dicarboxyethyl group, a 2-hydroxyethyl group, a 3-hydroxypropyl group, a 2-hydroxypropyl group, a 2,3-dihydroxypropyl group, a 3,4-dihydroxybutyl group, a 2-(2-hydroxyethoxy)ethyl group, and a 2-[2-hydroxyethoxylethoxy]ethyl group.

R₁-R₄ each represent a hydrogen atom, an aryl group, an alkenyl group, a heterocyclic group, or an alkyl group, and these groups include those having a substituent.

When R₁-R₄ each represent the alkyl group or the alkenyl group, the number of carbon atoms of the alkyl group is preferably 1-20, is more preferably 1-8, but is most preferably 1-4. Examples include a methyl group, an ethyl group, an i-propyl group, an n-propyl group, an n-octyl group, a vinyl group, a sulfomethyl group, a 2-hydroxyethyl group, a 3-hydroxypropyl group, a 2-hydroxypropyl group, a 2-sulfoethyl group, a 2-methoxyethyl group, a 2-(2-hydroxyethoxy)ethyl group, a 2-[2-(2-hydroxyethoxy)ethoxylethyl group, a 2-(2-82-hydroxyethoxy)ethoxylethoxy)ethyl group, a 2,3-dihydroxypropyl group, a 3,4-dihydroxybutyl group, a 2,3,4,5,6-pentahydoxyhexyl group, and a 1,2-dicarboxyethyl group.

The number of carbon atoms of the aryl group represented by R₁-R₄ is preferably 6-20, is more preferably 6-10, but is most preferably 6-8. Examples include a phenyl group, a naphthyl group, a 3-carboxyphenyl group, a 4-carboxyphenyl group, a 3,5-dicarboxydiphenyl group, a 4-methoxyphenyl group, a sulfophenyl group, and a 4-sulfophenyl group.

Preferred as the heterocyclic group represented by R₁-R₄ is one having 2-20 carbon atoms, more preferred is one having 2-10 carbon atoms, and still more preferred is one having 3-8 carbon atoms. The most preferred one is a univalent group formed by removing one hydrogen atom from a 5- or 6-membered aromatic or non-aromatic heterocyclic compound. Examples include a 2-furyl group, a 2-thienylgroup, a 2-pyrimidinyl group and a benzothiazolyl group.

Preferred as each of R₁-R₄ is a hydrogen atom, a methyl-group, an ethyl group, an n-propyl group, a sulfomethyl group, a 2-hydroxyethyl group, a 3-hydroxypropyl group, a 2-hydroxyprropyl group, a 3-hydroxypropyl group, a 2-sulfoethyl group, a 2-methoxyethyl group, a 2-(2-hydroxyethoxy)ethyl group, a 2-[2-(2-hydroxyethoxy)ethoxylethyl group, a 2,3-dihydoxypropyl group, a 3,4-dihydroxybutyl group, a phenyl group, a 3-carboxyphenyl group, a 4-carboxyphenyl group, a 3,5-dicarboxyphenyl group, a 4-methoxyphenyl group, a 2-sulfophenyl group, and a 4-sulfophenyl group, but more preferred are a hydrogen atom, a methyl-group, an ethyl group, a sulfomethyl group, a 2-hydroxyetyl group, a 2-sulfoethyl group, a 2-(2-hydroxyethoxy)ethyl group, a 2,3-didydroxypropyl group, a phenyl group, a 3-carboxyphenyl group, a 4-carboxyphenyl group, a sulfophenyl group, a 4-sulfophenyl group, and most preferred are a hydrogen atom, a methyl group, a sulfomethyl group, a 2-hydroxyethyl group, a 2-sulfoethyl group, a 2-(2-hydroxyethoxy)ethyl group, a 2,3-dihydroxypropyl group, a phenyl group, and a 4-sulfophenyl group.

Y represents a hydrogen atom, a thiol group, a halogen atom, a carboxyl group, a sulfo group, a hydroxylamino group, —NR₁R₂, —SR₃, or —OR₃, R₁, R₂, and R₃ each represent a hydrogen atom, an alkyl group, an aryl group, or a heterocyclic group, and further represent those having a substituent. Preferred examples include the same groups as represented for R₄.

Rings which are formed by combining R₁ and R₂, R₄ and A₁, or R₄ and A₂ are preferably 5- or 6-membered rings. Listed as examples are a pyrrolidine ring, a piperidine ring, a piperazine ring, and a morpholine ring.

It is preferable that the compounds represented by Formula (I) incorporate a water-solubilizing group in the molecule. Listed as water-solubilizing groups are, for example, a sulfo group, a carboxyl group, a hydroxyl group, a carbamoyl group, or a sulfamoyl group. Of these, the sulfo group, the carboxyl group, and the hydroxyl group are particularly preferred. In the case of incorporating the carboxyl group or the sulfo group, the resulting compounds may be free form or form a salt. In the case of the salt, the counter salt-forming element or group is preferably an alkaline metal, an alkaline earth metal, ammonium, or pyridinium. Of these, the alkaline metal and the alkaline earth metal are more preferred, but Na and K are particularly preferred. Examples of the ammonium salts include ammonium, trimethylammonium, and tetrabutylammonium, and of these, ammonium is preferred.

When both W₁ and W₂ represent —O—, or one represents —O— and the other represents —NR₄—, it is preferable that A₁ and A₂ each are an alkyl group, an aryl group, or a heterocyclic group, but it is more preferable that at least one is an aryl group or a heterocyclic group.

When both W₁ and W₂ represent —NR₄—, it is preferable that at most two of R₁, R₂, R₃, two R₄s, A₁ and A₂ are each an aryl group.

Of the compounds represented by Formula (I) according to the present invention, particularly preferred compounds are those represented by above Formula (II) or (III).

In above Formula (II), X₁, X₂, Y₁, and Y₂ each independently represent —N(R₁)R₂, —OR₃, —SR₃, a heterocyclic group, a hydroxyl group, a hydroxylamino group, or a halogen atom; Z, and Z₂ each represent —NR₄—, —O—, or —S—; L represents an arylene group, an alkylene group, an alkenylene group, or a heterocyclic group; R₁ and R₂ each represent a hydrogen atom, an alkyl group, an aryl group, or a heterocyclic group; R₃ represents an alkyl group, an aryl group, or a heterocyclic group; and R₄ represents a hydrogen atom, an aryl group, a heterocyclic group, or an alkyl group. R₁ and R₂ may bond to each other to form a nitrogen-containing ring. However, neither an azo group nor a diaminostilbene structure is included in the molecule represented by above Formula (II).

The compounds represented by Formula (II) will now be further detailed.

The alkyl groups represented by R₁, R₂, R₃, or R₄ include those having a substituent, and those having 1-20 carbon atoms are preferred, those having 1-8 carbons atoms are more preferred, but those having 1-4 carbon atoms are most preferred. Examples include a methyl group, an ethyl group, an i-propyl group, an n-propyl group, an n-octyl group, a sulfomethyl group, a 2-hydroxyethyl group, a 3-hydroxypropyl group, a 2-hydroxypropyl group, a 2-sulfoethyl group, a 2-methoxyethyl group, a 2-(2-hydroxyethoxy)ethyl group, a 2-[2-(2-hydroxyethoxy)ethoxy]ethyl group, a 2-(2-[2-(2-hydroxyethoxy)ethoxy)ethoxy)ethyl group, a 2,3-dihydroxypropyl group, a 3,4-dihydroxybutyl group, and a 2,3,4,5,6-pentahydroxyhexyl group.

The aryl groups represented by R₁, R₂, R₃, or R₄ include those having a substituent, and those having 6-20 carbon atoms are preferred, those having 6-10 carbons atoms are more preferred, but those having 6-8 carbon atoms are most preferred. Examples include a phenyl group, a naphthyl group, a 3-carboxyphenyl group; a 4-carboxyphenyl group, a 3,5-dicarboxyphenyl group, a 4-methoxyphenyl group, a 2-sulfophenyl group, a 4-sulfophenyl group, and a 2,4-disulfophenyl group.

The heterocyclic groups represented by R₁, R₂, R₃, or R₄ include those having a substituent, and those having 2-20 carbon atoms are preferred, and those having 2-10 carbons atoms are more preferred, but those which are formed by removing one hydrogen atom from a 5- or 6-membered aromatic or non-aromatic heterocyclic compound having 3-8 carbon atoms are most preferred. Examples include a 2-furyl group, a 2-thienyl group, a 2-pyrimidinyl group, and a 2-benzothiazolyl group.

R₁ and R₂ each are preferably a hydrogen atom, an alkyl group, and a aryl group, are more preferably a hydrogen atom, a methyl group, an ethyl group, an n-propyl group, a sulfomethyl group, a 2-hydroxyethyl group, a 3-hydroxypropyl group, a 2-hydroxypropyl group, a 2-sulfoethyl group, a 2-methoxyethyl group, a 2-(2-hydroxyethoxy)ethyl group, a 2-[2-(2-hydroxyethoxy)ethoxy)ethyl group, a 2,3-dihydroxypropyl group, a 3,4-dihydroxybutyl group, a phenyl group, a 3-carboxyphenyl group, a 4-carboxyphenyl group, a 3,5-dicarboxyphenyl group, a 4-methoxyphenyl group, a 2-sulfophenyl group, and a 4-sulfophenyl group, each are more preferably a hydrogen atom, a methyl group, an ethyl group, a sulfomethyl group, a 2-hydroxyethyl group, a 2-sulfoethyl group, a 2-(2-hydroxyethoxy)ethyl group, a 2,3-dihydroxypropyl group, a phenyl group, a 3-carboxyphenyl group, a 4-carboxyphenyl group, a 2-sulfophenyl group, and a 4-sulfophenyl group, but each are still more preferably a methyl group, a sulfomethyl group, a 2-hydroxyethyl group, a 2-sulfoethyl group, a 2-(2-hydroxyethoxy)ethyl group, a 2,3-dihydroxypropyl group, a phenyl group, and a 4-sulfophenyl group.

Preferred as a nitrogen-containing heterocyclic ring which is formed by combining R₁ and R₂ is a 5- or 6-membered ring. Listed as examples of the above ring are a pyrrolidine ring, a piperidine ring, a piperazine ring, and a morpholine ring.

The alkyl groups represented by R₄ include those having a substituent, and those having 1-6 carbon atoms are preferred. Examples include a methyl group, an ethyl group, an i-propyl group, and an n-propyl group.

When X₁, X₂, Y₁, or Y₂ represents a heterocyclic group, those having a substituent are included. Preferred are a univalent 5- or 6-membered ring group which is formed by removing one hydrogen atom bonding to the nitrogen atom from a 5- or 6-membered aromatic or non-aromatic nitrogen-containing heterocyclic compound, and examples of the rings include a pyrrolidine ring, a piperidine ring, a piperazine ring, and a morpholine ring.

When all of X₁, X₂, Y₁ and Y₂ represent —N(R₁)R₂, it is preferable that at most two of four R₂s and four R₂s represent an aryl group.

The arylene group represented by L includes those having a substituent, and a phenylene group or a naphthylene group is preferred. Further, those having 6-20 carbon atoms are preferred, those having 6-15 carbon atoms are more preferred, but most preferred are a phenylene group or a naphthylene group having 6-11 carbon atoms. Examples include 1,4-phenylene, 1,3-phenylene, 1,2-phenylene, 1,5-naphthylene, 1,8-naphthylene, 4-carboxy-1,2-phenylene, 5-carboxy-1,3-phenylene, 3-sulfo-1,4-phenylene, 5-sulfo-1,3-phenylene, 2,5-dimethoxy-1,4-phenylene, and 2,6-dichloro-1,4-phenylene. Of these, preferred are 1,4-phenylene, 1,3-phenylene, 1,2-phenylene, 1,5-naphthylene, 5-carboxy-1,3-phenylene, and 5-sulfo-1,3-phenylene. Of these, more preferred are 1,4-phenylene and 1,3-phenylene. The heterocyclic group represented by L includes those having a substituent. Those having 2-20 carbon atoms are preferred, those having 2-10 carbon atoms are more preferred, but those having 2-8 carbon atoms are still more preferred. Examples include a 3,5-(1,2,4-triazole)-diyl group, a 3,5-isothiazolediyl group, a 2,6-pyridinediyl group, a 2,6-pyrazinediyl group, a 2,6-pyrimidinediyl group, a 3,6-pyradazinediyl group, and a 1,4-phthalazinediyl group.

The alkylene group and alkenylene group represented by L include those having a substituent. Those having 1-10 carbon atoms are preferred, but those having 2-5 carbon atoms are more preferred. Examples include ethylene, triethylene, propylene, and vinylene.

The compounds represented by Formula (III) according to the present invention will now be described.

In above Formula (III), L₁₂ and L₁₃ may be the same or different and each represents an aryl group or a heterocyclic group, Q represents a hydrogen atom, a thiol group, a carboxyl group, a sulfo group, —NR₅R₆, —OR₇, a hydroxylamino group, or a halogen atom, and R₅, R₆, and R₇ each represent a hydrogen atom, an alkyl group, an aryl group, or a heterocyclic group. R₅ and R₆ may bond to each other to form a ring. However, incorporated in the molecule represented by said Formula (III) is at least one of the groups represented by —SO₃M, —CO₂M, or —OH, wherein M represent a hydrogen atom, an alkaline metal, an alkaline earth metal, ammonium, or pyridinium. However, neither an azo group nor a diaminostilbene structure is not included in the molecule represented by above Formula (III).

The compounds represented by Formula (III) according to the present invention will now be detailed.

The aryl groups represented by L₁₂ and L₁₃ include those having a substituent. Further, those having 6-20 carbon atoms are preferred, those having 6-15 carbon atoms are more preferred, but most preferred are a phenylene group or a naphthylene group having, 6-11 carbon atoms. It is preferable that the above aryl group has at least one substituent, and preferred substituents include —SO₃M, —CO₂M, —OH, —Cl, —Br, or above-cited —NR₅R₆ and —OR₇, wherein M represents a hydrogen atom, an alkaline metal, an alkaline earth metal, ammonium, or pyridinium R₅, R₆, and R₇ each represent a hydrogen atom, an alkyl group, an aryl group, or a heterocyclic group. R₅ and R₆ may bond to each other to from a ring.

The heterocyclic groups represented by L₁₂ and L₁₃ include those having a substituent. Further, those having 2-20 carbon atoms are preferred, those having 2-10 carbon atoms are more preferred, those having 3-8 carbon atoms are still more preferred, but most preferred is a univalent 5- or 6-membered ring group which is formed by removing one hydrogen atom from a 5- or 6-membered aromatic or non-aromatic heterocyclic compound, examples of which include a furyl group, a thienyl group, a pyrimidinyl group, a benzothiazolyl group, and a benzimidazole group.

Preferred examples of the alkyl group, aryl group, and heterocyclic group represented by R₅-R₇ are the same as for the groups represented by R₁-R₃ in Formula (I).

Specific examples of the compounds of the present, invention are listed below, however the present invention is not limited thereto.

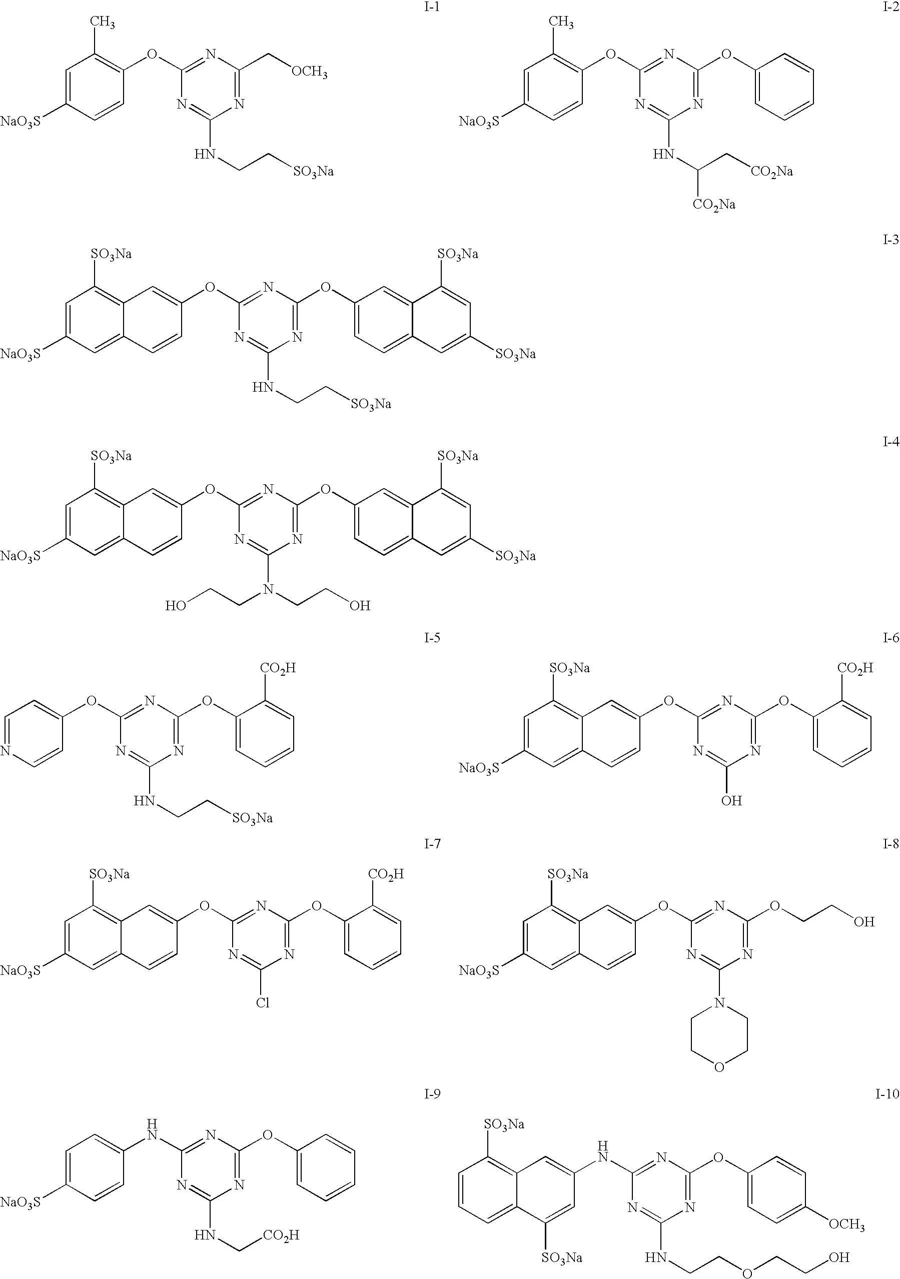

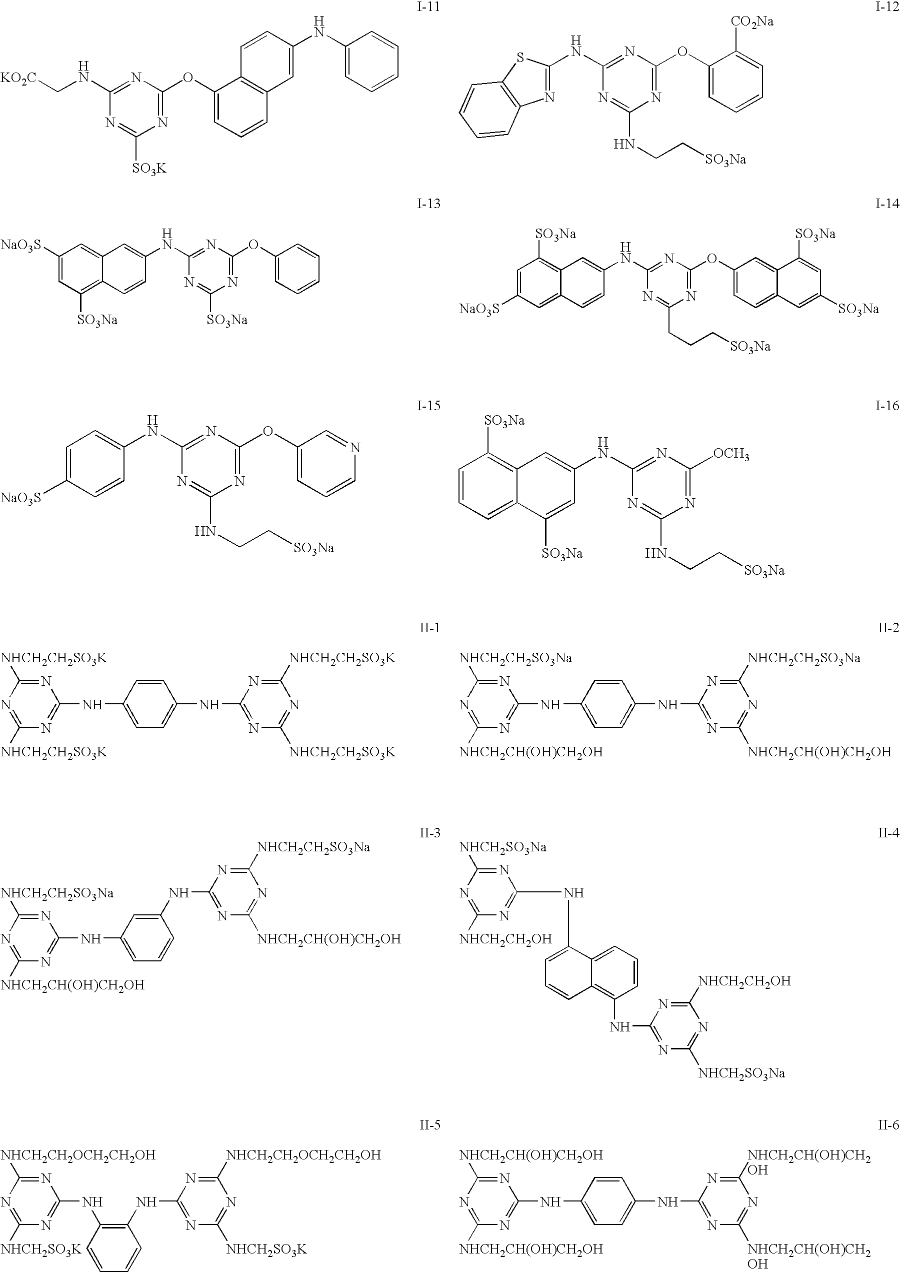

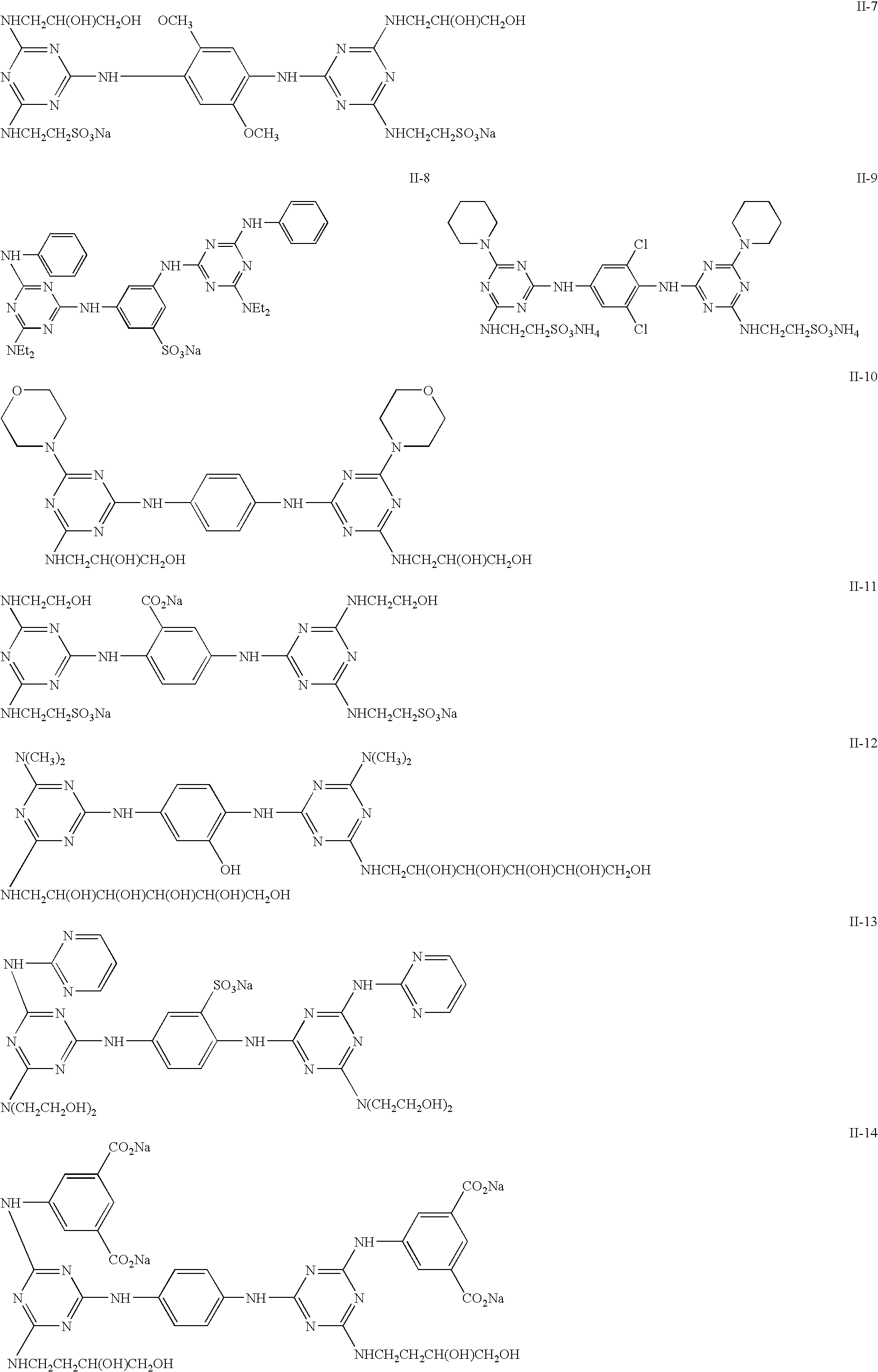

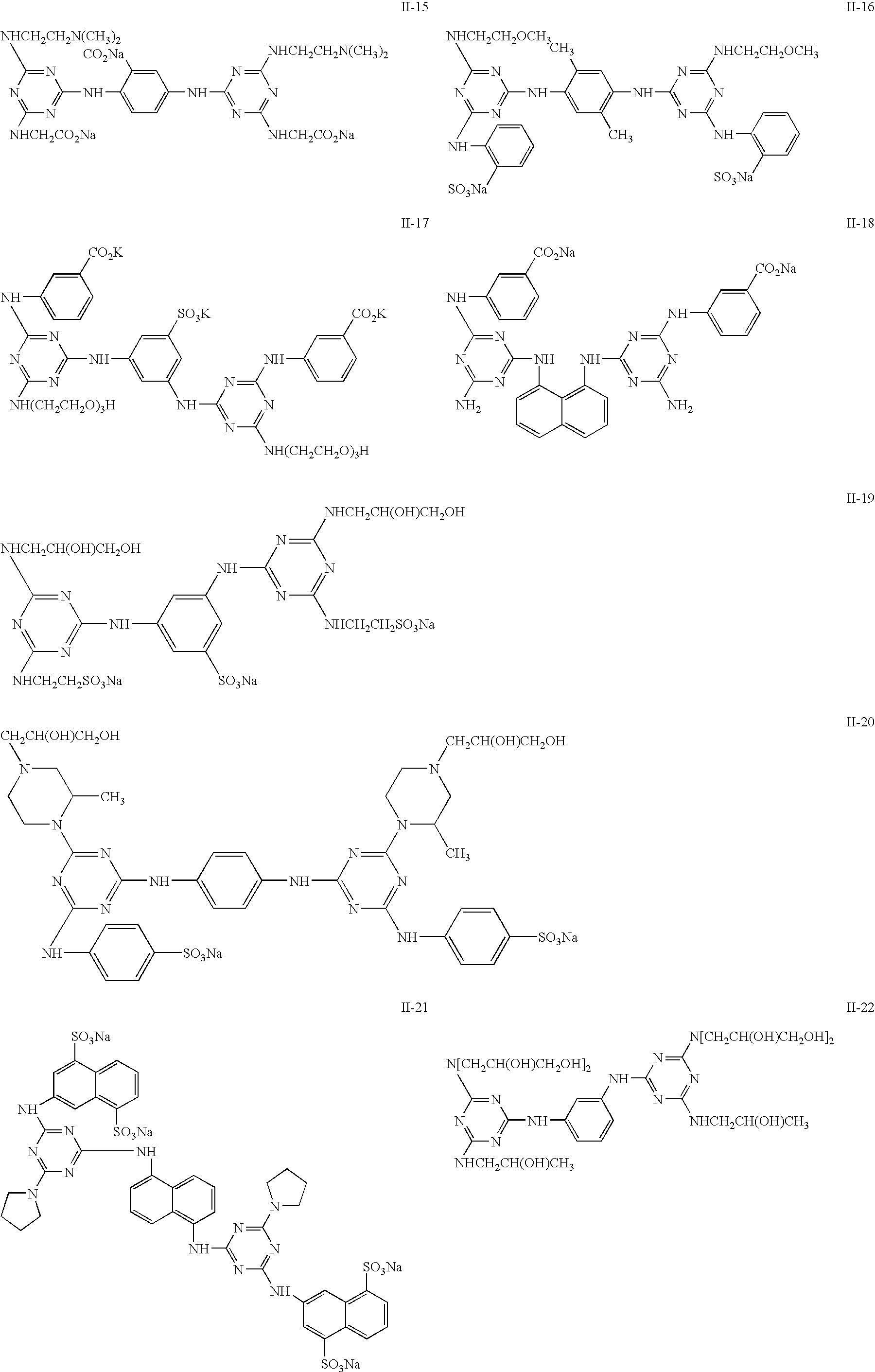

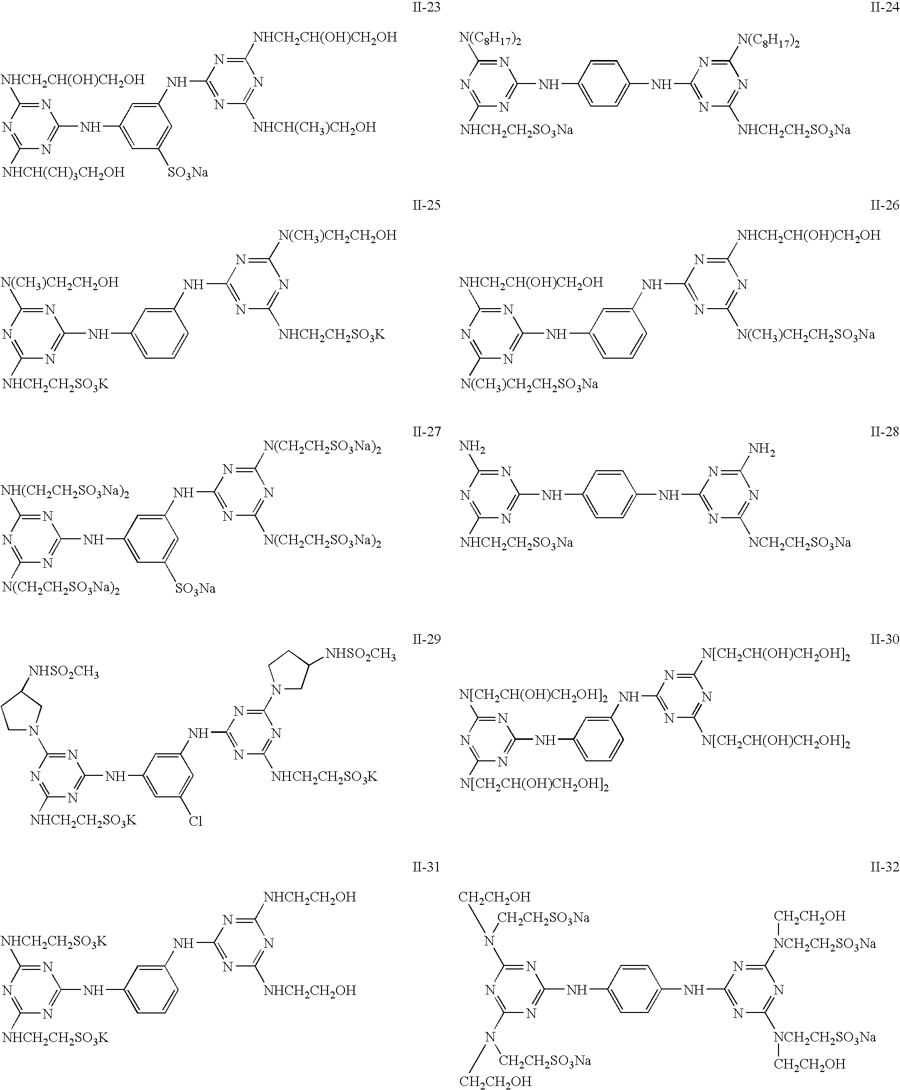

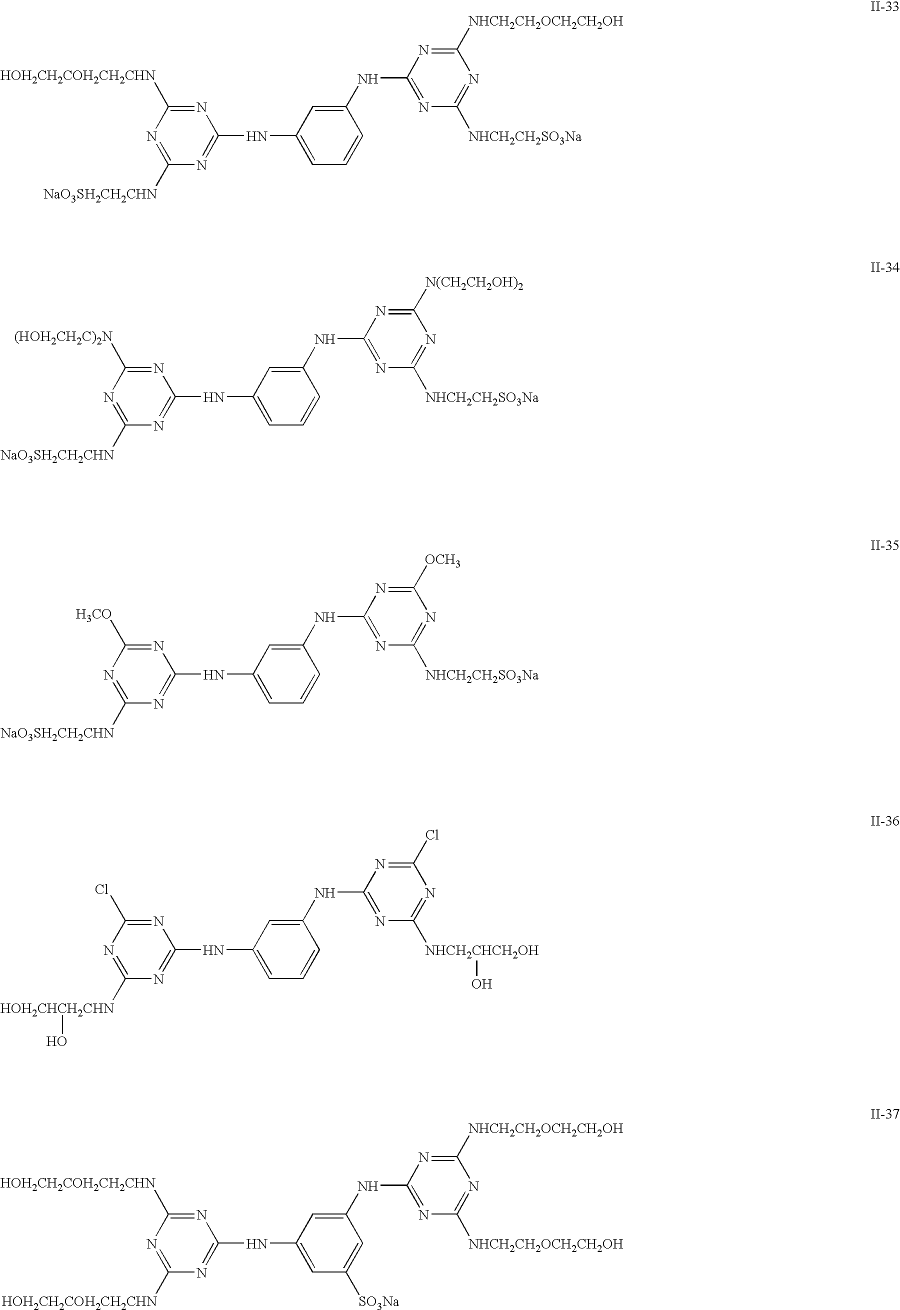

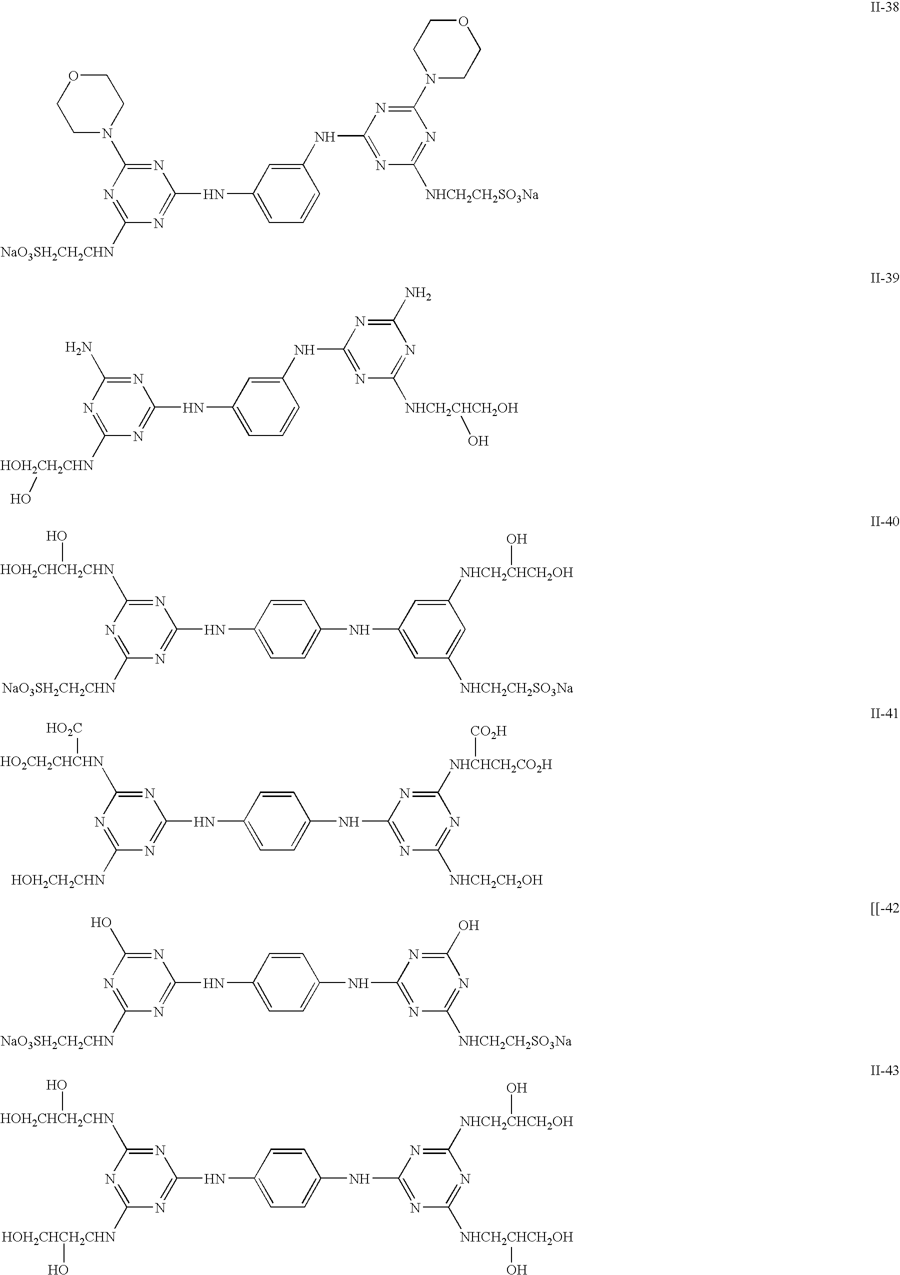

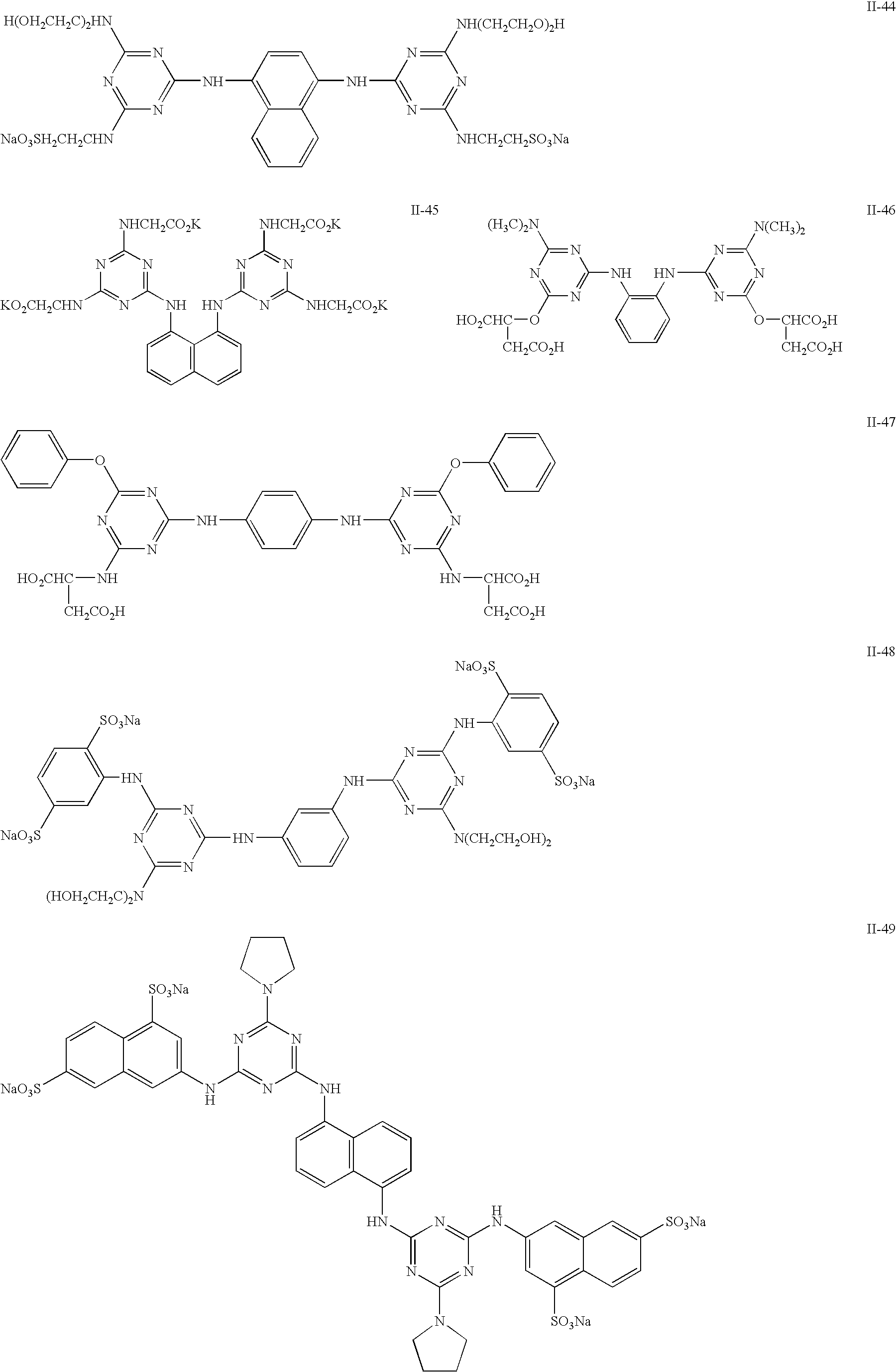

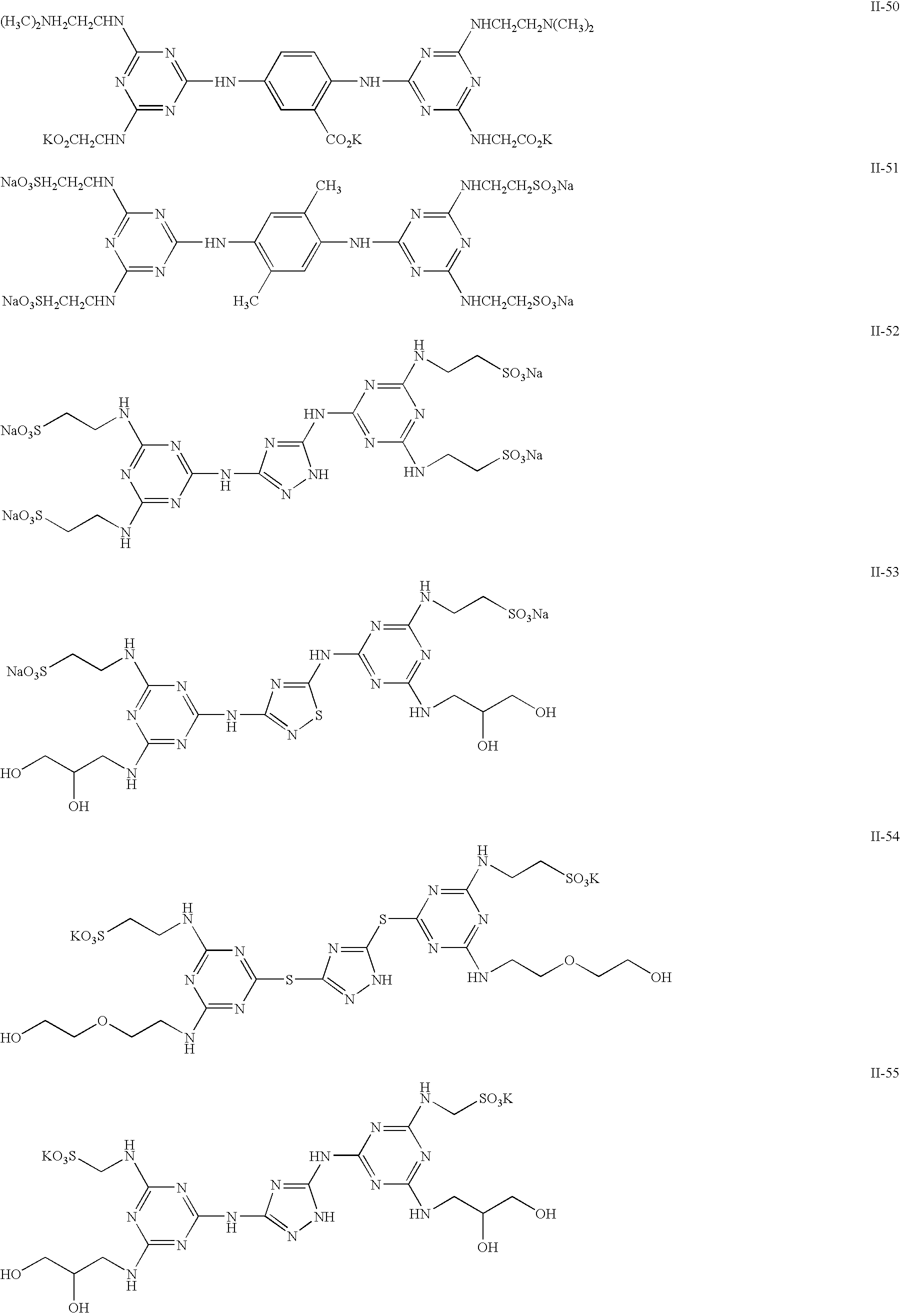

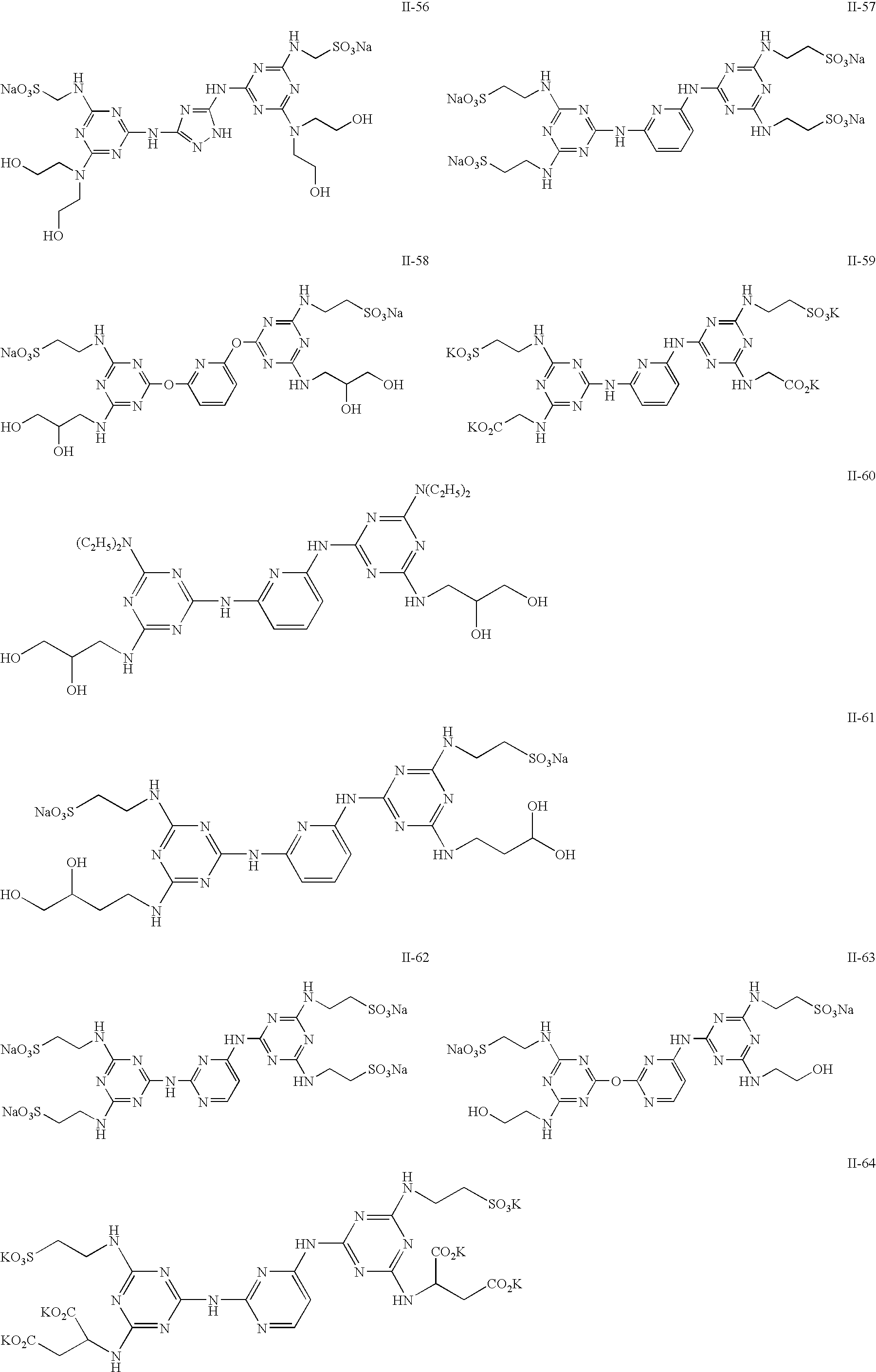

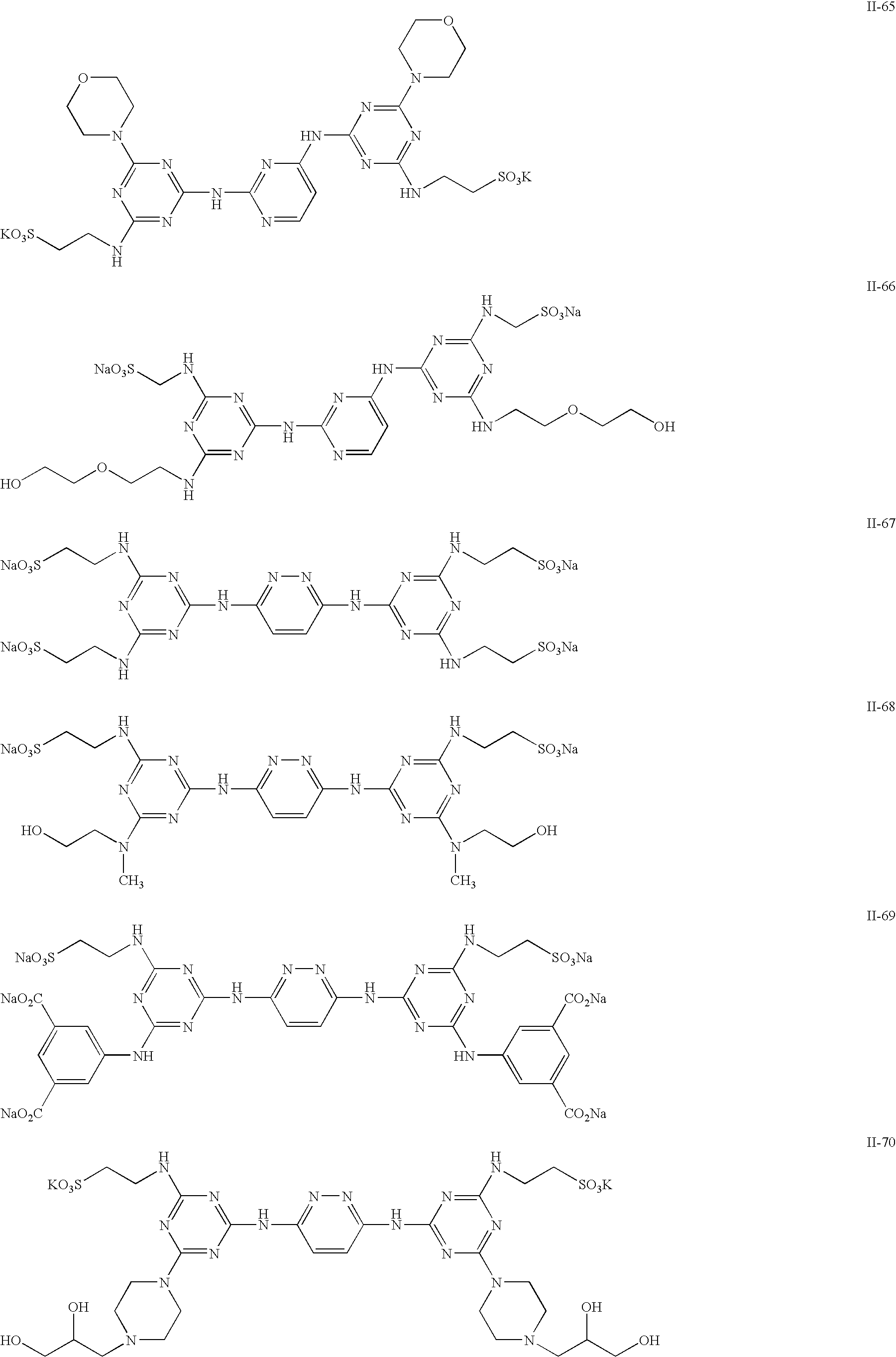

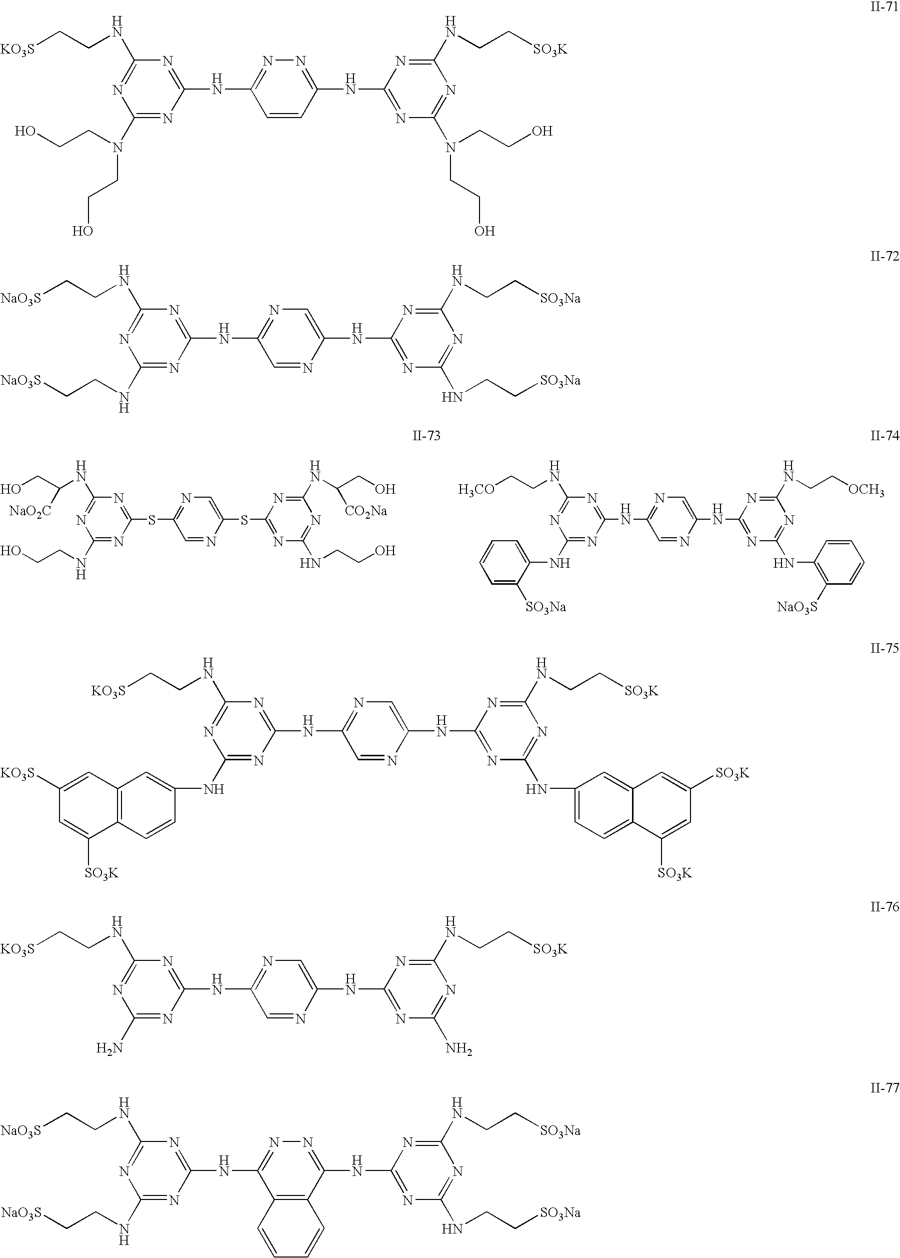

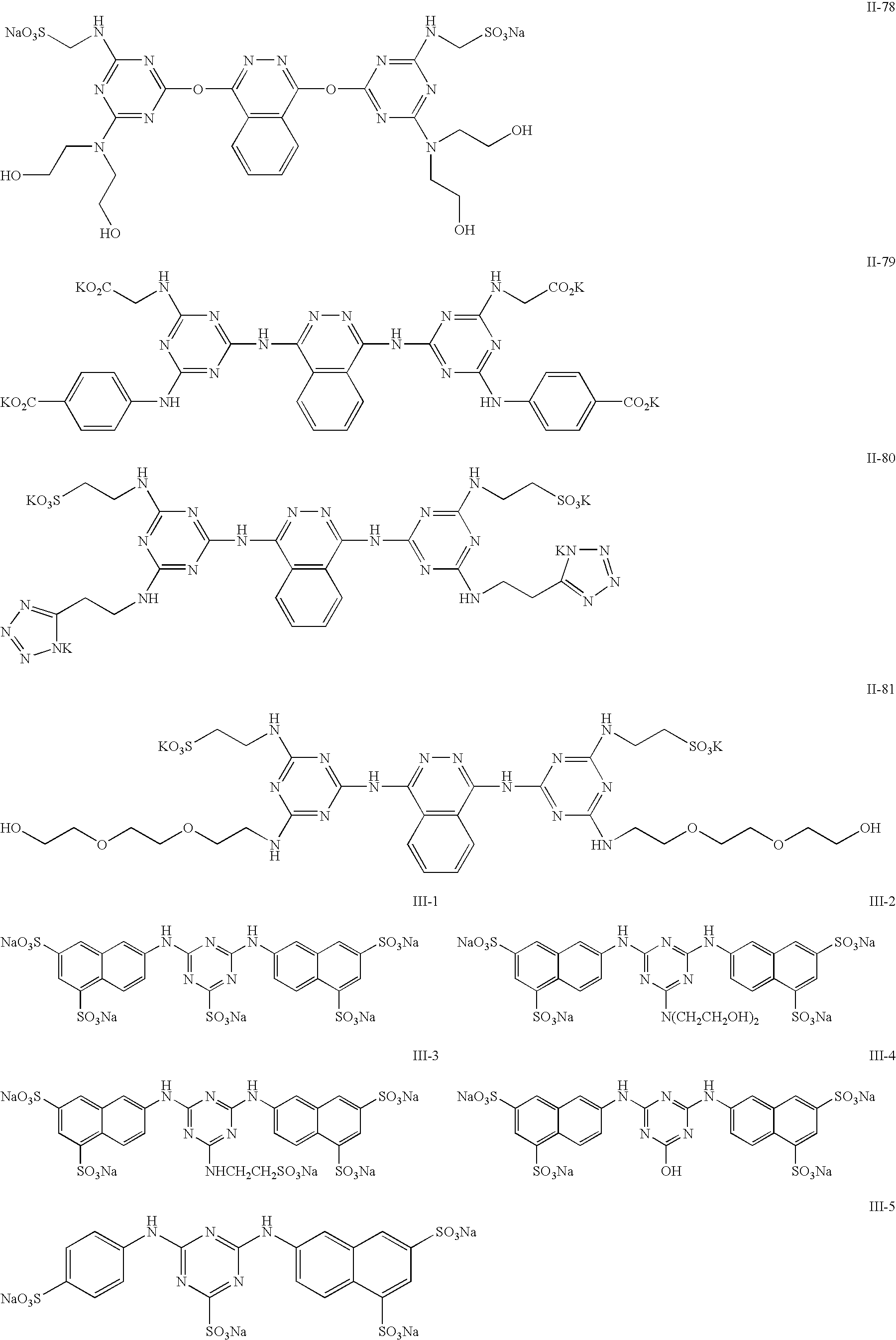

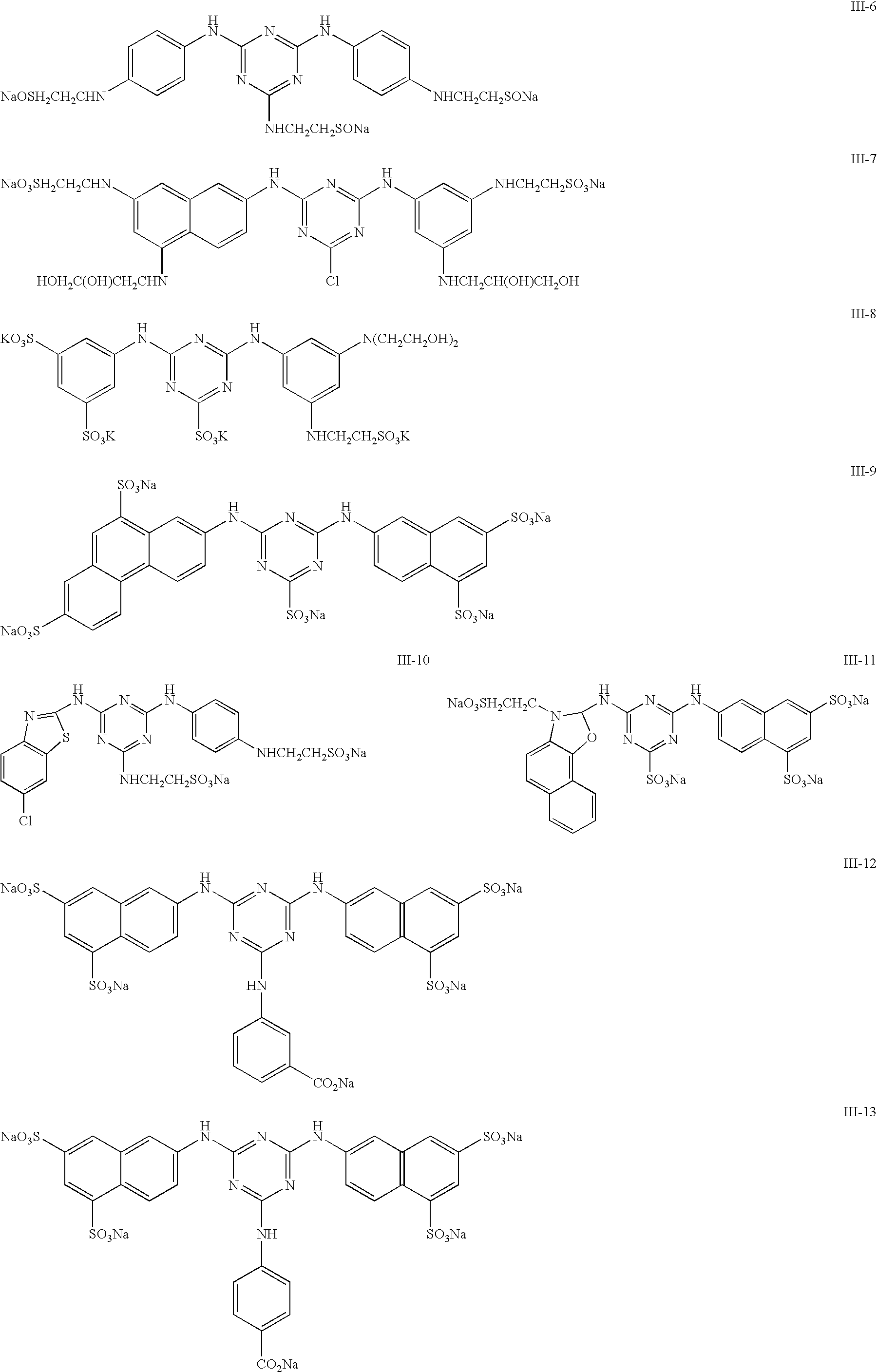

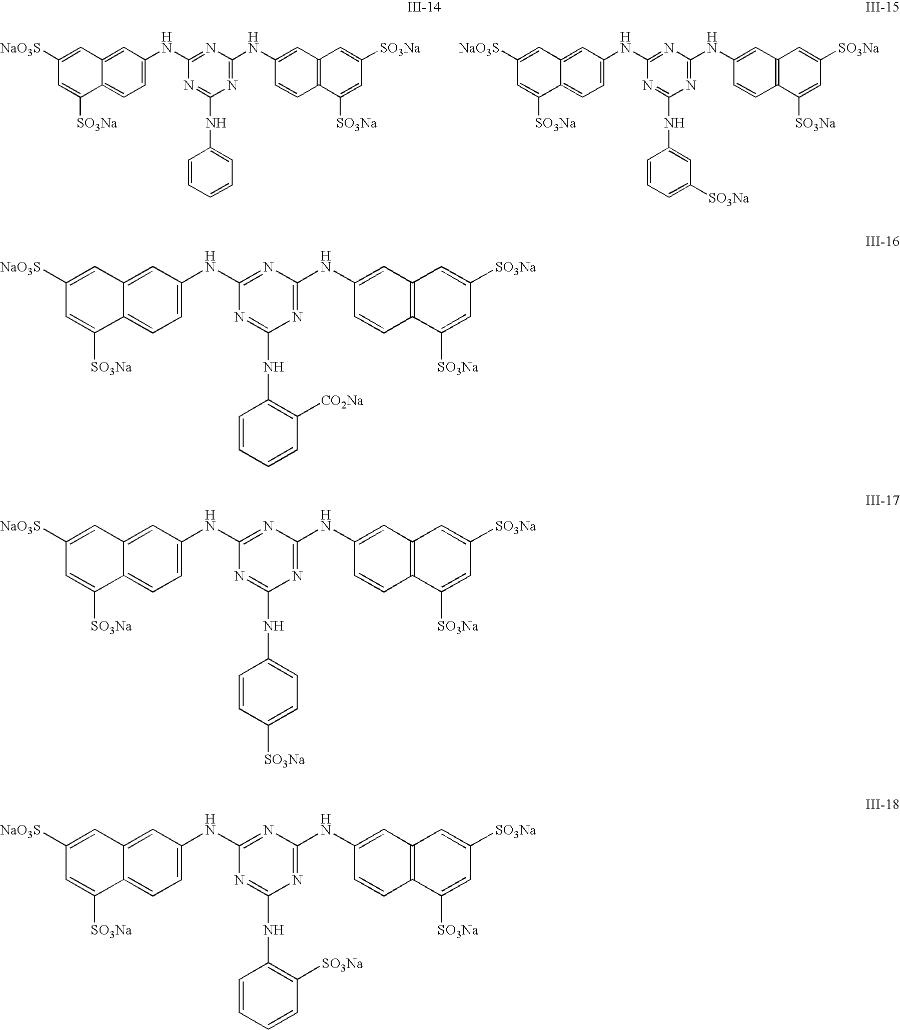

Further, in the present invention, of the compounds represented by above Formula (II), more preferable compounds are those represented by above Formulas (II-1) (II-4).

First, the compounds represented by Formula (II-1) will be described.

In above Formula (II-1), R₁₁-R₁₈ each independently represent a hydrogen atom, an alkyl group, an aryl group, or a heterocyclic group, while L₁ represents a phenylene group or a naphthylene group. At least 3 of R₁₁-R₁₈ are aryl groups. Further, R₁₁ and R₁₂, R₁₃ and R₁₄, R₁₅ and R₁₆, as well as R₁₇ and R₁₈ may bond to each other to form a ring. However, in the molecule represented by Formula (II-1) incorporated is at least one of the groups represented by —SO₃M, —CO₂M, and —OH, wherein M represents an alkaline metal ion, or an ammonium ion. Further, neither an azo group nor a diaminostilbene structure is included in the molecule of the compound represented by Formula (II-1).

The compounds represented by above Formula (II-1) will now be detailed.

R₁₁-R₁₈ each independently represent a hydrogen atom, an alkyl group, an aryl group, or a heterocyclic group, and include those having a substituent. Preferred as the alkyl groups represented by R₁₁-R₁₈ are those having 1-20 carbon atoms, more preferred are those having 1-8 carbon atoms, but most preferred are those having 1-4 carbon atoms. Examples include a methyl group, an ethyl group, an i-propyl group, an n-propyl group, an n-octyl group, a sulfomethyl group, a 2-hydroxyethyl group, a 3-hydroxypropyl group, a 2-hydroxypropyl group, a 2-sulfoethyl group, a 2-methoxyethyl group, a 2-(2-hydroxyethoxy)ethyl group, a 2-[2-(2-hydroxyethoxy)ethoxy)ethyl group, a 2-(2-[2-(2-hydroxyethoxy)ethoxy]ethoxy)ethyl group, a 2,3-dihydroxypropyl group, a 3,4-dihydroxybutyl group, and a 2,3,4,5,6-pentahydroxyhexyl group.

Preferred as the aryl groups represented by R₁₁-R₁₈ are those having 6-20 carbon atoms, more preferred are those having 6-10 carbon atoms, but most preferred are those having 6-8 carbon atoms. Examples include a phenyl group, a naphthyl group, a 3-carboxyphenyl group, a 4-carboxyphenyl group, a 3,5-dicarboxyphenyl group, a 4-methoxyphenyl group, a 2-sulfophenyl group, and a 4-sulfophenyl group.

Preferred as the heterocyclic groups represented by R₁₁-R₁₈ are those having 2-20 carbon atoms, more preferred are those having 2-10 carbon atoms, but still more preferred are univalent 5- or 6-membered ring groups, having 3-8 carbon atoms, which are formed by removing one hydrogen atom from a 5- or 6-membered aromatic or non-aromatic heterocyclic compound, examples of which a furyl group, a thienyl group, a pyrimidinyl group, and a benzothiazolyl group.

R₁₁-R₁₈ are each preferably a hydrogen atom, an alkyl group, and an aryl group, are more preferably a hydrogen atom a methyl group, an ethyl group, an n-propyl group, a sulfomethyl group, a 2-hydroxyethyl group, a 3-hydroxypropyl group, a 2-hyroxypropyl group, a 2-sulfoethyl group, a 2-methoxyethyl group, a 2-(2-hydroxyethoxy)ethyl group, a 2-[2-(2-hydroxyethoxy)ethoxy)ethyl group, a 2,3-dihydroxypropyl group, a 3,4-dihydroxybutyl group, a phenyl group, a 3-carboxyphenyl group, a carboxyphenyl group, a 3,5-dicarboxyphenyl group, a 4-methoxyphenyl group, a 2-sulfophenyl group, and a 4-sulfophenyl group, but are each more preferably a hydrogen atom, a methyl group, an ethyl group, a sulfomethyl group, a 2-hydroxyethyl group, a sulfoethyl group, a 2-(2-hydroxyethoxy)ethyl group, a 2,3-dihydroxypropyl group, a phenyl group, a 3-carboxyphenyl group, a 4-carboxyphenyl group, a 2-sulfophenyl group, and a 4-sulfophenyl group, but are each still more preferably a hydrogen atom, a methyl group, a sulfomethyl group, a 2-hydroxyethyl group, a 2-sulfoethyl group, a 2-(2-hydroxyethoxy)ethyl group, a 2,3-dihydroxypropyl group, a phenyl group, and a 4-sulfophenyl group.

Of R₁₁-R₁₈, at least three each represent an aryl group.

L₁ represents a phenylene group and a naphthylene group. The number of carbon atoms of the phenylene group or the naphthylene group represented by L₁ is preferably 6-20, is more preferably 6-15, but is most preferably 6-11 of the substituted or unsubstituted phenylene or naphthylene group. Examples include 1,4-phenylene, 1,3-phenylene, 1,2-phenylene, 1,5-naphthylene, 1,8-naphthylene, 4-carboxy11, 2-phenylene, 5-carboxy-1,3-phenylene, 3-sulfo-1,4-phenylene, 5-sulfo-1,3-phenylene, 2,5-dimethoxy-1,4-phenylene, 2,6-dichloro-1,4-phenylene.

L₁ is preferably 1,4-phenylene, 1,3-phenylene, 1,2-phenylene, 1,5-naphthylene, 5-carboxy-1,3-phenylene, or 5-sulfo-1,3-phenylene, but is more preferably 1,4-phenylene or 1,3-phenylene.

R₁₁ and R₁₂, R₁₃ and R₁₄, R₁₅ and R₁₆, as well as R₁₇ and R₁₈ may bond to each other to form a ring. The ring which is formed by combining R₁₁ with R₁₂, R₁₃ with R₁₄, R₁₅ with R₁₆, or R₁₇ and R₁₈ includes one which has a substituent, and is preferably a 5- or 6-membered ring. The examples of the above ring include a pyrrolidine ring, a piperidine ring, a piperazine ring, and a morpholine ring.

The compound represented by Formula (II-1) according to the present invention incorporates in the molecule at least one of the groups represented by —SO₃M, —CO₂M, or —OH, wherein M represents an alkaline metal ion, or an ammonium group. Of the alkaline metals and alkaline earth metals represented by M, Na and K are particularly preferred. Listed as ammonium groups are, for example, an ammonium group, a trimethylammonium group, a tetrabutylammonium group, and a pyridinium group. Those which are particularly preferred as M include Na and K.

Further, the compound represented by Formula (II-1) incorporates in the molecule neither —N═N— nor a diaminostilbene structure.

The specific examples represented by Formula (II-1) according to the present invention are listed below, however the present invention is not limited thereto.

| | 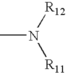 | 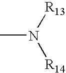 | 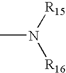 | 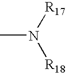 | —L₁— |
|---|---|---|---|---|---|
| II-1-1 | 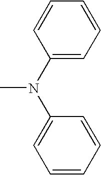 | 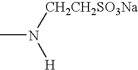 | 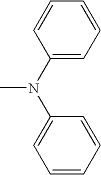 | 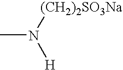 | 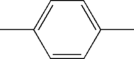 |
| II-1-2 | 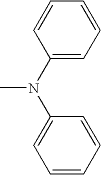 | 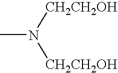 | 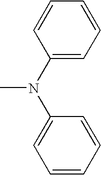 | 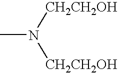 | 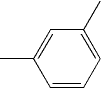 |
| II-1-3 | 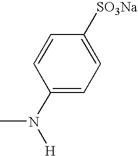 | 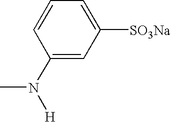 | 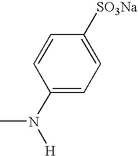 | 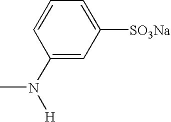 | 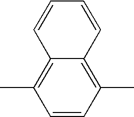 |
| II-1-4 | 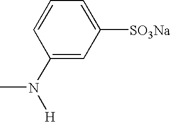 | 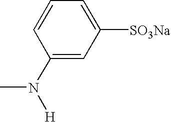 | 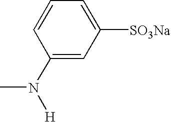 | 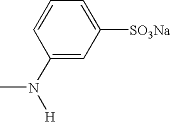 | 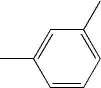 |
| II-1-5 | 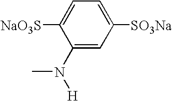 | 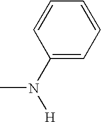 | 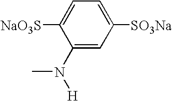 | 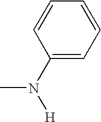 | 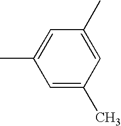 |
| II-1-6 | 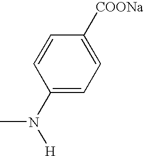 | 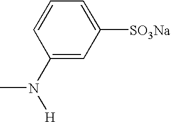 | 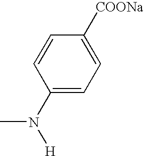 | 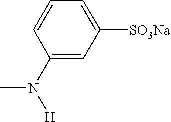 | 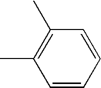 |
| II-1-7 | 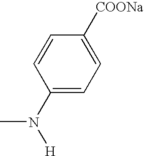 | 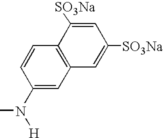 | 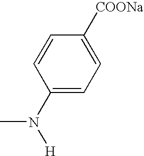 | 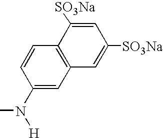 | 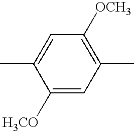 |
| II-1-8 | 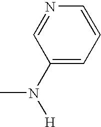 | 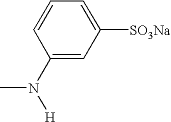 | 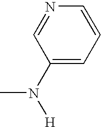 | 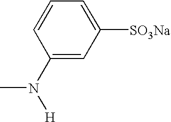 | 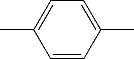 |
| II-1-9 | 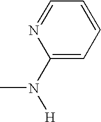 | 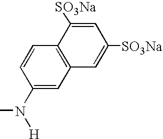 | 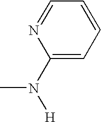 | 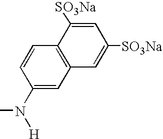 | 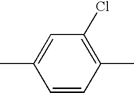 |
| II-1-10 | 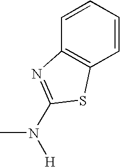 | 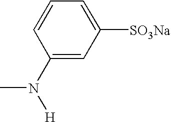 | 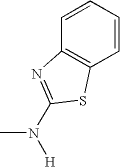 | 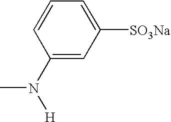 | 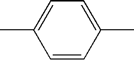 |
| II-1-11 | 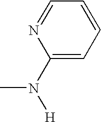 | 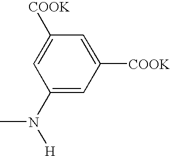 | 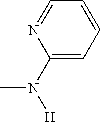 | 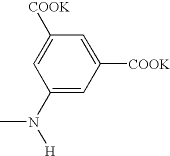 | 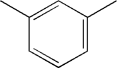 |
| II-1-12 | 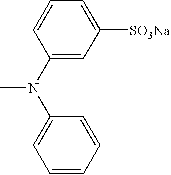 | 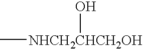 | 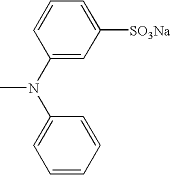 | 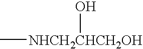 | 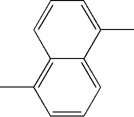 |
| II-1-13 | 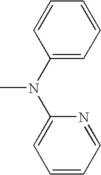 | 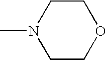 | 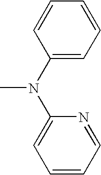 | 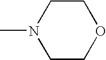 | 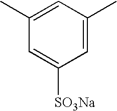 |
| II-1-14 | 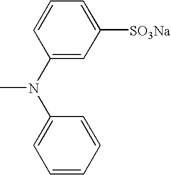 | 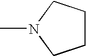 | 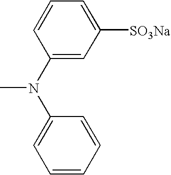 | 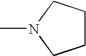 | 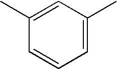 |
| II-1-15 | 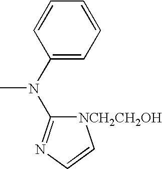 | 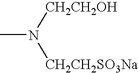 | 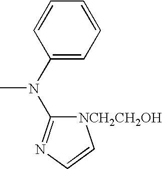 | 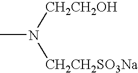 | 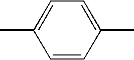 |
| II-1-16 | 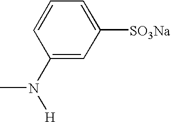 | 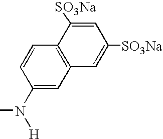 | 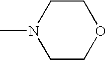 | 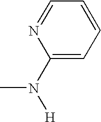 | 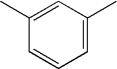 |
| II-1-17 | 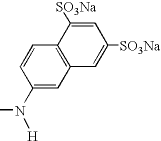 | 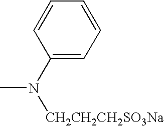 | 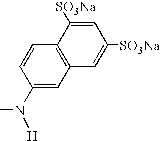 | 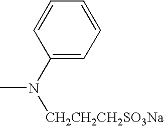 | 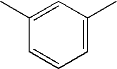 |
| II-1-18 | 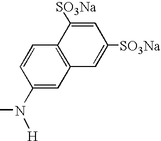 | 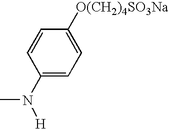 | 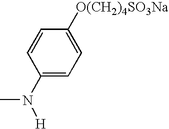 | 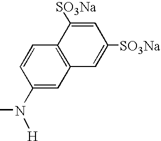 | 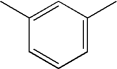 |
| II-1-19 | 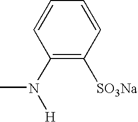 | 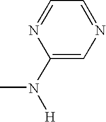 | 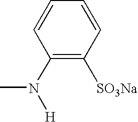 | 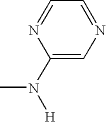 | 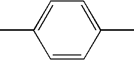 |
| II-1-20 | 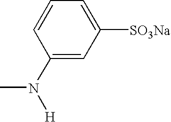 | 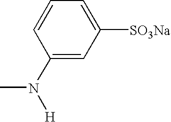 | 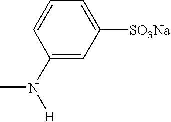 | 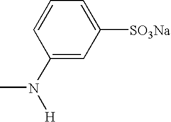 | 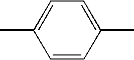 |
| II-1-21 | 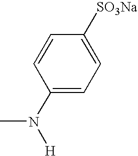 | 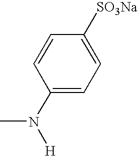 | 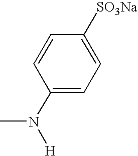 | 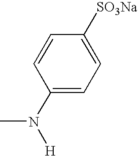 | 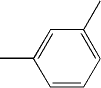 |
| II-1-22 | 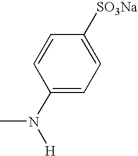 | 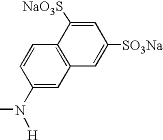 | 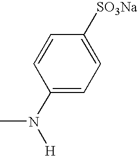 | 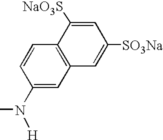 | 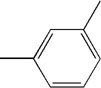 |
| II-1-23 | 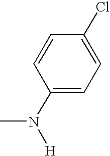 | 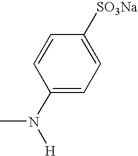 | 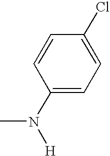 | 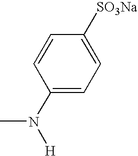 | 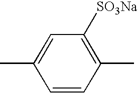 |
| II-1-24 | 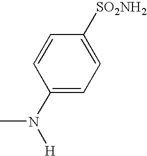 | 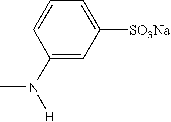 | 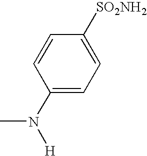 | 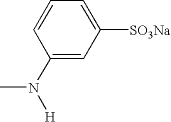 | 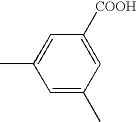 |

Subsequently, the compounds represented by Formula (II-2) according to the present invention will be described.

In aforesaid Formula (II-2), R₂₁-R₂₈ each independently represent a hydrogen atom, an alkyl group, an aryl group, or a heterocyclic group, while L₂ represents a phenylene group, a naphthylene group, an alkylene group, or a heterocyclic group.

Ra represents an alkyl group, an aryl group, or a heterocyclic group, while Rb represents a hydrogen atom, an alkyl group, or an aryl group.

R₂₁ and R₂₂, R₂₃ and R₂₄, R₂₅ and R₂₆, as well as R₂₇ and R₂₈ may bond to each other form a ring. However, the compounds represented by Formula (II-2) incorporates in the molecule at least one of the groups represented by —SO₃M, —CO₂M, and —OH in which M represents an alkaline metal ion, or an ammonium ion. Further, the compounds represented by Formula (II-2) incorporate neither —N═N— nor a diaminostilbene structure in the molecule.

The compounds represented by Formula (II-2) according to the present invention will now be detailed.

R₂₁-R₂₈ each independently represent a hydrogen atom, an alkyl group, an aryl group, or a heterocyclic group, and include those having a substituent. Listed as specific examples of the alkyl group, the aryl group, and the heterocyclic group represented by R₂₁-R₂₈ as well as *preferred groups may be those represented by R₁₁-R₁₈ in Formula (II-1).

L₂ represents a phenylene group, a naphthylene group, an alkylene group, or a heterocyclic group, and include those having a substituent. Listed as specific examples of the phenylene group and the naphthylene group represented by L₁ as well as preferred groups may be those similar to the phenylene group and the naphthylene group represented by L₁ in Formula (II-1).

The alkylene groups represented by L₂ are usable as long as both ends are methylene groups, and may incorporate an oxy group, a sulfide group, an imino group, and a sulfonyl group in the main chain.

The heterocyclic ring represented by L₂, as described herein, refers to a linking group in which two linking means extend from the position capable of being optionally substituted on a heteroatom containing aromatic ring or a non-aromatic ring. Specifically listed as heterocyclic rings represented by L₂, which may be used as a divalent linking group are furan, thiophene, pyrrole, pyridine, pyrimidine, pyridazine, pyrazine, isoquinoline, pyrazole, imidazole, triazole, oxazole, isooxazole, thiazole, benzoxazole, benzimidazole, benzothiazole, indazole, pyrrolidine, piperidine, morpholine, tetrahydropyrane, and dioxane.

Ra represents an alkyl group, an aryl group, or a heterocyclic group, and includes those having a substituent.

Listed as specific examples of the alkyl group, the aryl group, and the heterocyclic group represented by Ra and Rb may be those which are the same as the alkyl group, the aryl group, and the heterocyclic group represented by R₁₁-R₁₈ in Formula (II-1).

R₂₁ and R₂₂, R₂₃ and R₂₄, R₂₅ and R₂₆, as well as R₂₇ and R₂₈ may bond to each other to form a ring, and include those having a substituent. Listed as rings which are formed by combining R₂₁ with R₂₂, R₂₃ with R₂₄, R₂₅ with R₂₆, and R₂₇ with R₂₈ may be which are the same as the rings which are formed by combining R₁₁ with R₁₂, R₁₃ with R₁₄, R₁₅ with R₁₆, and R₁₇ with R₁₈ in Formula (II-1).

The compounds represented by Formula (II-2) incorporates in the molecule at least one of the groups represented by —SO₃M, —CO₂M, and —OH in which M is as defined for M in Formula (II-1). Further, the compounds represented by Formula (II-2) incorporated neither —N═N— nor a diaminostilbene structure in the molecule.

Specific examples of the compounds represented by Formula (II-2) according the present invention are listed below, however the present invention is not limited thereto.

| | 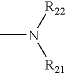 | 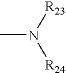 | 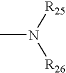 | 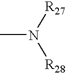 | 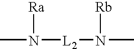 |
|---|---|---|---|---|---|
| II-2-1 | 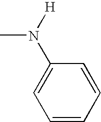 | 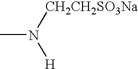 | 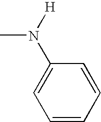 | 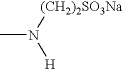 | 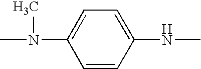 |
| II-2-2 | 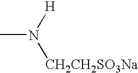 | 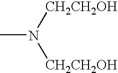 | 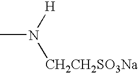 | 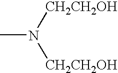 | 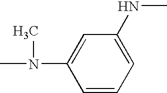 |
| II-2-3 | 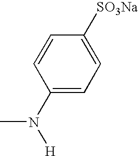 | 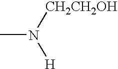 | 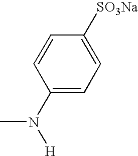 | 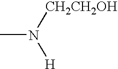 | 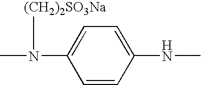 |
| II-2-4 | 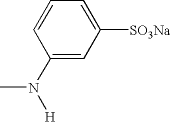 | 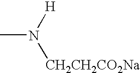 | 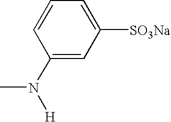 | 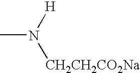 | 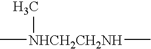 |
| II-2-5 | 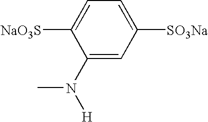 | 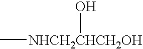 | 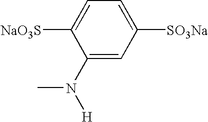 | 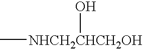 | 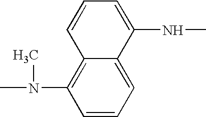 |
| II-2-6 | 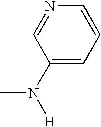 | 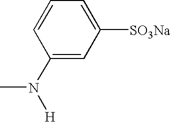 | 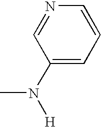 | 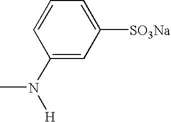 | 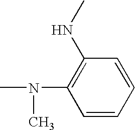 |
| II-2-7 | 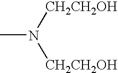 | 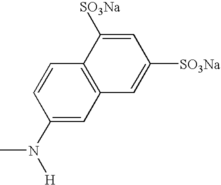 | 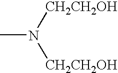 | 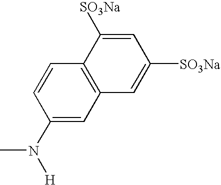 | 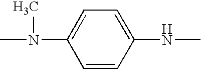 |
| II-2-8 | 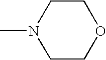 | 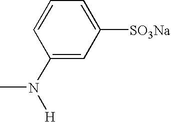 | 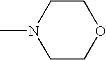 | 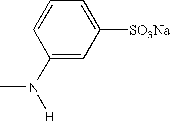 | 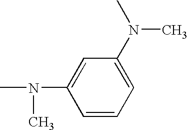 |
| II-2-9 | 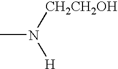 | 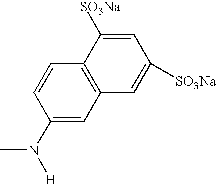 | 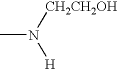 | 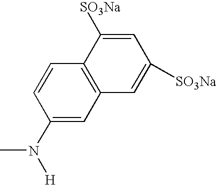 | 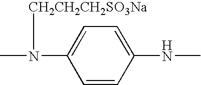 |
| II-2-10 | 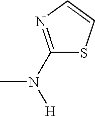 | 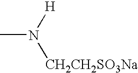 | 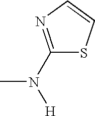 | 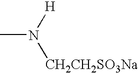 | 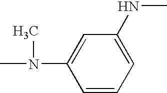 |

The compounds represented by Formula (II-3) according to the present invention will now be described.

In above Formula (II-3), R₃₁-R₃₄ each independently represent a hydrogen atom, an alkyl group, an aryl group, or a heterocyclic group. L₃ represents a phenylene group, a naphthylene group, an alkylene group, or a heterocyclic group. A₃₁ and A₃₂ each independently an alkoxy group, an aryloxy group, a heterocyclic oxy group, an alkylthio group, a heterocyclic thio group, or a hydroxylamino group. R₃₅ and R₃₆ each independently represent a hydrogen atom, an alkyl group, an aryl group, or a heterocyclic group.

R₃₁ and R₃₂ as well as R₃₃ and R₃₄ may bond to each other to form a ring. However, the compounds represented by Formula (II-3) incorporates in the molecule at least one of the groups represented by —SO₃M, —CO₂M, and —OH in which M, represents an alkaline metal ion, or an ammonium ion. Further, the compounds represented by Formula (II-3) incorporate neither —N═N— nor a diaminostilbene structure in the molecule.

The compounds represented by above Formula (II-3) will now be detailed.

In Formula (II-3), R₃₁-R₃₄ each independently represent a hydrogen atom, an alkyl group, an aryl group, or a heterocyclic group and include those having a substituent. L₃ represents a phenylene group, a naphthylene group, an alkylene group, or a heterocyclic group and include those having a substituent. Listed as specific examples of R₃₁-R₃₄ and preferred examples thereof may be those which are the same as R₁₁-R₁₈ in Formula (II-1).

A₃₁ and A₂₃ each independently represent an alkoxy group, an aryloxy group, a heterocyclic oxy group, an alkylthio group, an arylthio group, a heterocyclic thio group, and a hydroxyamino group.

Listed as alkyl groups constituting the alkoxy groups represented by A₃₁ and A₃₂ are those which are the same as the alkyl groups represented by R₁₁-R₁₈ in Formula (II-1).

Listed as aryl groups constituting the aryloxy groups represented by A₃₁ and A₃₂ are those which are the same as the aryl groups represented by R₁₁-R₁₈ in Formula (II-1).

Listed as heterocyclic groups constituting the heterocyclic oxy groups represented by A₃₁ and A₃₂ are those which are the same as the heterocyclic groups represented by R₁₁-R₁₈ in Formula (II-1).

Listed as the alkyl groups, the aryl groups and the heterocyclic groups constituting the alkylthio groups, the arylthio groups, and the heterocyclic thio groups represented by A₃₁ and A₃₂ may be those which are the same as the alkyl groups, the aryl groups, and the heterocyclic groups represented by R₁₁-R₁₈ in Formula (II-1).

The alkyl groups, the aryl groups, and the heterocyclic groups represented by R₃₅ and R₃₆ are as defined for Ra and Rb in Formula (II-2).

However, the compounds represented by Formula (II-3) incorporates in the molecule at least one of the groups represented by —SO₃M, —CO₂M, and —OH in which M is as defined for M in Formula (II-1).

Further, the compounds represented by Formula (II-3) incorporate neither —N═N— nor a diaminostilbene structure in the molecule.

Specific examples of the compounds represented by Formula (II-3) according to the present invention are listed, however the present invention is not limited thereto.

| | —A₃₁ | 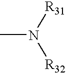 | —A₃₂ | 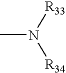 | 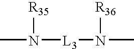 |
|---|---|---|---|---|---|
| II-3-1 | —SCH₂COOH | 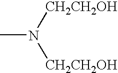 | —SCH₂COOH | 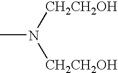 | 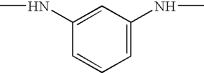 |
| II-3-2 | —SCH₂COOH | 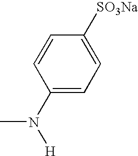 | —SCH₂COOH | 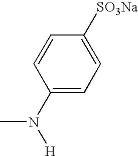 | 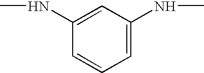 |
| II-3-3 | 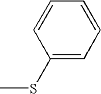 | 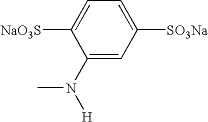 | 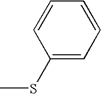 | 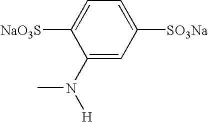 | 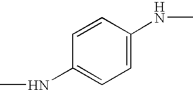 |
| II-3-4 | —SCH₂COOH | 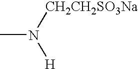 | —SCH₂COOH | 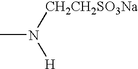 | 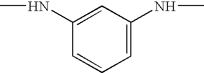 |
| II-3-5 | 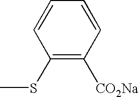 | 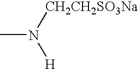 | 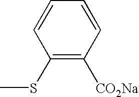 | 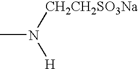 | 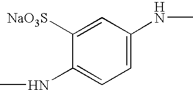 |
| II-3-6 | 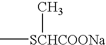 | 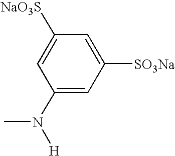 | 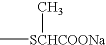 | 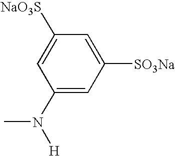 | 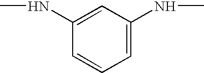 |
| II-3-7 | —SCH₂COOH | 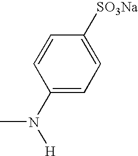 | —SCH₂COOH | 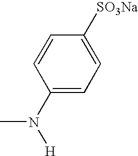 | 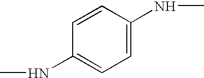 |
| II-3-8 | —SCH₂COOH | 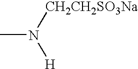 | —SCH₂COOH | 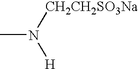 | 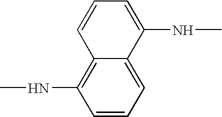 |
| II-3-9 | —SCH₂COOH | 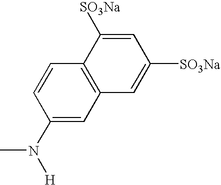 | —SCH₂COOH | 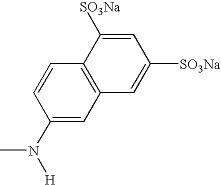 | 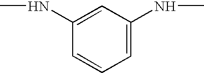 |
| II-3-10 | —SCH₂COOH | 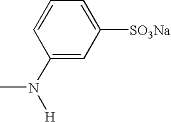 | —SCH₂COOH | 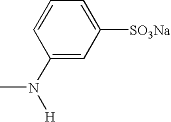 | 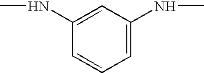 |
| II-3-11 | —SCH₂COOH | 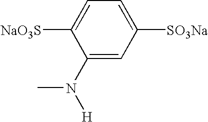 | —SCH₂COOH | 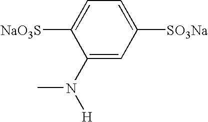 | 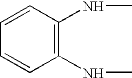 |
| II-3-12 | 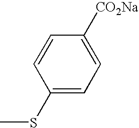 | 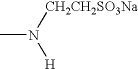 | 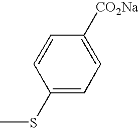 | 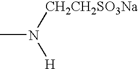 | 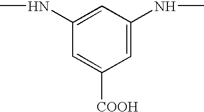 |
| II-3-13 | —SCH₂COOH | 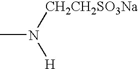 | —SCH₂COOH | 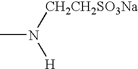 | 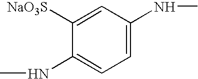 |
| II-3-14 | —SCH₂COOH | 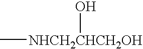 | —SCH₂COOH | 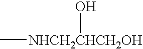 | 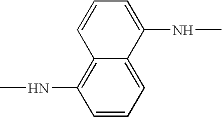 |
| II-3-15 | —SCH₂CH₂SO₃Na | —NHCH₂CH₂OH | —SCH₂CH₂SO₃Na | —NHCH₂CH₂OH | 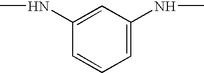 |
| II-3-16 | —SCH₂COOH | 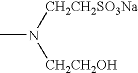 | —SCH₂COOH | 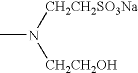 | 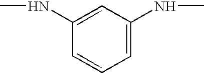 |
| II-3-17 | 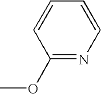 | 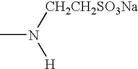 | 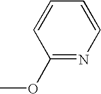 | 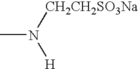 | 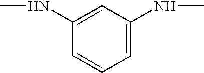 |
| II-3-18 | 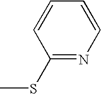 | 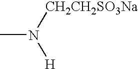 | 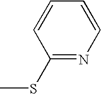 | 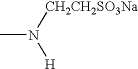 | 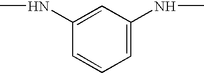 |
| II-3-19 | 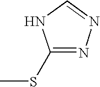 | 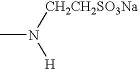 | 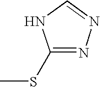 | 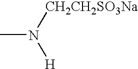 | 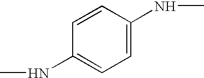 |
| II-3-20 | 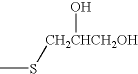 | 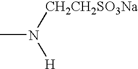 | 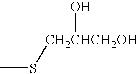 | 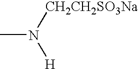 | 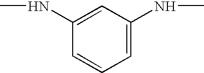 |
| II-3-21 | —OCH₃ | —NH—CH₂CH₂SO₃Na | —OCH₃ | —NH—CH₂CH₂SO₃Na | 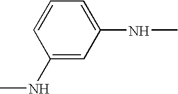 |
| II-3-22 | 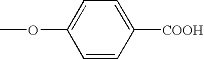 | 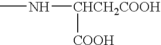 | 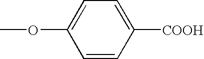 | 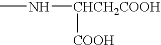 | 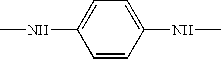 |
| II-3-23 | 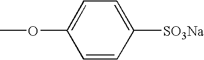 | —NH—CH₂CH₂SO₃Na | 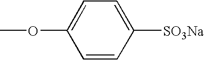 | —NH—CH₂CH₂SO₃Na | 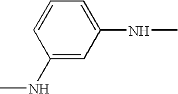 |
| II-3-24 | 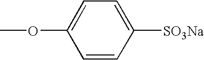 | 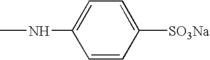 | 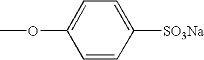 | 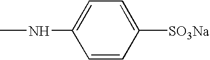 | 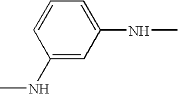 |
| II-3-25 | —O—CH₂COONa | —NH—CH₂CH₂SO₃Na | —O—CH₂COONa | —NH—CH₂CH₂SO₃Na | 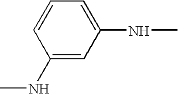 |
| II-3-26 | —NHOH | —NH—CH₂CH₂SO₃Na | —NHOH | —NH—CH₂CH₂SO₃Na | 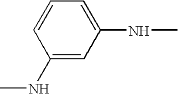 |
| II-3-27 | —O—CH₂CH₂OH | —N(CH₂CH₂OH)₂ | —O—CH₂CH₂OH | —N(CH₂CH₂OH)₂ | 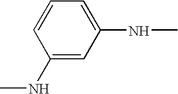 |

The compounds represented by Formula (II-4) according to the present invention will now be described.

In above Formula (II-4), L₄ represents a phenylene group, a naphthylene group, or an alkylene group.

X₁ represents an oxygen atom or a sulfur atom, while X₂ represents an oxygen atom, a sulfur atom, or —NH—. A₄₁, A₄₂, A₄₃, and A₄₄ each independently represent an alkoxy group, an aryloxy group, a heterocyclic oxy group, an alkylthio group, an arylthio group, a heterocyclic thio group, a hydroxylamino group, or —NR₄₁R₄₂ (R₄₁ and R₄₂ each independently represent a hydrogen atom, an alkyl group, an aryl group, or a heterocyclic group, and R₄₁ and R₄₂ may bond to each other to form a ring).

The compounds represented by Formula (II-4) incorporates in the molecule at least one of the groups represented by —SO₃M, —CO₂M, and —OH in which M represents an alkaline metal ion, or an ammonium ion. Further, the compounds represented by Formula (II-4) incorporate neither —N═N— nor a diaminostilbene structure in the molecule.

The compounds represented by Formula (II-4) according to the present invention will further be described.

L₄ in Formula (II-4) represents a phenylene group, a naphthylene group, or an alkylene group and include those having a substituent. Listed as a phenylene group, a naphthylene group, and an alkylene group are those similar to L₂ in Formula (II-2).

The alkoxy groups, the aryloxy groups, the heterocyclic oxy groups, the alkylthio groups, the arylthio groups, and the heterocyclic thio groups represented by A₄₁-A₄₄ include those having a substituent. Listed as examples are those which are the same as A₃₁ and A₃₂ in Formula (II-3). When A₄₁-A₄₄ each represent —NR₄₁R₄₂, a ring formed by combining R₄₁ with R₄₂ includes one having a substituent, and listed are those which are the same as R₁₁-R₁₈ in Formula (II-1).

In Formula (II-4), X₁ represents an oxygen atom or a sulfur atom, while X₂ represents a oxygen atom, a sulfur atom, or —NH—.

However, the compounds represented by Formula (II-4) incorporate in the molecule at least one of the groups represented by —SO₃M, —CO₂M, and —OH in which M is as defined for M in Formula (II-1).

Further, the compounds represented by Formula (II-4) incorporate neither —N═N— nor a diaminostilbene structure in the molecule.

Specific examples of the compounds represented by Formula (II-4) are listed below, however the present invention is not limited thereto.

| | —A₄₁ | —A₄₂ | —A₄₃ | A₄₄ | —X₁—L₄—X₂— |
|---|---|---|---|---|---|
| II-4-1 | —OCH₃ | 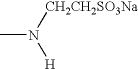 | —OCH₃ | 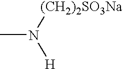 | 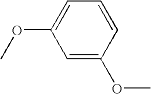 |
| II-4-2 | —SCH₂COOH | 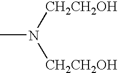 | —SCH₂COOH | 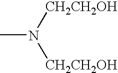 | 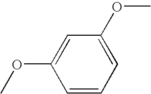 |
| II-4-3 | 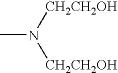 | 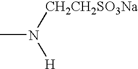 | 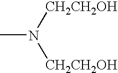 | 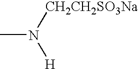 | 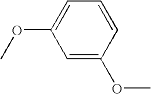 |
| II-4-4 | 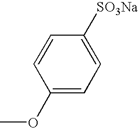 | 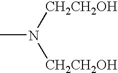 | 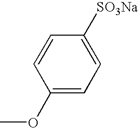 | 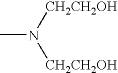 | 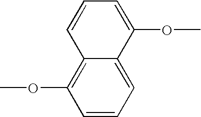 |
| II-4-5 | —OCH₃ | 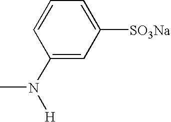 | —OCH₃ | 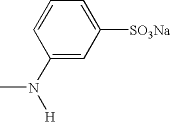 | 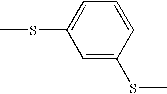 |
| II-4-6 | 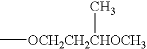 | 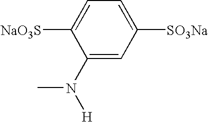 | 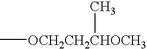 | 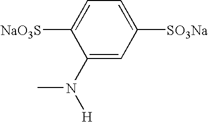 | —SCH₂CH₂OCH₂CH₂S— |
| II-4-7 | 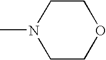 | 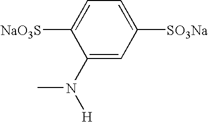 | 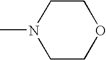 | 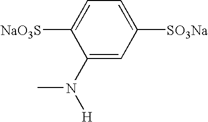 | 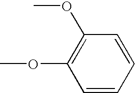 |
| II-4-8 | 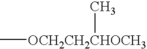 | 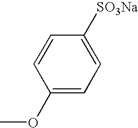 | 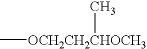 | 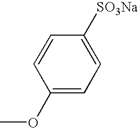 | 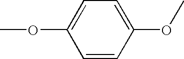 |
| II-4-9 | 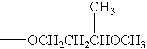 | 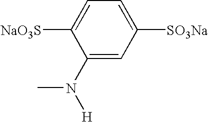 | 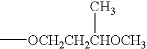 | 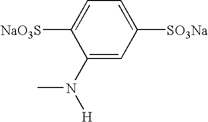 | 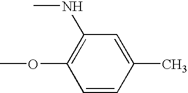 |
| II-4-10 | 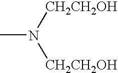 | 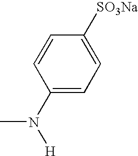 | 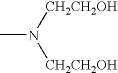 | 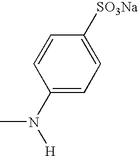 | —SCH₂CH₂CH₂CH₂S— |
| II-4-11 | 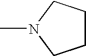 | 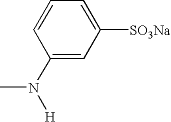 | 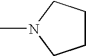 | 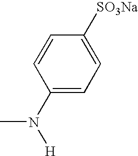 | 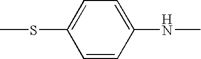 |
| II-4-12 | —SCH₂COOH | 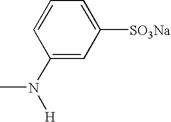 | —SCH₂COOH | 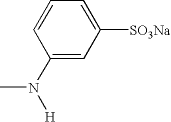 | 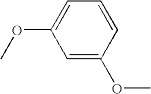 |
| II-4-13 | 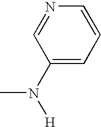 | 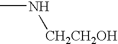 | 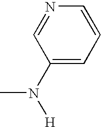 | 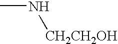 | —OCH₂CH₂NH— |
| II-4-14 | 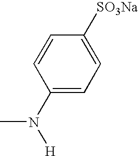 | 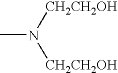 | 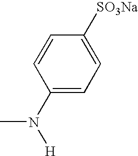 | 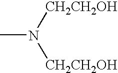 | —OCH₂CH₂OCH₂CH₂O— |

It is possible to add, in the form of an optional salt such-as a sodium salt or an ammonium salt, the compounds exemplified as above, represented by Formula (I) (hereinafter described as Formula (I) including Formulas (II), (III), as well as Formulas (II-1)-(II-4)).

In cases in which the compounds represented by Formula (I) according to the present invention incorporate a plurality of asymmetric carbon atoms in the molecule, a plurality of stereoisomers exists with respect to the same structure. The present invention includes all the possible stereoisomers, and it is possible to employ one of a plurality of stereoisomers or combinations of some of them.

Further, in the present invention, only one of the compounds represented by Formula (I) according to the present invention may be employed, but it is preferable to use a mixture of at least two compounds depending on the need to enhance solubility.

In view of the effects of the present invention, the addition amount of the compounds represented by Formula (I) according to the present invention to a stabilizer or a rinsing solution is preferably 0.1-20 mmol per liter of the working solution, but is most preferably 0.5-10 mmol per liter.

Further, it is possible to simultaneously employ the compounds represented by Formula (I) and triazinylstilbene compounds. For example, it is possible to simultaneously employ the triazinylstilbene compounds described in each of JP-A Nos. 6-329936, 7-140625, 10-104809, and 2000-39690. Commercially available compounds are described, for example, in “Senshoku Note (Dying Notes)”, 19th Edition (Shikisen Sha), pages 165-168. Of the products described in the above, preferred is BLANKOPHOR BSU liq. or HAKKOL BRK.

It is possible to synthesize the compounds represented by Formula (I) with reference to, for example, page 528 of Volume 17 of Yuki Gosei Kagaku Kyokaishi (Journal of Synthetic Organic Chemistry, Japan) and Japanese Registered Patent No. 2618748. Namely, preferred is a method in which first, cyanuric chloride is allowed to react with a phenylenediamine derivative or a naphthalenediamine derivative and subsequently, is allowed to successively react with amines. Alternatively, it is also preferable that the phenylenediamine derivative or the naphthalenediamine derivative is allowed to react in the second stage or the final stage. Listed as solvents which are usable in the above reaction are water and organic solvents such as alcohols, ketones, ethers, or amides. Of these, preferred are water and water-soluble organic solvents, as well as a mixture of these solvents. Of these, most preferred are mixtures of water and acetone. Further listed as employed bases are organic bases such as triethylamine, pyridine, or 1,8-diazacyclo[5,4,0]-7-undecene, as well as inorganic bases such as sodium hydroxide, potassium hydroxide, sodium carbonate, potassium carbonate, sodium hydrogencarbonate, or potassium hydrogencarbonate. Of these, the inorganic bases are preferred of which sodium hydroxide, potassium hydroxide, sodium carbonate, and potassium carbonate are most preferred. The allowed reaction temperature is in the range of −20 to 150° C., but is preferably in the range of −10 to 100° C.; More specifically, it is preferable that the first stage is conducted in the range of −10 to 10° C., the second stage is conducted in the range of 0 to 40° C., and the third stage is conducted in the range of 40-100° C.

Appropriately employed in the stabilization processing composition of the present invention are components incorporated in common stabilizers such as chelating agents, chelating metal ions in water (for example, ethylenediamine tetraacetic acid, diethylenetriamine pentaacetic acid, and 1-hydroxyethylidene-1,1-disulfonic acid), buffering agents (for example, potassium carbonate, borates, acetates, and phosphates), mildewcides (for example, DIASIDE 702, produced by DuPont, U.S.A., p-chloro-m-cresol, and benzisothiazoline-3-one), optical brightening agents (for example, triazinylstilbene based compounds), antioxidants (for example, ascorbic acid salts), or water-soluble metal salts (for example, zinc salts and magnesium salts).

Further, it is possible to incorporate sulfites, bisulfites, and metabisulfites. Irrespective of organic and inorganic substances, any of those which release a sulfite ion may be employed, but are preferably inorganic salts. Listed as specific examples of preferred compounds are sodium sulfite, potassium sulfite, ammonium sulfite, ammonium bisulfite, potassium bisulfite, sodium bisulfite, sodium bisulfite, potassium metabisulfite, and ammonium metabisulfite. Further, it is possible to incorporate sulfinic acid compounds, compounds having a pyrrolidone structure, and surface active agents.

In the stabilization processing composition of the present invention, it is preferable to employ at least one of the compounds represented by above Formula (IV) together with the compounds represented by Formula (I) according to the present invention. By realizing the above embodiment, adverse effects due to solids generated in a stabilization processing tank are reduced to achieve enhancement of white background. At the same time, maximized are effects which minimize a decrease in maximum density and formation of yellow stain due to adhered substances on color paper, derived from the stabilizer composition.

The triazylstilbene based optical brightening agents represented by Formula (IV) according the present invention will now be described.

In above Formula (IV), X₁, X₂, Y₁, and Y₂ each represent a hydroxyl group, a halogen atom such as chlorine or bromine, a morpholino group, an alkoxy group (for example, methoxy, and methoxyethoxy), an aryloxy group (for example, phenoxy and p-sulfophenoxy), an alkyl group (for example, methyl or ethyl), an aryl group (for example, phenyl and methoxyphenyl), an amino group, an alkylamino group (for example, methylamino, ethylamino, propylamino, dimethylamino, cyclohexylamino, β-hydroxyethylamino, di(β-hydroxylethyl)amino, β-sulfonylethylamino, N-(β-sulfoethyl)-N′-methylamino, and N-(β-hydroxyethyl-N′-methylamino), an arylamino group (for example, aniline, o-, m-, p-sulfoanilino, o-, m-, p-chloroanilino, o-, m-, p-toluidino, o-, m-, p-carboxyanilino, o-, m-, p-hydroxyanilino, sulfonaphthylamino, o-, m-, p-aminoanilino, and o-, m-, p-anidino), and M represents a hydrogen atom, sodium, potassium, ammonium, or lithium.

Specific examples of the compounds represented by Formula (IV) will follow, however the present invention is not limited to these exemplified compounds.
(Exemplified Compounds)

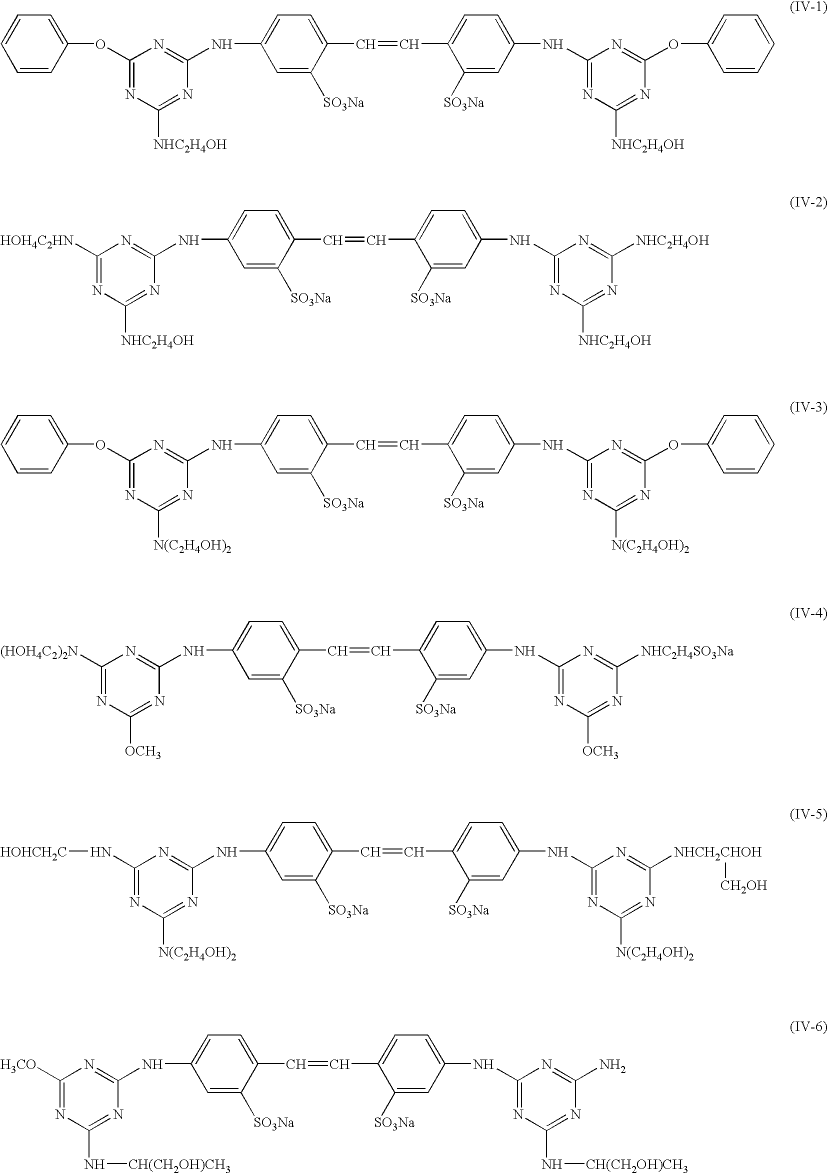

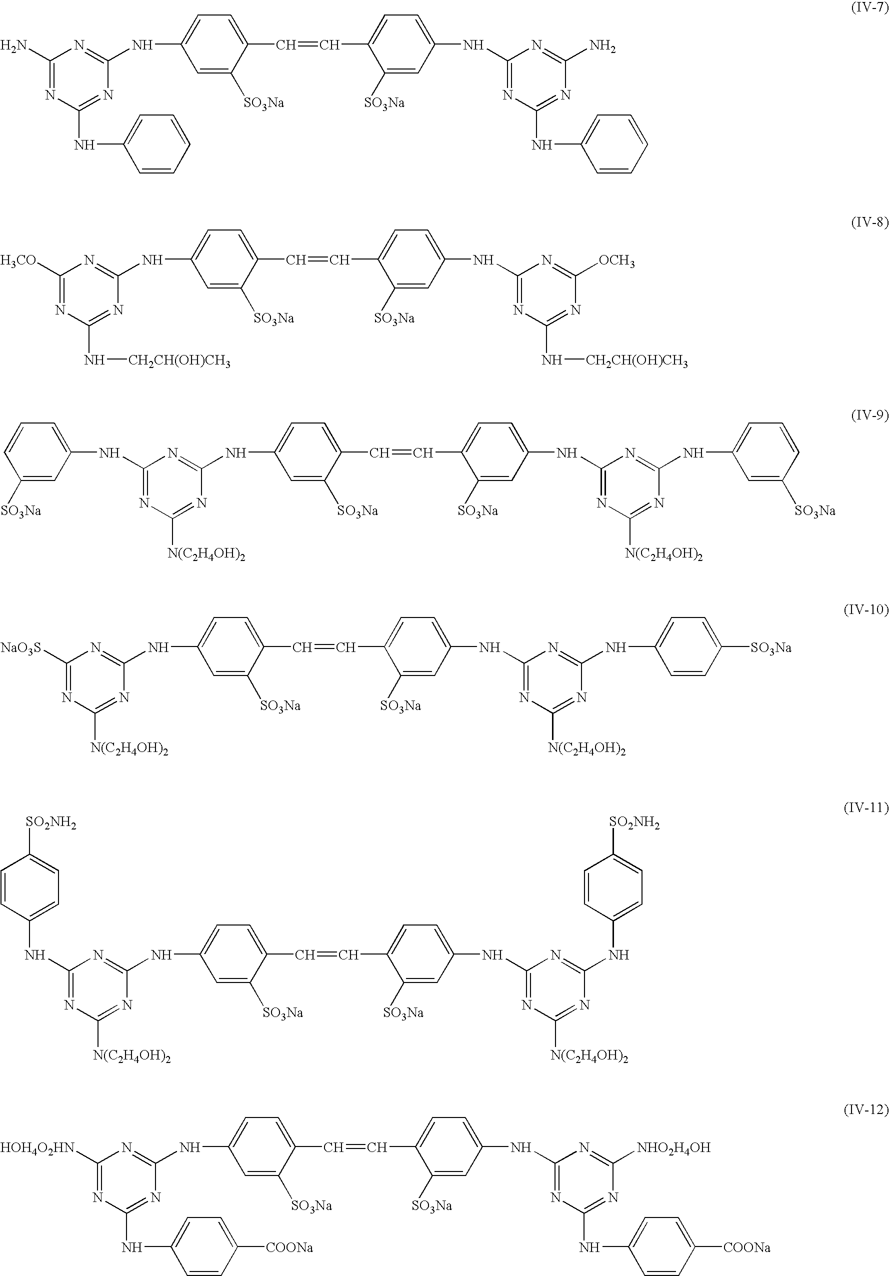

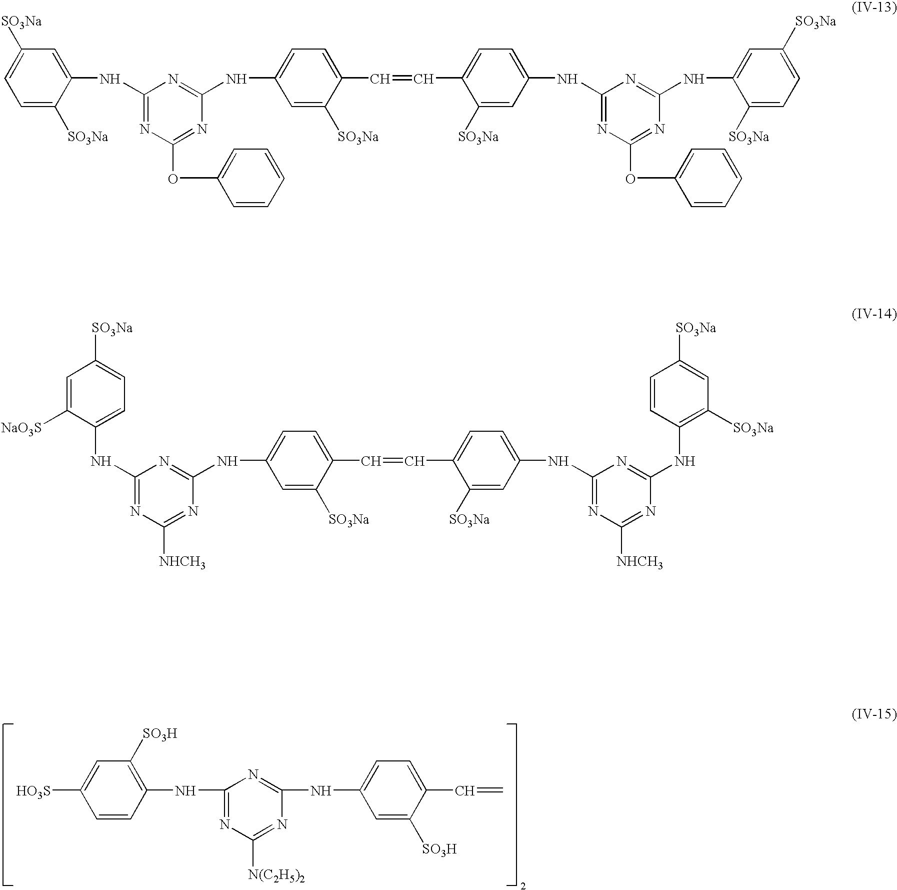

It is possible to synthesize triazylstilbene based optical brightening agents represented by Formula (IV), employing conventional methods described, for example, on page 8 of “Keiko Zohakuzai (Optical Brightening Agents)” edited by Kaseihin Kogyo Kyokai (published in August, 1976).

The addition amount of the triazylstilbene based optical brightening agents represented by Formula (IV) to a stabilizer composition is preferably in the range of 0.2-6.0 g per L, but is most preferably in the range of 0.4-3.0 g.

It is possible to add various compounds which are added to the stabilizer as described above in any form of salt. In the stabilization processing composition of the present invention, the feature is that the ratio of the ammonium salt is controlled to be less than 50 mol percent with respect to the total cations. When the above ratio is at least 50 mol percent, increased formation of yellow stains results during extended storage at high temperature of processed silver halide light-sensitive color photographic materials.

In the present invention, the ratio of ammonium salts is preferably less than 25 percent. Specifically, an embodiment is preferred in which the stabilizer incorporates no ammonium salts.

If the stabilization processing composition of the present invention is composed of solid processing agents, the object of the present invention is effectively realized. Of solid processing agents, those in the form of tablets are most preferred.

Solidification of photographic processing agents is performed employing optional methods in which a concentrated solution or minute particle powders or particles of photographic agents are kneaded with water-soluble binders and molded, or water-soluble binders are sprayed onto the surface of temporarily molded photographic agents to form a covering layer. Reference may be made to the content described, for example, in JP-A Nos. 4-29136, 4-85533, 4-85534, 4-85535, 4-85536, and 4-172341.

The preferred production method of tablets is one in which after granulating powdered solid processing agents, molding is performed employing a tablet-making process. Tablets produced as above result in more desired solubility and retention property compared to solidified processing agents which are molded employing a tablet making process after simply mixing solid processing agent components, whereby an advantage results in which photographic performance is stabilized.

Employed as a granulation method for tablet making may be conventional methods such as rolling granulation, extrusion granulation, compression granulation, shredding granulation, agitation granulation, fluidized bed granulation, or spray-dry granulation. For making tablets, the average diameter of the resulting particles is preferably 100-800 μm, but is more preferably 200-700 μm so that non-uniformity of components, so-called segregation hardly occurs when the above particles are mixed and compressed under pressure. Further, the preferred size distribution is such that at least 60 percent of the particles are within a deviation of ±10-150 μm. The resulting particles are employed as granules without any additional treatment. Subsequently, when the resulting particles are compressed under pressure, it is possible to use conventional compressors such as a hydraulic oil press, a single-shot tablet machine, a rotary type tablet machine, or a briquetting machine. It is possible to form any common shape of solid processing agents obtained via pressurized compression. However, in view of productivity, handling, and a powder dust problem during use by customers, a cylindrical shape, a so-called tablet is preferred.

It is more preferable that each of the components such as an alkali agent, a reducing agent, a bleaching agent, or a preserver is individually granulated, whereby the above effects are more pronounced.

It is possible to produce tablet processing agents employing common methods described, for example, in JP-A Nos. 51-61837, 54-155038, and 52-88025, as well as British Patent No. 1,213,803. Further, it is possible to produce granule processing agents employing common methods described in JP-A Nos. 2-109042, 2-109043, 3-39735, and 3-39739. Still further, it is possible to produce powder processing agents employing common methods described, for example, in JP-A No. 54-133332, British Patent No. 725,892 and 729,862, as well as German Patent No. 3,733,861.

It is possible to vary the processing temperature during the stabilization process depending on the types of silver halide light-sensitive color photographic materials to be processed and characteristics thereof. The above processing temperature is preferably 15-45° C., but is more preferably 20-40° C. It is possible to optionally set the processing time. However, in view of a decrease in processing time, a shorter time is desired. The processing time is preferably 5 seconds-1 minute and 45 seconds, but is more preferably 10 seconds-1 minute.

In view of the running cost, a decrease in the effluent amount and handling property, a lower replenishment rate is more preferred. The specific replenishment rate is preferably 0.5-50 times the carry-over rate per unit area from the previous bath, but is more preferably 3-40 times. Further, the replenishment rate is preferably at most 1 liter per m² of the silver halide light-sensitive color photographic material, but is more preferably at most 500 ml. Further, the replenishment may be performed continuously or intermittently.

In the present invention,sa stabilization process employing a stabilizer may be composed of one or more tanks. However, it is preferable to employ a cascaded counter-current system composed of at least two tanks.

The cascaded counter-current system, as described herein, refers to a system in which in the stabilization tank which is divided into at least two portions, the stabilization process is performed in such a manner that the stabilizer flows along the conveying path of the silver halide light-sensitive color photographic material while overflowing into each cascade-divided stabilization tank from downstream to upstream in the light-sensitive material conveying direction.

In the processing method of silver halide light-sensitive color photographic materials according to the present invention, exposed silver halide light-sensitive color photographic materials are subjected to a color development process (employing a color developer), a bleaching process (employing a bleach), a fixing process (employing a fixer) or a bleach-fixing process (employing a bleach-fixer), and a stabilization process (employing a stabilizer), and subsequently dried. Further, it is possible to perform a photographic process while replenishing each of the color developer replenisher, the bleach replenisher, the fixer replenisher or the bleach-fix replenisher,.and the stabilizer replenisher. The color developer, the bleach, the bleach-fixer, and the fixer employed in the present invention will now be described.

Examples of preferred color developing agents employed in the color developer according to the present invention include conventional aromatic primary amine color developing agents, specifically p-phenylenediamine derivatives. The representative examples are shown below, however the present invention is not limited thereto.
1) N,N-diethyl-p-phenylenediamine
2) 4-amino-3-methyl-N,N-diethylaniline
3) 4-amino-N-(β-hydroxylethyl)-N-methylaniline
4) 4-amino-N-ethyl-N-(β-hydroxylethyl)aniline
5) 4-amino-3-methyl-N-ethyl-N-(β-hydroxyethyl)aniline
6) 4-amino-3-methyl-N-ethyl-N-(3-hydroxypropyl)aniline
7) 4-amino-3-methyl-N-ethyl-N-(4-hydroxybutyl)aniline
8) 4-amino-3-methyl-N-ethyl-N-(β-methanesulfonamidoethyl)aniline
9) 4-amino-N,N-diethyl-3-(β-hydroxyethyl)aniline
10) 4-amino-3-methyl-N-ethyl-N-(β-methoxyethyl)aniline
11) 4-amino-3-methyl-N-ethyl-(β-ethoxyethyl)-N-ethylaniline
12) 4-amino-3-methyl-N-(3-carbamoylpropyl)-N-n-propyl-aniline
13) 4-amino-N-(4-carbamoylbutyl)-N-n-propyl-3-methylaniline
14) N-(4-amino-3-methylphenyl)-3-hydroxypyrrolidine
15) N-(4-amino-3-methylphenyl)-3-(hydroxymethyl)pyrrolidine
16) N-(4-amino-3-methylphenyl)-3-pyrrolidinecarbooxide

Of the above p-phenylenediamine derivatives, particularly preferred are Exemplified Compounds 5), 6), 7), 8), and 12) of which Exemplified Compounds 5) and 8) are most preferred. Further these p-phenylenediamine derivatives may be in the form of salts such as a sulfate, a hydrochloride, a sulfite, a naphthalenedisulfonate, or a p-toluenesulfonate, or in the form of free basic type (also called a free radical). The concentration of the above aromatic primary amine developing agents in the working solution is preferably 2-200 mmol per liter of the developer, is more preferably 6-100 mmol, but is most preferably 10-40 mmol per liter.

In the color developer employed in the present invention, in order to minimize a decrease in the color developing agents due to oxidation, it is preferable to incorporate preservers. Listed as representative preservers are hydroxylamine derivatives. Listed as the hydroxylamine derivatives usable in the present invention are, other than hydroxylamine salts such as hydroxylamine sulfates or hydroxylamine hydrochlorides, hydroxylamine derivatives described, for example, in JP-A Nos. 1-97953, 1-186939, 1-186940, and 1-187557. Specifically preferred are the hydroxylamine derivatives represented by following Formula (A). 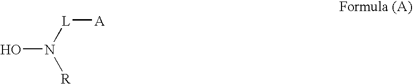
wherein L represents an alkylene group which may be substituted; A represents a carboxyl group, a sulfo group, a phosphono group, a phosphine group, a hydroxyl group, an amino group which may be subjected to alkyl substitution, an ammonia group which may be subjected to alkyl substitution, a carbamoyl group which may be subjected to alkyl substitution, a sulfamoyl group which may be subjected to alkyl substitution, an alkylsulfonyl group, a hydrogen atom, an alkoxy group, or —O—(B—O)ₙ—R′, wherein R and R′ each represent a hydrogen atom and an alkyl group which may be substituted; B represents an alkylene group which may be substituted; and n represents an integer of 1-4.

In above Formula (A), L is preferably an alkylene group having 1-10 carbon atoms in which the straight or branched chain is substituted, and the number of carbon atoms is more preferably 1-5. Specifically, a methylene, ethylene, trimethylene, or propylene group is listed as a preferred example. The substituents include a carboxyl group, a sulfo group, a phosphono group, a phosphine group, a hydroxyl group, an ammonio group which may be subjected to alkyl substitution. Of these, listed, as preferred examples are the carboxyl group, the sulfo group, the phosphine group, and the hydroxyl group. Listed as preferred examples of the groups represented by A are a carboxyl group, a sulfo group, a phosphono group, a phosphine group, and a hydroxyl group, as well as an amino group, an ammonio group, a carbamoyl group, or a sulfamoyl group, each of which may be subjected to alkyl substitution. Listed as preferred examples are the carboxyl group, the sulfo group, the hydroxyl group, the phosphono group and the carbamoyl group which may be subjected to alkyl substitution. Listed as preferred examples of -L-A, may be a carboxymethyl group, a carboxyethyl group, a carboxypropyl group, a sulfoethyl group, a sulfobutyl group, a phosphonomethyl group, a phosphonoethyl group, and a hydroxyethyl group. Listed as specifically preferred examples are the carboxyymethyl group, the carboxymethyl group, the sulfoethyl group, the sulfopropyl group, the phosphonomethyl group, and the phosphonoethyl group. R is preferably a hydrogen atom, an alkyl group having 1-10 carbon atoms of which a straight or branched chain may be substituted, and the number of carbon atoms is most preferably 1-5. Listed as substituents are a darboxyl group, a sulfo group, a phosphono group, a phosphine group, and a hydroxy group, as well as an amino group, an ammonio group, a carbamoyl group, a sulfamoyl group, and —O—(B—O)n-. R′, each of which may be subjected to alkyl substitution. Incidentally, B and R′ each are as defined for those listed in the description of above A. There may be at least two substituents. Listed as preferred examples of the compounds represented by R may be a hydrogen atom, a carboxymethyl group, a carboxymethyl group, a carboxypropyl group, a sulfoethyl group, a sulfopropyl group, a sulfobutyl group, a phosphonomethyl group, and a phosphonoethyl group. L and R may bond to each other to form a ring.

Examples of representative compounds represented by Formula (A) are listed below, however the present invention is not limited thereto.

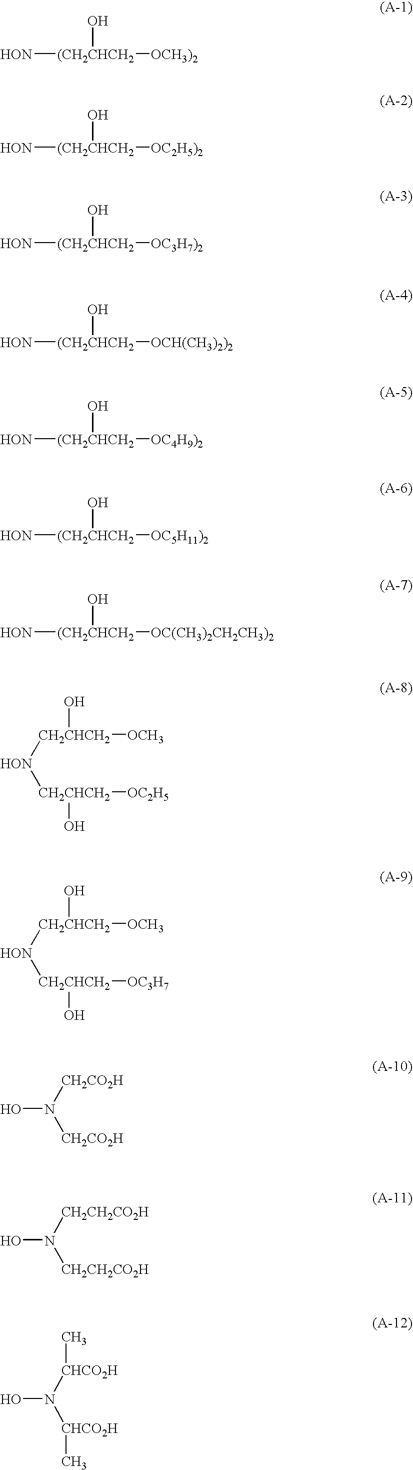

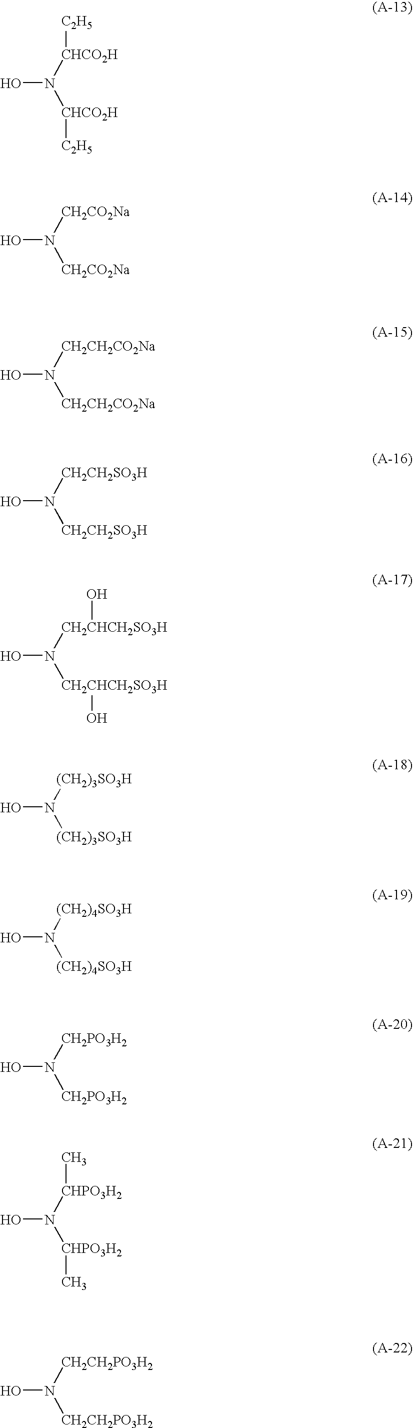

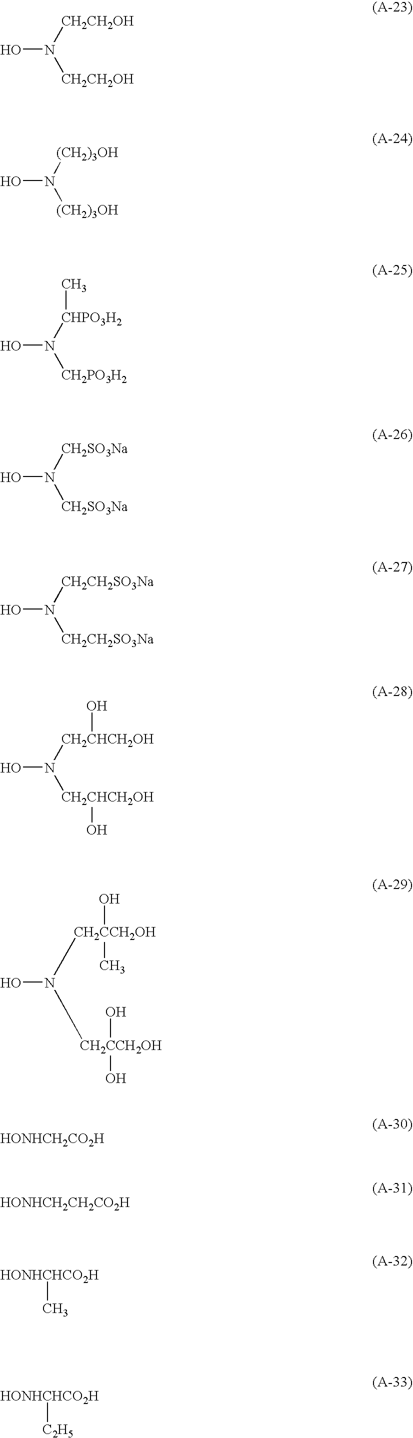

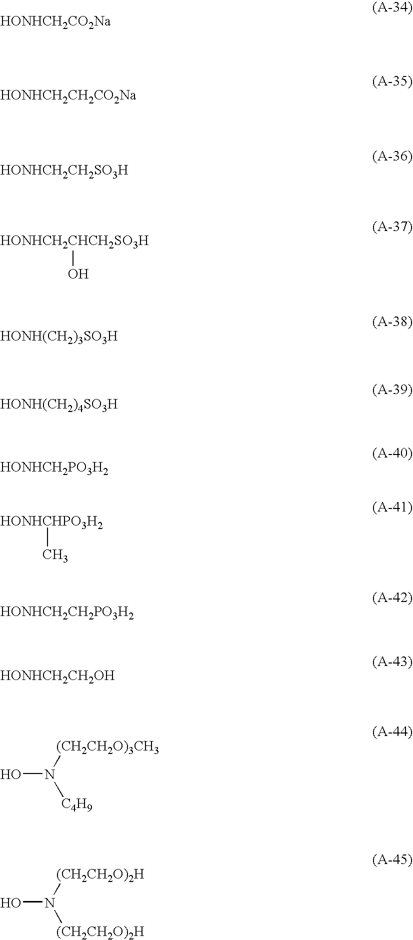

Further, it is preferred to employ sulfites as a preserver. Their concentration is preferably 0.005-1.0 mol/L of the color developer for color negative films, and is preferably zero −0.1 mol/L of the color developer for color papers. Listed as sulfites usable in the present invention may, for example, be sodium sulfite and potassium sulfite.

Other than the preservers described above, the use of the following preservers is not limited. Listed ma be hydroxamic acids, hydrazides, phenols, α-hydroxyketones, α-aminoketones, saccharides, diamies, polyamines, quaternary ammonium salts, nitroxy radicals, alcohols, oximes, diamido compounds, and condensed ring amines. These are described in JP-A Nos. 63-4235, 63-30845, 63-21637, 63-44655, 63-53551, 63-43140, 63-56654, 63-58346, 63-43138, 63-146041, 63-44657, and 63-44656; U.S. Pat. Nos. 3,615,503, 2,494,903; JP-A No. 52-143020; and Japanese Patent Publication No. 4830496.

In addition, if desired, incorporated may be various metals described in JP-A Nos. 57-44148 and 57-53749, salicylic acids described in JP-A No. 59-180588, alkanol amines, such as triethanolamine or triisopropanolamine, described in JP-A No. 54-3532, and aromatic polyhydroxy compounds described in U.S. Pat. No. 3,746,544.

The pH of the color developer employed in the present invention is preferably 9.0-13.5, but is more preferably 9.5-1.0. It is possible to incorporate alkalis, buffering agents, and if desired, acids to maintain the specified pH.

When a color developer is prepared, in view of maintaining the pH in the above range, it is preferable to employ the following buffering agents. Employed as buffering agents may be carbonates, phosphates, borates, tetraborates, hydroxybenzoates, glycyl salts, N,N-dimethylglycine salts, leucine-salts, norleucine salts, quanine salts, 3,4-dihydroxyphenylalanine salts, alanine salts, aminobutyrates, 2-amino-2-methyl-1,3-propanediol salts, valine salts; proline salts, trishydroxyaminomethane salts, and lysine salts. Specifically, carbonates, phosphates, tetraborates, and hydroxybenzoates result in excellent buffering capability in a high pH region of at least 10.0. Further, their addition to the color developer does not result in adverse effects (such as fogging) for the photographic performance and their cost is low, whereby they are preferred as buffering agents.

Listed as exemplified compounds of the above buffering agents may-be sodium carbonate, potassium carbonate, sodium bicarbonate, potassium bicarbonate, trisodium phosphate, tripotassium phosphate, disodium phosphate, dipotassium phosphate, sodium borate, potassium borate, sodium tetraborate (borax), potassium tetraborate, sodium o-hydroxybenzoate (sodium salicylate), potassium o-hydroxybenzoate, sodium 5-sulfo-2-hydroxybenzdate (sodium 5-sulfosalicylate), and potassium 5-sulfo-2-hydroxybenzoate (potassium 5-sulfosalicylate), however the present invention is not limited these compounds.

The addition amount of these buffering agents is preferably 0.01-2 mol per liter of the color developer, but is more preferably 0.1-0.5 mol.

As other components, added to the color developer employed in the present invention may, for example, be calcium or magnesium precipitation inhibitors and various chelating agents which enhance its stability. Examples include nitrilotriacetic acid, diethylenetriaminepentaacetic acid, ethylenediaminetetraacetic acid, N,N,N-trimethylenephosphonic acid, ethylenediamine-N,N,N′,N′-tetramethylenesulfonic acid, transcylohexadiaminetetraacetic acid, 1,2-diaminopropanetetraacetic acid, ethylenediamineorthohydroxyphenylacetic acid, ethylenediaminesuccinic acid (being a SS form), N-(2-carboxylatethyl)-L-aspartic acid, β-alaninediacetic acid, 2-phosphonobutane-1,2,4-tricarboxylic acid, 1-hydroxyethylidne-1,1-diphosphocic acid, N,N′-bis(2-hydroxybenzyl)ethylenediamine-N,N′-diacetic acid, 1,2-hydroxybenzene-4,6-disulfonic-acid. If desired, at least two types of these chelating agents may simultaneously be employed. The necessary amount of these chelating agents is one which completely chelates metal ions in the working color developer. For example, addition is performed to result in 0.1-10 g per liter.

If desired, it is also possible to incorporate any of the development accelerators to the color developer employed in the present invention. Development accelerators, which can be incorporated, if desired, include thioether based compounds described in Japanese Patent Publication Nos. 37-16088, 37-5987, 38-7826; 44-12380, and 45-9019, as well as U.S. Pat. No. 3,813,247; p-phenylenediamine based compounds disclosed in JP-A Nos. 52-49829 and 50-15554; quaternary ammonium salts disclosed in JP-A No. 50-137726, Japanese Patent Publication No. 44-30074, JP-A Nos. 56-156826 and 52-43429; amine based compounds described in U.S. Pat. Nos. 2,494,903, 3,128,182, 4,230,796, and 3,253,919, Japanese Patent Publication No. 41-11431, U.S. Pat. Nos. 2,482,546, 2,596,926, and 3,582,346; polyalkylene oxides disclosed in Japanese Patent Publication Nos. 37-16088 and 42-25201, U.S. Pat. No. 3,128,183, Japanese Patent Publication Nos. 41-11431 and 42-23883, and U.S. Pat. No. 3,532,501; as well as others such as 1-phenyl-3-pyrazolidone or imadazoles. The concentration of these compounds is preferably 0.001-0.2 mol per liter of the color developer, but is more preferably 0.01-0.05-ml.

If desired, it is possible to incorporate any common antifoggants to the color developer. Listed as representative examples of organic antifoggant are nitrogen-containing heterocyclic compounds such as benzotriazole, 6-nitrobenzimidazole, 5-nitroisoindazole, 5-methylbenzotriazole, 5-nitrobenzotriazole, 5-chloro-nenzotriazole, 2-thiazolyl-benzimidazole, 2-thiazolylmethyl-benzimidazole, indazole, hydroxyazaindolidine, and adenine.

Further, if desired, it is possible to incorporate optical brightening agents in the color developer. Preferred as an optical brightening agent are bis(triazinylamino)stilbenesulfonic acid compounds. Employed as bis(triazinylamino)stilbenesulfonic acid are prior art or commercially available stilbene based optical brightening agents. Preferred as prior art bis(triazinylamino)stilbenesulfonic acid compounds are those described, for example, in JP-A Nos. 6-329936, 7-140625, and 10-140849. Commercially available compounds are described, for-example, in pages 165-168 of “Senshoku Note (Dying Note)” 9th Edition (Shikisen Sha), and of the compounds described therein, BLANKOPHOR BSU liq. and HAKKOL BRK are preferred.

Further, listed as other bis(triazinylamino)stilbenesulfonic acid compounds may be are Compounds I-1 to I-48 described in paragraphs [0038]-[0049] of JP-A No. 2001-2818²3, as well as Compounds II-1 to II-16 described in paragraph Nos. [0050]-[0052] of JP-A No. 2001-281823. The addition amount of the optical brightening agents described above is preferably 0.1 mmol-0.1 mol per liter of the color developer.

Further, the color developer for color negative films preferably incorporates bromide ions at 0.2×10⁻²−1.5×10⁻¹-mol/liter, but preferably 0.5×10⁻²−5.0×10⁻² mo/liter. Since bromide ions are commonly released into a working color developer as a by-product of development, occasionally, it is unnecessary to incorporate bromide ions in the replenisher. Further, the above color developer incorporates preferably iodide ions at 0.2×10⁻³−1.5×10⁻¹ mol/liter, but more preferably 0.5×10⁻³−0.5×10⁻³ mol/liter. Iodide ions are commonly released into the developer as a byproduct of development. On the contrary, released iodide ions are occasionally consumed upon being adsorbed by silver halide which is not developed. In order to maintain the iodide ion concentration in the color developer, no addition is required to the replenisher, or addition is occasionally required. Further, when bromide ions are incorporated in the color developer for color paper, the concentration is preferably at most 1.0×10⁻³ mol/liter. It is preferable that the color developer for color paper incorporates chloride ions in an amount of 3.5×10⁻²−1.5×10⁻¹. On the other hand,, since chloride ions are commonly released into the developer as a by-product of development, no occasional addition to the replenisher is required.

Further, the processing temperature of color development performed by the processing method of the present invention, when a light-sensitive material to be developed is color paper, is preferably 30-55° C., is more preferably 35-55° C., but is still more preferably 38-45° C. The color development time is preferably 5-90 seconds, but is more preferably 15-60 seconds. The replenishment rate is preferred to be as low as possible, is appropriately 15-600 ml per m² of the light-sensitive material, is preferably 15-120 ml, but is most preferably 30-60. ml. On the other hand, in the case of color negative film, the development temperature is preferably 20-55° C., is more preferably 30-55° C., but is still more preferably 38-45° C. The color development time is preferably 20 seconds-6 minutes, but is more preferably 30-200 seconds. The replenishment rate is preferably as low as possible, is appropriately 100-800 ml per m² of the light-sensitive material, but is most preferably 250-400 ml. The color development time, as described in the present invention, refers to the time between the entrance of a light-sensitive material into a color developer and the entrance of the same to the following process (for example, a bleach fixer). When processed employing an automatic processor, the color development time refers to the total of the time (so-called in-liquid time) during immersion of a light-sensitive material in the color developer and the time (so-called cross-over time) during which the light-sensitive material is conveyed out of the liquid to the following process after leaving the color developer. Further, the cross-over time is preferably at most 10 seconds, but is more preferably at most 5 seconds.

In the present invention, employed as a bleaching agent used in a bleaching solution or a bleach-fixer may be any of the bleaching agents, but specifically preferred are organic complexes of iron(III) (for example, complexes of aminopolycarboxylic acids such as ethylenediaminetetraacetic acid, diethylenetriaminepentaacetic acid, nitrilotriacetic acid, cyclohexanediaminetetraacetic acid, ethylenediaminesuccinic acid, aminopolyphosphonic acid, phosphonocarboxylic acid, and organic phosphonic acid); organic acids such as citric acid, tartaric acid, or malic acid; persulfate salts; or hydrogen peroxide.

Of these, preferred are iron(III) complex salts of ethylenediaminetetraacetic acid, diethylenetriaminepentaacetic acid, cyclohexaneaiaminetetraacetic acid, 1,3-diaminopropanetetraacetic acid, ethylenediaminetartaric acid, and methyliminodiacetic acid, since they exhibit high bleaching capability. These ferric ion complexes may be used in the form of a complex salt, or ferric ion complex salts may be formed in a solution employing ferric salts such as ferric: sulfate, ferric chloride, ferric nitrate, ammonium ferric sulfate, or ferric phosphate, together with chelating agents such as aminopolycarboxylic acid, aminopolyphosphonic acid, or phosphonocarboxylic acid. Further, chelating agents may be used in an amount which is greater than that necessary for forming the ferric complex salts. Of iron complexes, aminopolycarboxylic acid iron complexes are preferred, and their addition amount is preferably 0.01-1.0 mol/liter, but is more preferably 0.05-0.50. mol/liter.

In a bleaching solution or a bleach-fixer, employed as a bleaching accelerator may be various compounds. For example, preferred are compounds having a mercapto group or a disulfide bond, as described in Research Disclosure No. 17129 (July 1978), thiourea based compounds, or halides such as an iodide ion or a bromide ion, since they result in superior bleaching capability.

In addition, incorporated in the bleaching solution or bleach-fixer may be re-halogenation agents such as a bromide (for example, potassium bromide), a chloride (for example, potassium chloride), or iodide (for example, ammonium iodide). If desired, incorporated may be at least one of the inorganic and organic acids as well as alkaline metal or ammonium salts thereof, such as borax, sodium metaborates, acetic acid, sodium acetate, sodium-carbonate, potassium carbonate, citric acid, sodium citrate, tartaric acid, succinic acid, maleic acid,, or glycolic acid, all of which exhibit pH buffering capability, or corrosion inhibitors such as ammonium nitrate or guanidine.

Fixing agents employed in the fixer or the bleach-fixer are conventional fixing agents, namely water-soluble silver halide dissolving agents including thiosulfates such as sodium thiosulfate or ammonium thiosulfate; thiocyanates such as sodium thiocyanate or ammonium thiocyanate; thioether compounds such as 3,6-dithia-1,8-octanediol; and thioureas. These may be employed individually or in combination of at least two types. In the present invention, it is preferable to use thiosulfates, particularly ammonium thiosulfate. The amount of fixing agents is preferably in the range of 0.1-5.0 mol per liter, but is more preferably in the range of 0.3-2.0 mol. The pH of a bleach-fixer or a fixer is preferably in the range of 3-10, but is more preferably in the range of 5-9.

Further, other than those above, incorporated in a bleaching solution, a fixer, and a bleach-fixer may be various types of optical brightening agents, defoamers, surface active agents, polyvinylpyrrolidone, and organic solvents such as methanol.

Commonly incorporated in a bleaching solution, a fixer, and a bleach-fixer as a preserver are sulfites, such as sodium sulfite, potassium sulfite, ammonium sulfite, potassium bisulfite, sodium bisulfite, sodium metabisulfite, potassium metabisulfite, or ammonium metabisulfite. Other than these, incorporated may be ascorbic acid, carbonyl bisulfurous acid addition products or carbonyl compounds.

Further, if desired, incorporated may be buffering agents, optical brightening agents, chelating agents, defoamers, and mildewcides.

Further, the time required for the bleach-fixing process which is applicable to the processing method of the present invention is preferably at most 90 seconds, but is more preferably at most 45 seconds. The time required for the bleach-fixing process, as described herein, refers, when the above process is composed of a plurality of tanks, to the time from immersion of a light-sensitive material into the first tank to leaving from the final tank, and when the above process is composed of single tank, to the time until the light-sensitive material is immersed into the following processing solution, such as a rinsing solution or stabilizer, while including the cross-over time. The cross-over time is preferably at most 10 seconds, but is more preferably at most 5 seconds. Further, the temperature of a bleach-fixer is preferably 20-70° C., but is more preferably 25-50 ° C. Still further, the replenishment rate of the bleach-fixer is preferably at most 200 ml/m²₁ but is more preferably 20-100 ml/m².

The replenishment rate of the bleaching solution is preferably at most 200 ml/m²; but is more preferably 50-200 ml/m². The total processing time of the bleaching process is preferably 15-90 seconds. The time required for the bleaching process, as described herein, refers, when the above process is composed of a plurality of tanks, to the time from immersion of a light-sensitive material into the first tank to leaving from the final tank, and when the above process is composed of a single tank, to the time until the light-sensitive material is immersed in the following processing solution, such as a rinsing solution or stabilizer, while including the cross-over time. The cross-over time is preferably at most 10 seconds, but is more preferably at most 5 seconds. Further, the processing temperature is preferably 25-50° C. The replenishment rate of the fixer is preferably at most 600 ml/m², but is more preferably 20-500 ml/m². Further, the total processing time of the fixing process is preferably 15-90 seconds. The time required for the fixing process, as described herein, refers, when the above process is composed of a plurality of tanks, to the time from immersion of a light-sensitive material into the first tank to leaving from the final tank, and when the above process is composed of a single tank, to the time until the light-sensitive material is immersed into the following processing solution, such as a rinsing solution or stabilizer, while including the cross-over time. The cross-over time is preferably at most 10 seconds, but is more preferably at most 5 seconds. Further, the processing temperature is preferably 25-50° C.

Listed as a silver halide light-sensitive color photographic material, applicable to the processing method employing the stabilization processing composition of the present invention, may be various photographic media, such as color negative films, color reversal film, color paper, or color movie film, which incorporate a support having thereon silver halide light-sensitive layers.

The silver halide light-sensitive color photographic material according to the present invention incorporates a support having thereon a photographic constituting layer composed of at least one layer of each of a yellow dye forming coupler containing blue-sensitive silver halide emulsion layer, a magenta dye forming coupler containing green-sensitive silver halide emulsion layer, a cyan dye forming coupler containing red-sensitive silver halide emulsion layer, and a light-insensitive hydrophilic colloidal layer. The above yellow dye forming coupler containing silver halide emulsion layer functions as a yellow developing layer, and the above magenta dye forming coupler containing silver halide emulsion layer functions as a magenta developing layer, while the above cyan dye forming coupler containing silver halide emulsion layer functions as a cyan developing layer. It is preferable that the silver halide emulsion incorporated in each of the above yellow developing layer, the magenta developing layer, and the cyan developing layer exhibit sensitivity to light in respective different wavelength regions (for example, light in the blue region, the green region, and the red region). Other than the yellow developing layer, the magenta developing layer, and the cyan developing layer, if desired, a light-sensitive material may also incorporate an antihalation layer, an interlayer, and a tinted layer functioning as a light-insensitive hydrophilic colloidal layer.

The constitution example of a color paper which is a silver halide light-sensitive color photographic material will now be described.

Silver halide emulsions employed in the light-sensitive material according to the present invention may be composed of any halides such as silver chloride, silver bromide, silver chlorobromide, silver iodobromide, silver chloroiodobromide, or silver chloroiodide. Of these, silver chlorobromide or silver chloroiodide which incorporate silver chloride in an amount of at least 95 mol percent, is preferred since the targeted effects of the present invention are most pronounced. In view of quick processability and process stability, the content of silver chloride in the silver halide emulsion is preferably at least 97 mol percent, but is more preferably 98 99.9 mol percent.

In order to minimize any decrease in contrast of the characteristic curve in the higher density region under high intensity and short time exposure, in the light-sensitive material according to the present invention, it is possible to preferably employ a silver halide emulsion having a portion in which silver bromide is incorporated at a higher concentration. In this case, the portion which incorporates silver bromide at the above high concentration may be subjected to an epitaxy joint to silver halide grains, or may be a so-called core/shell emulsion. Further, a perfect layer is not formed, but only a region in which the composition is partially different is present. Further, the composition may continuously or discontinuously vary. It is particularly preferable that the portions in which silver bromide is present at a high concentration exist on the surface of the silver halide grain or the summit of the crystal particle.

In the light-sensitive material according to the present invention, in view of minimizing any decrease in contrast due to high intensity and short time scanning exposure, it is preferable to employ silver halide grains incorporating heavy metal ions. Listed as heavy metal ions which are so employed to realize the above object may, for example, be any ion of Group 8-10 metals such as iron, iridium, platinum, palladium, nickel, rhodium, osmium, ruthenium, or cobalt, Group 12 metals such as cadmium, zinc, or mercury, as well as any ion of lead, rhenium, molybdenum, tungsten, gallium, or chromium. Of these, preferred are metal ions of iron, iridium, platinum, ruthenium, gallium, and osmium. It is possible to incorporate these metal ions in silver halide emulsions in the form of a salt, as well as a complex salt.

In cases in which the above metal ion forms a complex, preferred as its ligand or ion are, for example, a cyanide ion, a thiocyanate ion, a cyanate ion, a chloride ion, a bromide ion, an iodide ion, a nitrate ion, carbonyl, and ammonia. Of these, preferred are the cyanide ion, the thiocyanate ion, the isothiocyanate ion, a chloride ion, and the bromide ion.

In order to incorporate the above heavy metal ions in silver halide grains, the above heavy metal compounds may be added at any time during the process of physical ripening such as prior to formation of silver halide grains, during formation of silver halide grains, or after formation of silver halide grains. Further, it is possible to continuously add a heavy metal compound solution during the entire or a portion of the process of grain formation.

The addition amount of the above heavy metal ions in silver halide emulsions is preferably 1×10⁻⁹-1×10⁻² mol per mol of silver halide, but is most preferably 1×10⁻⁸-5×10⁻⁵ mol.

In the light-sensitive materials according to the present inventions, it is possible to employ any appropriate shape of silver halide grains. One of the preferred examples is a cube having (100) planes as a crystal surface. Further, prepared are grains in the shape of octahedron, dodecahedron, or tetradecahedron based on the methods described in U.S. Pat. Nos. 4,183,756 and 4,225,666, JP-A No. 55-26589, and Japanese Patent Publication No. 55-42737, as well as in Journal of Photographic Science 21, 39 (1973), and then employed. Further, employed may be grains having twin planes.

In the light-sensitive materials according to the present invention, preferably employed are silver halide grains composed of a single shape. It is particularly preferable that at least two monodispersed silver halide emulsions are incorporated in one layer.

The diameter of silver halide grains according to the present invention is not particularly limited. When rapid processability, photographic speed, and other photographic performance are taken into account, the average grain diameter is preferably in the range of 0.1-1.2 μm, but is more preferably 0.2-1.0 μm. It is possible to determine the above grain diameter based on the projective area or the diameter approximate value. In cases in which grains are substantially of a single shape, it is possible to represent grain size distribution employing the diameter or the projective area.

The silver halide grains employed in the light-sensitive materials according to the present invention are preferably composed of monodispersed silver halide grains, exhibiting a grain size distribution of a variation coefficient of preferably at most 0.22, but more preferably 0.15. It is particularly preferable that at least two monodispersed emulsions at a variation coefficient of at most 0.15 are incorporated in one layer. The variation coefficient, as described herein, is the coefficient representing the degree of the range of grain size distribution, and defined by the following formula.
Variation coefficient=S/R (wherein S represents the standard deviation of grain size distribution, while R represents average grain diameter)

The grain diameter, as described herein, refers to the diameter of a sphere when silver halide grains are spherical or the diameter of the circle having the same projective area of a grain when the grain shape is neither cubic nor spherical.

Employed as a preparation apparatus and a method of silver halide emulsion preparation are various prior art methods in this field. Silver halide emulsions employed in the light-sensitive materials according to the present invention may be prepared employing an acid method, a neutral method, or an ammonia method. Silver halide grains may be those which are grown all at once or grown after preparing seed grains. Methods which prepare seed grains and grow grains may be the same or different.

Further, employed as a method which allows water-soluble silver salts to react with water-soluble halide salts may be a normal mixing method, a reverse mixing method, and a double-jet method, or a combined method of these, but silver halide grains prepared employing the double-jet method are preferred. Further, as one type of the double-jet method it is possible to employ the pAg controlled double-jet method described in JP-A No. 54-48521.

Further, employed may be the apparatus described in JP-A Nos. 57-92523 and 57-92524 in which an aqueous water-soluble silver salt solution and an aqueous water-soluble halide salt solution are fed from the addition unit arranged in a reaction mother liquid, the apparatus described in German Patent Publication Open to Public Inspection No. 2,921,164 which continuously adds an aqueous water-soluble silver salt solution and an aqueous water-soluble halide salt solution while changing concentration, and the apparatus described in Japanese Patent Publication No. 56-501776 in which by removing a reaction mother solution from the reaction vessel and concentrating it employing ultrafiltration, grains are formed while maintaining the distance between silver halide grains at a constant value. If desired, employed may be silver halide solvents such as thioether. Further, employed compounds having a mercapto group, nitrogen containing heterocyclic compounds or compounds such as a sensitizing dye may be by adding any of them during formation of silver halide grains or after formation thereof.

A sensitization method employing gold compounds and a sensitization method employing chalcogen sensitizers may be combined and applied to silver halide emulsions employed in the light-sensitive materials according to the present invention. Employed as chalcogen sensitizers applicable to silver halide emulsions may, for example, be sulfur sensitizers, selenium sensitizers, and tellurium sensitizers. Of these, preferred are the sulfur sensitizers. Examples of the above sulfur sensitizers include thiosulfate salts, allylthiocarbamidothiourea, allylisothiocyanate, cystine, p-toluenethiosulfonate salts, rhodamine, and inorganic sulfur. It is preferable that the addition amount of the sulfur sensitizers is varied depending on the type of the applied silver halide emulsion and the degree of expected effects, and is commonly in the range of 5×10⁻¹⁰-5×10⁻⁵ per mol of silver halide, but is preferably in the range of 5×10⁻⁸-3×10⁻⁵ mol.

It is possible to incorporate gold sensitizers in the form of various gold complexes other than chloroauric acid and gold sulfide. Listed as employed ligand compounds may be dimethylrhodanine, thiocyanic acid, mercaptotetrazole, and mercaptotriazole. The addition amount of gold compounds need not be uniform, but depends on the type of silver halide emulsions, the type of used compounds, and the ripening conditions, and is preferably 1×10⁻⁴-1×10⁻⁸ mol per mol of silver halide, but is more preferably 1×10⁻⁵-1×10⁻⁸ mol. Employed as a chemical sanitizing method applicable to the silver halide emulsion according to the present invention may be a reduction sensitization method.

For the purposes of minimizing fogging resulted in the preparation process of light-sensitive materials, performance variation during storage, and fogging resulted during development, it is possible to employ in silver halide emulsions antifoggants and stabilizers known in the art. Listed as examples of preferred compounds usable for such purposes may be the compounds represented by Formula (II) described in the lower portion on page 7 of JP-A No. 2-146.036. Further, listed as more preferred specific compounds are Compounds (IIa-1) (IIa-8), and (IIb-1)-(IIb-7) described on page 8 of the above patent, as well as 1-(3-methoxyphenyl)-5-mercaptotetrazole and 1-(4-ethoxyphenyl)-5-mercaptotetrazole. Based on the aims, these compounds are added in processes such as the preparation process of silver halide emulsion grains, the chemical sensitization process, at the completion of chemical sensitization, or the liquid coating composition preparation process. When chemical sensitization is performed in the presence of these compounds, they are preferably employed in an amount of about 1×10⁻⁵- about 5×10⁻⁴ mol per mol of silver halide. When added at the completion of chemical sensitization, the preferred amount is about 1×10⁻⁶ - about 1×10⁻² mol per mol of silver halide, but is more preferably 1×10⁻⁵-5×10⁻⁴ mol. When added to a silver halide emulsion layer during the liquid coating composition preparation process, the amount is preferably about 1×10⁻⁶- about 1×10⁻¹, but is more preferably 1×10⁻⁵-1×10⁻². When added to constituting layers other than silver halide emulsion layers, the amount in the coated layer is preferably about 1×10⁻⁹- about 1×10⁻³ mol per m².

In the light-sensitive materials according to the present invention, to achieve antirradiation and antihalation, employed may be dyes having absorption in various wavelength regions. For the above purposes, employed may be any appropriate compounds known in the art. Preferably employed as dyes exhibiting absorption in the visible region are Dyes AI-1-11 described on page 308 of JP-A No. 3-251840, the dyes described in JP-A No. 6-3770, and the dyes described in JP-A No. 11-119379. Preferred as infrared dyes are the compounds represented by Formulas (I), (II), and (III) described in the lower left column on page 2 of JP-A No. 1-280750, since they exhibit preferred spectral characteristics, result in no adverse effects to photographic characteristics of silver halide photographic emulsions, and result in no staining due to residual coloring.

In view of improving background whiteness, it is preferable to incorporate-optical brightening agents in the light-sensitive material according to the present invention. Listed as such preferably employed compounds are those represented by Formula II described in JP-A No. 2-232652.

The light-sensitive materials according to the present invention have layers incorporating a silver halide emulsion which is spectrally sensitized in the specific region of wavelength region of 400-900 nm by being combined with a yellow coupler, a magenta coupler, and a cyan coupler. The above-mentioned silver halide emulsion incorporates one, or at least two types of sensitizing dyes.

Employed as spectral sensitizing dyes employed for spectral sensitization of the silver halide emulsion employed in the photosensitive material according to the present invention may be any appropriate compounds known in the art. As a blue-sensitive sensitizing dye, BS-1-8 described on page 28 of JP-A No. 3-251840 may preferably be employed individually or in combination. Preferably employed as green-sensitive sensitizing dyes are GS-1-5 described on page 28 of the above patent, while preferably employed as red-sensitive sensitizing dyes are RS-1-8 described on page 29 of the above patent. Further, in the case of performing image exposure of infrared light while employing a semiconductor laser, it is required to employ infrared-sensitive sensitizing dyes. Preferably employed as infrared-sensitive sensitizing dyes are IRS-1-11 described on pages 6-8 of JP-A No. 4-285950. It is preferable to employ supersensitizers SS-1-SS-9 described on pages 8 and 9 of JP-A No. 4-285950 or Compounds S-1-S-17 described on page 17 of JP-A No. 4-285950, while combining with these infrared-, red-, green-, and blue-sensitive sensitizing dyes. These sensitizing dyes may be added at any time from the formation of silver halide grains to after completion of the chemical sensitization.

Sensitizing dyes may be added in the form of a solution by dissolving them in water-soluble organic solvents such as methanol, ethanol, fluorinated alcohol, acetone, or dimethylformamide, or water, or in the form of a solid dispersion.

Employed as couplers employed in the light-sensitive materials according to the present invention may be any compounds capable of forming a coupling product having a spectral absorption maximum wavelength longer than 340 nm upon coupling with the oxidation product of a color developing agent. Representative ones include those known as a coupler forming yellow dye having a maximum-spectral absorption in the wavelength region of 350-500 nm, a coupler forming magenta dye having a maximum spectral absorption in the wavelength region of 500-600 nm, and a coupler forming cyan dye having a maximum spectral absorption in the wavelength region of 600-750 nm.

Cyan couplers which are preferably employed in the light-sensitive materials according to the present invention include pyrrolotriazole based couplers. Particularly preferred are the couplers represented by Formula (I) or (II) of JP-A No. 5-313324, the couplers represented by Formula (I) of JP-A No. 6-347960, as well as the exemplified couplers described in these patents. Further, preferred are phenol and naphthol based cyan couplers. For example, the cyan couplers represented by Formula (ADF) described in JP-A No. 10-333297 are preferred. Preferred as cyan couplers, other than the described above, are the pyrroloazole type cyan couplers described in European Patent Nos. 488,248 and 491,197A1, the 2,5-diacylaminophenol coupler described in U.S. Pat. No. 5,888,716, the pyrazoloazole type cyan couplers having an electron attractive group at the 6-position and a hydrogen bonding group described in U.S. Pat. Nos. 4,873,183 and 4,916,051, and specifically, pyrazoloazole type cyan couplers having a carbamoyl group at position 6 described in JP-A Nos. 8-171185, 8-311360, and 8-339060.

Further, other than the diphenylimidazole based cyan couplers described in JP-A No. 2-33144, it is also possible to employ the 3-hydroxypyridine based cyan couplers (of which specifically preferred are those which are converted to a two-equivalent coupler by allowing Coupler (42), being a four-equivalent coupler, to incorporate a chlorine releasing group, as well as Couplers (6) and (9)), described in European Patent No. 333,185A; the cyclic active methylene based cyan couplers (of which specifically preferred are Coupler Examples 3, 8, and 34 listed as specific examples), described in JP-A No. 64-32260; the pyrrolopyrazole type cyan couplers described in European Patent No. 456,226A1; and the pyrroloimidazole type cyan couplers described in European Patent No. 484,909.

Further, of these cyan couplers, particularly preferred are the pyrroloazole based cyan couplers represented by Formula (I) described in JP-A No. 11-282138, and description of paragraph Nos. [0012)-[0058), including Cyan Couplers (1)-(47), is applicable to the present application without any modification and is included as a part of the Specification of the present application.

In the present invention, employed as magenta couplers employed in the magenta image forming layer are, for example, 5-pyrazolone based magenta couplers and pyrazoloazole based magenta couplers of these, in view of color, image stability, and color forming properties, preferred are the pyrazolotriazole couplers in which a secondary or tertiary alkyl group directly bond to position 2, 3, or 6 of the pyrazolotriazole ring, described in JP-A No. 61-65245; the pyrazoloazole couplers containing a sulfonamido group in the molecule, described in JP-A No. 61-65246; the pyrazoloazole couplers having a alkoxyphenylsulfonamido ballast group, described in JP-A No. 61-147254; and the pyrazoloazole couplers having an alkoxy group or an aryloxy group at the 6-position, described in European Patent Nos. 226,849A and 294,785A. Particularly preferred as magenta couplers are the pyrazoloazole couplers represented by Formula (M-1) described in JP-A No. 8-122984. Description of paragraph Nos. [0009]-[0026] of the above-patent is applicable to the present application with no modification and is included as a part of the Specification of the present application. In addition, preferably employed are the pyrazoloazole couplers having a steric hindrance group at the 3- and 6-positions, described in European Patent Nos. 854,384 and 884,640.

Further, yellow couplers which are preferably employed in the light-sensitive materials according to the present invention include the acylacetoamido type yellow couplers in which the acyl group has a 3- to 5-membered ring structure, described in European Patent No. 447,969A1; the malondianilido type yellow couplers having a ring structure, described in European Patent No. 482,552A; the pyrrole-2 or 3-yl, or indole-2 or 3-ylcarbonylacetic acid anilido based couplers, described in. Europeans Patent. Nos. 953,870A1, 953,871A1, 953,872A1, 953,873A1, 953,874A1, and 953,875A1; and the acylacetoamido type yellow couplers having a dioxane structure, described in U.S. Pat. No. 5,118,599. Of these, it is particularly preferred to employ acylacetoamido type yellow couplers in which the acyl group is a 1-alkylcyclopropane-1-carbonyl group or malondianilido type yellow couplers in which one of the anilidos forms an indoline ring. These couplers may be employed individually or in combination.

In cases in which an oil-in-water type emulsion dispersing method is employed as the method to add couplers and other organic compounds employed in the light-sensitive materials according to the present invention, such couplers and compounds are dissolved in water-insoluble high boiling point organic solvents at a boiling point of commonly at least 150° C., if desired, together with low boiling point and/or water-soluble organic solvents, and the resulting mixture is emulsion-dispersed into hydrophilic binders such as an aqueous gelatin solution, employing surface active agents. Employed as a dispersing device may be a stirrer, a homogenizer, a colloid mill, a flow-jet mixer, or an ultrasonic homogenizer. The resulting dispersion may be introduced into a low boiling point organic solvent removal process some time, or immediately, after dispersion. Preferably employed as a high boiling point organic solvent used to dissolve and disperse couplers are, for example, phthalic acid esters such as dioctyl phthalate, diisodecyl phthalate, or dibutyl phthalate, as well as phosphoric acid esters such as tricresyl phosphate or trioctyl phthalate. Further, the dielectric constant of the high boiling point organic solvents is preferably 3.5.-7.0. Further, it is possible to simultaneously employ at least two high boiling point organic solvents.

Further, instead of the method employing high boiling point organic solvents or by simultaneously employing high boiling organic solvents, it is acceptable to employ a method in which, if appropriate, water-insoluble and organic solvent-soluble polymer compounds are dissolved in low boiling point and/or water-soluble organic solvents and the resulting mixture is emulsion-dispersed under the presence of surface active agents employing any of the appropriate dispersing devices. Listed as water-insoluble and organic solvent-soluble polymers which are employed in the above operation may be poly(N-t-butylacrylamide).

Listed as preferred surface active agents, employed to disperse photographic additives and to control surface tension, are those incorporating a hydrophobic group having 8-30 carbon atoms in the molecule and a sulfonic acid group or a salt thereof. Specifically listed are. A-1-A-11 described in JP-A No. 64-26854. Further, it is possible to employ surface active agents in which fluorine atoms are substituted for the alkyl group.

In order to minimize fading of formed dye images due to light and heat, it is preferable to simultaneously employ anti-fading agents together with each of the above couplers. Compounds which are particularly preferred for magenta dyes include the phenyl ether based compound represented by Formula I and II, described on page 3 of JP-A No. 2-66541; the phenol based compounds represented by Formula IIIB, described in JP-A No. 3-174150; the amine based compounds represented by Formula A described in JP-A No. 64-90445; and the metal complexes represented by Formulas XII, XIII, XIV, and XV, described in JP-A No. 62-182741. Particularly preferred for yellow and cyan dyes are the compounds represented by Formula I′ described in JP-A No. 1-196049, as well as the compounds represented by Formula II described in JP-A No. 5-11417.

To shift the absorption wavelength of formed dyes, it is possible to employ compounds such as compound (d-11) in the left lower column on page 9 of JP-A No. 4-114154 and compound. (A′-1) described in the lower left column on page 10 of the above patent. Further, it is possible to employ the fluorescent dye releasing compounds described in U.S. Pat. No. 4,774,187.

In the light-sensitive materials according to the present invention, it is preferable that color contamination is minimized by incorporating compounds which react with oxidized color developing agents, into the layer-between light-sensitive layers, and fogging is retarded by incorporating the above compounds into the silver halide layer. Preferred as compounds to realize the above are hydroquinone derivatives and more specifically dialkylhydroquinones such as 2,5-di-t-octylhydroquinone. Particularly preferred compounds are those represented by Formula II described in JP-A 4-133056, and listed are Compounds II-1-II-14 described on pages 13 and 14 as well as Compound I described on page 17 of the above patent.

It is preferable that UV absorbers are incorporated in the light-sensitive materials according to the present invention to minimize static fog and to enhance lightfastness of dye images. Listed as such preferred UV absorbers are benzotriazoles. Of these, listed as particularly preferred compounds are those represented by Formula III-3 described in JP-A No. 1-250944; the compounds represented by Formula III described in-JP-A No. 64-66646.; UV-1L-UV-27L described in JP-A No. 63-187240; the compounds represented by Formula I described in JP-A No. 4-1633; and the compounds represented by Formulas (I) and (II) described in JP-A No. 5-165144.

It is advantageous to employ gelatin as a binder in the light-sensitive materials according to the present invention. If desired, it is also possible to employ gelatin derivatives, graft polymers of gelatin with other polymers, proteins other than gelatin, sugar derivatives, cellulose derivatives, and hydrophilic colloids of hydrophilic synthetic polymer materials such as homopolymers or copolymers.

As hardeners of these binders, it is preferable that vinylsulfone type hardeners and chlorotriazine type hardeners are employed individually or in combination. It is preferable to employ, for example, the compounds described in JP-A Nos. 61-249054 and 61-245153. Further, in order to minimize breeding of mold and bacteria, which adversely affect photographic performance and image retention properties, it is preferable to incorporate in colloid layers the compounds described, for example, in JP-A Nos. 3-157646. Further, in order to enhance the physical surface properties prior to or after processing of light-sensitive materials, it is preferable to incorporate the protective layer lubricants and matting agents, described in JP-A Nos. 6-118543 and 2-73250.

The light-sensitive material according to the present invention is acceptable as long as at least one of each of the yellow image forming layer, the magenta image forming layer and the cyan image forming layer is incorporated. However, if desired, a unit may be composed of a plurality of color image forming layers.

For purposes of achieving antirradiation and antihalation, in the light-sensitive material according to the present invention, it is possible to employ dyes exhibiting absorption in various wavelength regions. To achieve these aims, it is possible to employ any appropriate compounds known in the art. Of these, preferably employed as dyes exhibiting absorption in the visible region are the dyes AI-1-11 described on page 308 of JP-A No. 3-251840 and the dyes described in JP-A No. 6-3770.

It is preferable that the light-sensitive material according to the present invention incorporates at least one hydrophilic colloidal layer colored with nondiffusive compounds on the side nearer to the support than any of the silver halide emulsion layers which is nearest the support. Employed as colored substances may be dyes as well as organic and inorganic colored substances other than such dyes.

It is preferable that the light-sensitive material according to the present invention incorporates at least one colored hydrophilic colloidal layer on the side nearer the support than any of the silver halide emulsion layers nearest the support, and the above layer may incorporate white pigments. For example, employed may be rutile type titanium dioxide, anatase type titanium dioxide, barium sulfate, barium stearate, silica, alumina, zirconium oxide, or kaolin. Of these, for various reasons, preferred is titanium dioxide. White pigments are dispersed, for example, in an aqueous hydrophilic colloidal solution binder such as gelatin so that the resulting processing solution can be penetrated. The coated amount of white pigments is preferably in the range of 0.1-50 g/m², but is more preferably in the range of 0.2-5 g/m².

If desired, other than the white pigment containing layer, it is possible to arrange a sublayer between the support and the silver halide emulsion layer nearest the support and a light-insensitive hydrophilic colloidal layer such as a interlayer at any other position.

It is preferable to further enhance background whiteness by incorporating optical brightening agents in the light-sensitive material according to the present invention. Optical brightening agents are not particularly limited as long as they absorb ultraviolet radiation and emit fluorescence composed of visible light. Diaminostilbene based compounds having at least one sulfonic acid group in the molecule are preferred since these compounds also exhibit desired effects to dissolve sensitizing dyes out of the light-sensitive material. Another preferred embodiment includes minute solid particle compounds exhibiting optical brightening effects.

In the light-sensitive material according to the present invention, silver halide emulsion layers are applied onto a support in the form of a layer over another layer, but the order from the support is not limited. Other than the above, if desired, arranged may be an interlayer, a filter layer, and a protective layer.

It is preferable that UV absorbers are incorporated in the light-sensitive materials according to the present invention to minimize static fog and to enhance lightfastness of dye images. Listed as such preferred UV absorbers are benzotriazoles. Of these, listed as particularly preferred compounds are the compounds represented by Formula III-3 described in JP-A No. 1-250944, the compounds represented by Formula III described in JP-A No. 64-66646, UV-1L-UV-27L described in JP-A No. 63-187240, the compounds represented by Formula I described in JP-A No. 4-1633, and the compounds represented by Formulas (I) and (II) described in JP-A No. 5-165144.

To enhance background whiteness, oil-soluble dyes and pigments are preferably incorporated in the light-sensitive material according to the present invention. Specific examples of representative oil-soluble dyes include the Compounds 1-27 described on pages 8 and 9 of JP-A No. 2-842.

In cases in which an oil-in-water type emulsion dispersing method is employed to add antistaining agents and other organic compounds employed in the light-sensitive materials according to the present invention, such agents and compounds are dissolved in water-insoluble high boiling point organic solvents at a boiling point of commonly at least 150° C., if desired, together with low boiling point and/or water-soluble organic solvents, and the resulting mixture is emulsion-dispersed into hydrophilic binders such as an aqueous gelatin solution, employing surface active agents. Employed as a dispersing device may be a stirrer, a homogenizer, a colloid mill, a flow-jet mixer, or an ultrasonic homogenizer. The resulting dispersion may be introduced into a low boiling point organic solvent removal process some time or immediately after dispersion. Preferably employed as a high boiling point organic solvent used to dissolve and disperse antistaining agents are, for example, phthalic acid esters such as dioctyl phthalate, diisodecyl phthalate, or dibutyl phthalate, as well as phosphoric acid esters such as tricresyl phosphate or trioctyl phthalate. Further, the dielectric constant of the high boiling point organic solvents is preferably 3.5-7.0. Further, it is possible to simultaneously employ at least two high boiling point organic solvents.

Listed as preferred surface active agents employed to disperse photographic additives employed in the light-sensitive materials according to the present invention and to control surface tension during coating, are those incorporating a hydrophobic group having 8-30 carbon atoms in the molecule and a sulfonic acid group or a salt thereof. Specifically listed are A-1-A-11 described in JP-A No. 64-26854. Further, it is possible to employ surface active agents in which fluorine atoms are substituted for the alkyl group. These dispersions are commonly added to a liquid coating composition incorporating a silver halide emulsion. The shorter the duration between the addition to the liquid coating composition after dispersion and the start of coating after being added to the liquid coating composition, the more preferred. Each of the duration is preferably within 10 hours, is more preferably within 3 hours, but is most preferably within 20 minutes.

Materials of the support employed in the light-sensitive materials according to the present invention are not particularly limited. It is possible to employ paper coated with polyethylene or polyethylene terephthalate, paper supports composed of natural pulp or synthetic pulp, vinyl chloride sheets, polypropylene and polyethylene terephthalate supports which may incorporate white pigments, and baryta paper. Of these, preferred are supports having a water-resistant resin coated layer on both sides of a base paper. Preferred as water-resistant resins are polyethylene and ethylene terephthalate, as well as copolymers thereof.

Employed as supports having a water-resistant resin coated layer on the paper surface are commonly those at a weight of 50-300 g/m², which exhibit smooth surface. To prepare proof images, in order to approach quality feeling while handling printing paper, preferably employed is base paper at a weight of at most 130 g/m², while more preferably employed is one at a weight of 70-120 g/m².

Preferably employed as supports used in the present invention are those which randomly exhibit unevenness or are smooth.

Employed as white pigments used in supports may be inorganic and/or organic white pigments, of which inorganic white pigments are preferably employed. Examples include sulfates of alkaline earth metals such as barium sulfate, carbonates of alkaline earth metals such as calcium carbonate, and silicas such as minute silicic acid particle powder, synthetic silicic salts, as well as calcium silicate, alumina, alumina hydrates, titanium oxide, zinc oxide, talc and clay. Of these, preferred are barium sulfate and titanium oxide.

The amount of white pigment incorporated in the water-resistant resinous layer of the support to enhance sharpness is preferably at least 13 percent by weight, but is more preferably 15 percent by weight.

It is possible to determine the degree of dispersion of white pigments in the water-resistant resinous layer of the paper support according to the present invention, employing the method described in JP-A No. 2-28640. When determined based on the above method, the degree of dispersion of white pigments is preferably at most 0.20 in terms of the variation coefficient described in the above patent, but is more preferably at most 0.15.

The resinous layer on the paper support having a water-resistant resinous layer on both sides employed in the present invention may be composed of one layer or a plurality of layers. Of a plurality of layers, white pigments may be incorporated in the layer in contact with the emulsion layer preferably at a higher concentration, to result in marked enhancement of sharpness.

Further, the mean center surface roughness value (SRa) of a support is preferably at most 0.15 μm, but is more preferably at most 0.12 μm so that more desired effects of improved glossiness is realized.

In the light-sensitive materials according to the present invention, after applying corona discharge, ultraviolet radiating exposure, or a flame treatment onto the surface of a support, coating may be performed directly onto the resulting surface or via a sublayer (being one or at least two sublayers to enhance adhesion property of the support surface, antistatic properties, dimensional stability, abrasion resistance, hardness, antihalation property, and friction characteristics).

When light-sensitive materials employing silver halide emulsions are coated, in order to enhance coatability, employed may be thickening agents. As a coating method, specifically useful are extrusion coating and curtain coating, both capable of achieving simultaneous coating at least two layers.

### EXAMPLES

The present invention will now be described with reference of examples, however the present invention is not limited thereto. In the examples, “parts” and “%” are employed and represent “parts by weight” and “% by weight”, respectively unless otherwise specified.

### Example 1

<<Preparation of Silver Halide Light-Sensitive Color Photographic Materials<<

Based on the method below, color paper was prepared which was a silver halide light-sensitive color photographic material and was viewed by reflection.

A paper support was prepared by laminating high density polyethylene onto both sides of pulp paper sheets at a basis weight of 180 g/m². The side onto which each emulsion layer was to be applied was laminated with melted polyethylene incorporating a surface-treated anatase type titanium oxide dispersion (at a content of 15% by weight), whereby Reflection Support A was prepared. Above Reflection Support A was subjected to corona discharge treatment and thereafter, a gelatin sublayer was applied. Further, each constituting layer composed, as described below, was coated, whereby color paper being Sample 101, was prepared. In Tables 1 and 2, the addition amount of each of the silver halide emulsions was described in terms of Ag.

During preparation of above Sample 101, hardening agents H-1 and H-2 were added. As a coating aid, surface active agents SU-2 and SU-3 were added, whereby the surface tension was controlled to the desired value. Further, F-1 was added to each layer until the total weight reached 0.04 g/m².

TABLE 1

| | | Addition |
|---|---|---|
| | | Amount |
| Layer | Constitution | (g/m²) |
| 7th Layer | gelatin | 0.70 |
| (Protective | DIDP | 0.002 |
| Layer) | DBP | 0.002 |
| | silicon dioxide | 0.003 |
| 6th Layer | gelatin | 0.40 |
| (UV Absorbing | AI-1 | 0.01 |
| Layer) | UV Absorber (UV-1) | 0.07 |
| | UV Absorber (UV-2) | 0.12 |
| | Antistaining Agent (HQ-5) | 0.02 |
| 5th Layer | gelatin | 1.00 |
| (Red-Sensitive | Red Sensitive Silver(Em-R) | 0.17 |
| Layer) | Cyan Coupler (C-1) | 0.22 |
| | Cyan Coupler (C-2) | 0.06 |
| | Dye Image Stabilizer (ST-1) | 0.06 |
| | Antistaining Agent (HQ-1) | 0.003 |
| | DBP | 0.10 |
| | DOP | 0.20 |
| 4th Layer | gelatin | 0.94 |
| (UV Absorbing | AI-1 | 0.02 |
| Layer) | UV Absorber (UV-1) | 0.17 |
| | UV Absorber (UV-2) | 0.27 |
| | Antistaining Agent (HQ-5) | 0.06 |

TABLE 2

| | | Addition |
|---|---|---|
| | | Amount |
| Layer | Constitution | (g/m²) |
| 3rd Layer | gelatin | 1.30 |
| (Green- | AI-2 | 0.01 |
| Sensitive | Green-Sensitive Silver | 0.12 |
| Layer) | Chlorobromide Emulsion(Em-G) | |
| | Magenta Coupler (M-1) | 0.05 |
| | Magenta Coupler (M-2) | 0.15 |
| | Dye Image Stabilizer (ST-3) | 0.10 |
| | Dye Image Stabilizer (ST-4) | 0.02 |
| | DIDP | 0.10 |
| | DBP | 0.10 |
| 2nd Layer | gelatin | 1.20 |
| (Interlayer) | AI-3 | 0.01 |
| | Antistaining Agent (HQ-1) | 0.02 |
| | Antistaining Agent (HQ-2) | 0.03 |
| | Antistaining agent (HQ-3) | 0.06 |
| | Antistaining Agent (HQ-4) | 0.03 |
| | Antistaining Agent (HQ-5) | 0.03 |
| | DIDP | 0.04 |
| | DBP | 0.02 |
| 1st Layer | gelatin | 1.10 |
| (Blue- | Blue-Sensitive Silver | 0.24 |
| Sensitive | Chlorobromide Emulsion(Em-B) | |
| Layer) | Yellow Coupler (Y-1) | 0.10 |
| | Yellow Coupler (Y-2) | 0.30 |
| | Yellow Coupler (Y-3) | 0.05 |
| | Dye Image Stabilizer (ST-1) | 0.05 |
| | Dye Image Stabilizer (ST-2) | 0.05 |
| | Dye Image Stabilizer (ST-5) | 0.10 |
| | Antistaining Agent (HQ-1) | 0.005 |
| | Image Stabilizer A | 0.08 |
| | Image Stabilizer B | 0.04 |
| | DIDP | 0.05 |
| | DBP | 0.15 |

| | |
|---|---|
| Support | polyethylene-laminated paper |
| | (containing a very small amount of |
| | colorants) |

Each of the additives listed as abbreviations in Tables 1 and 2 is spelled out below.
SU-1: sodium tri-i-propylnaphthelenesulfonate
SU-2: sodium di(2-ethylhexyl)sulfosuccinate
SU-3: sodium di(2,2,3,3,4,4,5,5-octafluoropentyl)sulfosuccinate
DBP: dibutyl phthalate.
DNP: dinonyl phthalate
DOP: dioctyl phthalate
DIDP: di-i-decyl phthalate
H-1: tetrakis(vinylsulfonylmethyl)methane
H-2: sodium 2,4-dichloro-6-hydroxy-s-triazine
HQ-1: 2,5-di-t-octylhydroquinone
HQ-2: 2,5-di-sec-dodecylhydroquinone
HQ-3: 2,5-di-sec-tetradecylhydroquinone
HQ-4: 2-sec-dodecyl-5-tetradecylhydroquinone
HQ-5: 2,5-di[(1,1-dimethyl-4-hexyloxycarbonyl)butyl]hydroquinone
Image Stabilizer A: p-t-octylphenol
Image Stabilizer B: poly(t-butylacrylamide) 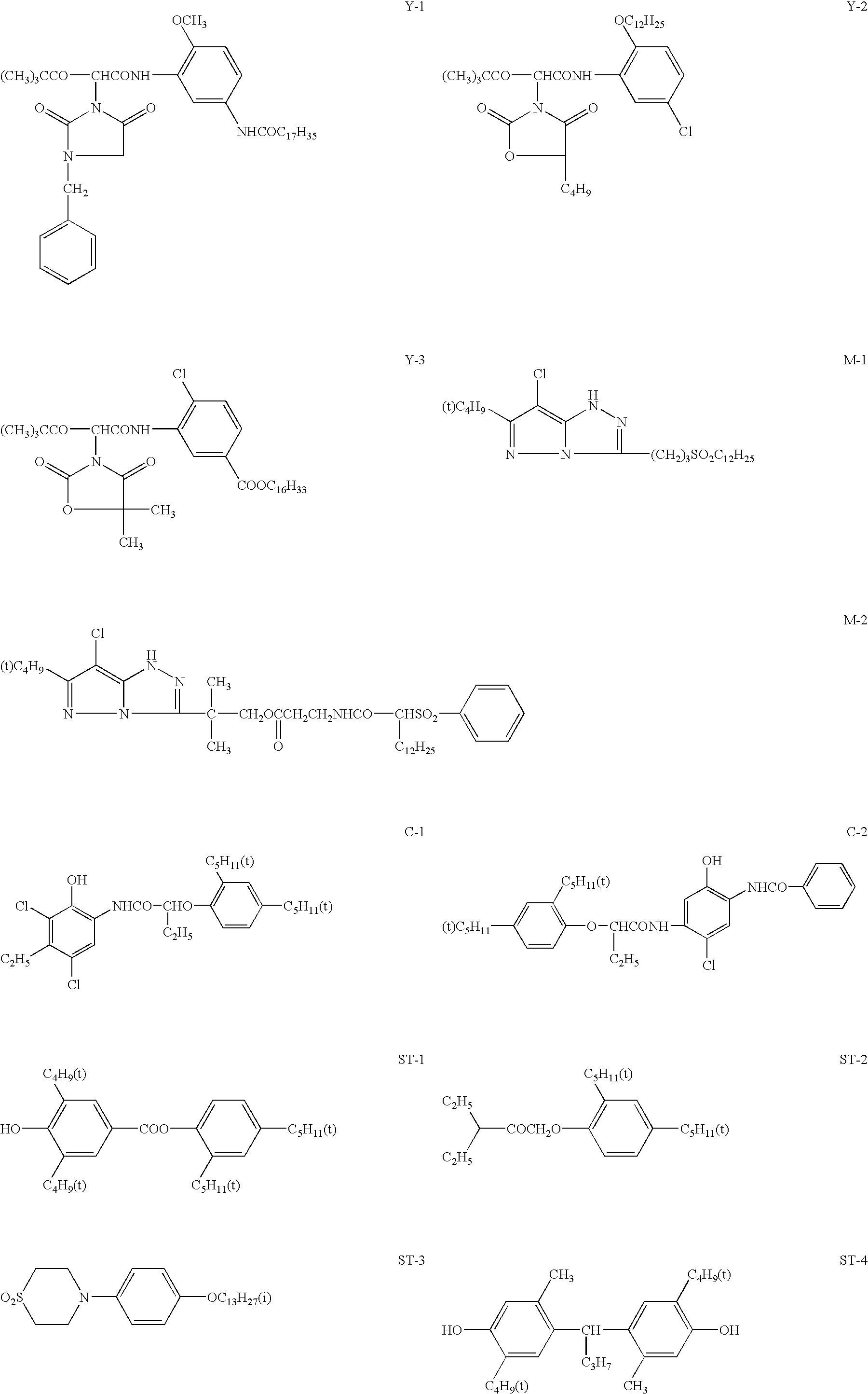 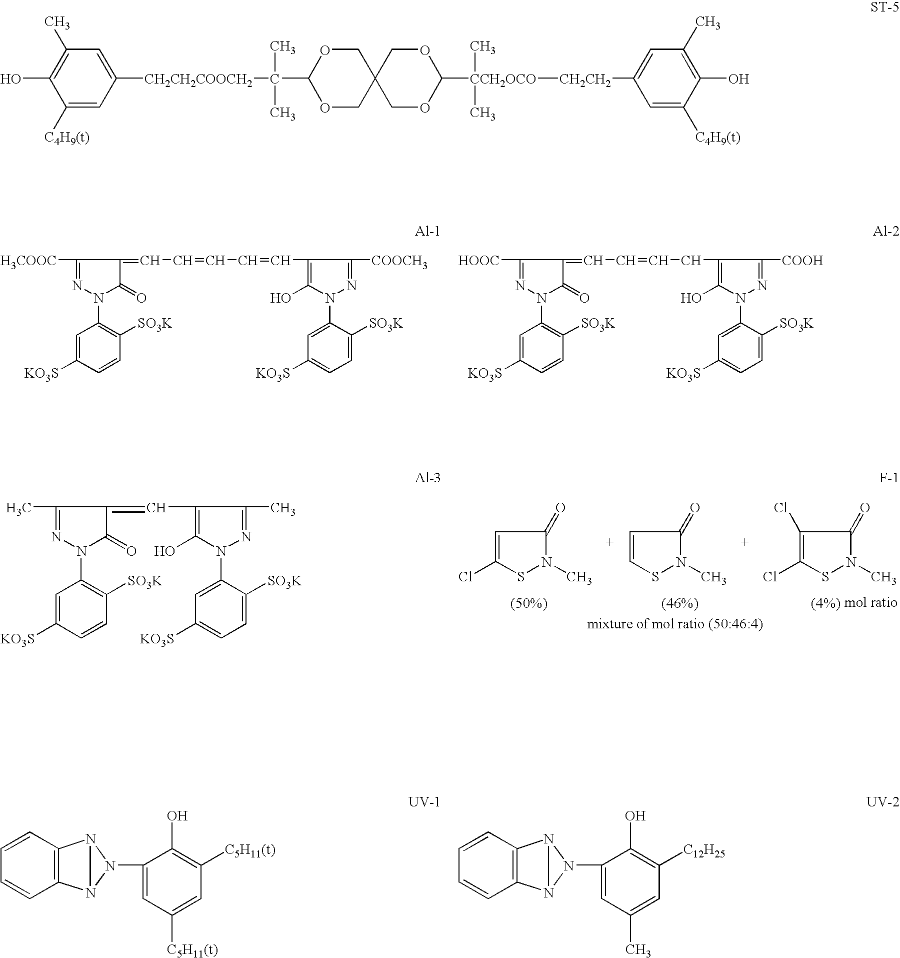
   (Preparation of Silver Halide Emulsions)
   <Preparation of Blue-Sensitive Silver Halide Emulsion<

EMP-1, being a monodispersed cubic grain emulsion at an average grain diameter of 0.71 μm, a variation coefficient of grain size distribution of 0.07, and a content ratio of silver chloride of 99.5 mol percent, was prepared based on a conventional method. Subsequently, EMP-1B, being a monodispersed cubic grain emulsion at an average grain diameter of 0.64 μm, a variation coefficient of grain size distribution of 0.07, and a content ratio of silver chloride of 99.5 mol percent, was prepared based on a conventional method.

Above EMP-1 was allowed to undergo chemical sensitization employing the compounds below so that the photographic speed-fog relationship became optimal. Further, EMP-1B was also allowed to undergo chemical sensitization so that the photographic speed-fog relationship also became optimal. The sensitized EMP-1 and EMP-1B were blended at a ratio of 1:1 in terms of silver weight, whereby Blue-Sensitive Silver Halide Emulsion (Em-B) was prepared.

| | | |
|---|---|---|
| Sodium thiosulfate | 0.8 | mg/mol AgX |
| Chloroauric acid | 0.5 | mg/mol AgX |
| Stabilizer: STAB-1 | 3 × 10⁻⁴ | mol/mol AgX |
| Stabilizer: STAB-2 | 3 × 10⁻⁴ | mol/mol AgX |
| Stabilizer: STAB-3 | 3 × 10⁻⁴ | mol/mol AgX |
| Sensitizing Dye: BS-1 | 4 × 10⁻⁴ | mol/mol AgX |
| Sensitizing Dye: BS-2 | 1 × 10⁻⁴ | mol/mol AgX |

<Preparation of Green-Sensitive Silver Halide Emulsion>

EMP-2, being a monodispersed cubic grain emulsion at an average grain diameter of 0.40 μm, a variation coefficient of 0.08, and a content ratio of silver chloride of 99.5 mol percent, was prepared based on a conventional method. Subsequently, EMP-2B, being a monodispersed cubic grain meulsion at an average grain diameter of 0.50 μm, a variation coefficient of the grain size distribution of 0.08, and a content ratio of silver chloride of 99.5 mol percent, was prepared based on a conventional method.

Above EMP-2 was allowed to undergo chemical sensitization employing the compounds below so that the photographic speed-fog relationship became optimal. Further, EMP-2B was also allowed to undergo chemical sensitization so that the photographic speed-fog relationship also became optimal. The sensitized EMP-2 and EMP-2B were blended at a ratio of 1:1 in terms of silver weight, whereby Green-Sensitive Silver Halide Emulsion (Em-G) was prepared.

| | | |
|---|---|---|
| Sodium thiosulfate | 1.5 | mg/mol AgX |
| Chloroauric acid | 1.0 | mg/mol AgX |
| Stabilizer: STAB-1 | 3 × 10⁻⁴ | mol/mol AgX |
| Stabilizer: STAB-2 | 3 × 10⁻⁴ | mol/mol AgX |
| Stabilizer: STAB-3 | 3 × 10⁻⁴ | mol/mol AgX |
| Sensitizing Dye: GS-1 | 4 × 10⁻⁴ | mol/mol AgX |

<Preparation of Red-Sensitive Silver Halide Emulsion>

EMP-3, being a monodispersed cubic grain emulsion at an average grain diameter of 0.40 μm, a variation coefficient of the grain size distribution of 0.08, and a content ratio of silver chloride of 99.5 mol percent, was prepared based on a conventional method. Subsequently, EMP-3B, being a monodispersed cubic grain emulsion at an average grain diameter of 0.38 μm, a variation coefficient of-the grain size distribution of 0.08, and a content ratio of silver chloride of 99.5 mol percent, was prepared based on a conventional method.

Above EMP-3 was allowed to undergo chemical sensitization employing the compounds below so that the photographic speed-fog relationship became optimal. Further, EMP-3B was also allowed to undergo chemical sensitization so that the photographic speed-fog relationship became optimal. Thereafter, sensitized EMP-1 and EMP-1B were blended at a ratio of 1:1 in terms of silver weight, whereby Red-Sensitive Silver Halide Emulsion (Em-R) was prepared.

| | | |
|---|---|---|
| Sodium thiosulfate | 1.8 | mg/mol AgX |
| Chloroauric acid | 2.0 | mg/mol AgX |
| Stabilizer: STAB-1 | 3 × 10⁻⁴ | mol/mol AgX |
| Stabilizer: STAB-2 | 3 × 10⁻⁴ | mol/mol AgX |
| Stabilizer: STAB-3 | 3 × 10⁻⁴ | mol/mol AgX |
| Sensitizing Dye: RS-1 | 1 × 10⁻⁴ | mol/mol AgX |
| Sensitizing Dye: RS-2 | 1 × 10⁻⁴ | mol/mol AgX |

Each of the above compounds, employed to prepare each of the above silver halide emulsions, is spelled out below.
STAB-1: 1-(3-acetoamidophenyl)-5-mercaptotetrazole
STAB-2: 1-phenyl-5-mercatptotetrazole
STAB-3: 1-(4-ethoxyphenyl)-5-mercaptptetrazole

Further, SS-1was added to the red-sensitive silver halide emulsion in an amount of 2.0×10⁻³ mol per mol of silver halide. 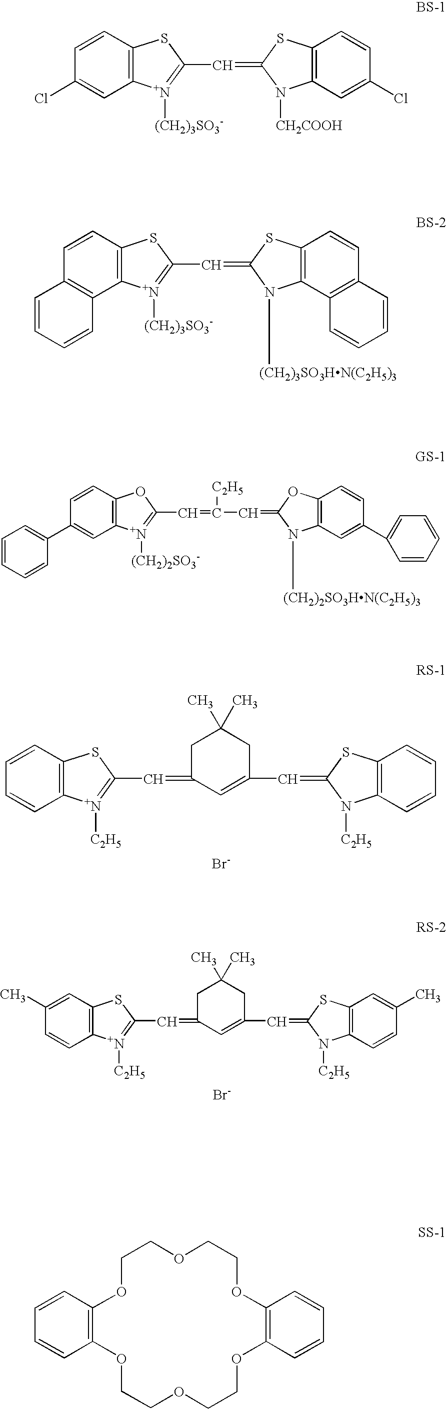
<<Exposure and Photographic Processing>>
(Exposure)

The entire surface of Sample 101, prepared as above, was uniformly exposed to light under conditions such that each of the yellow image density, magenta image destiny, and cyan image density reached approximately 0.8 after the photographic processing under-the conditions below.

The photographic processing was performed employing an automatic color paper processor R-1 Super, produced by Konica Minolta Photo Imaging, Inc. which had been modified to exhibit the processing conditions below. Continuous Processes 1-1-1-32 were performed until the color developer replenisher was replenished by a factor of 3 of the capacity (15 L) of the color developer tank (hereinafter also referred to as 3-round).

(Processing Conditions)

| | | | | Processing |
|---|---|---|---|---|
| | Processing | Processing | Replenishment | Tank |
| Processing | Temperature | Time | Rate | Capacity |
| Step | (° C.) | (seconds) | (ml/m²) | (L) |
| Color | 39.8 | 22 | 80 | 15 |
| Development | | | | |
| Bleach-Fixing | 37.0 | 22 | 100 | 15 |
| Stabilization-1 | 38.0 | 22 | *1 | 15 |
| Stabilization-2 | 38.0 | 22 | *2 | 15 |
| Stabilization-3 | 38.0 | 22 | 200 | 15 |
| Drying | 65.0 | 30 | | |

*1 cascade to Stabilization-2 → Satbilization-1
*2 cascade to Stabilization-3 → Stabilization-2
(Color Developer: per 1 liter)

| | Working | | | |
|---|---|---|---|---|
| | Solution | | Replenisher | |
| 4-Amino-3-methyl-N-ethyl-N- | 6.0 | g | 12.0 | g |
| (β-(methanesulfonamido)ethyl)aniline | | | | |
| sulfate | | | | |
| Potassium sulfite | 0.1 | g | 0.2 | g |
| Disulfoethylhydroxylamine | 4.5 | g | 9.0 | g |
| Stilbene based optical brightening agent | 0.5 | g | 1.0 | g |
| Pentasodium diethylenetiriaminepentaacetate | 3.0 | g | 3.0 | g |
| Diethylehe glycol | 25 | g | 25.0 | g |
| Potassium carbonate | 30 | g | 30.0 | g |
| Potassium chloride | 4.0 | g | — | |
| pH | 10.35 | | 12.30 | |

The total volume was brought to one liter by the addition of ion-exchanged water and the pH was controlled by the addition of 50 percent sulfuric acid or potassium hydroxide.

(Bleach-Fixer: per liter)

| <Bleach-Fixer Replenisher> | | |
|---|---|---|
| Ammonium thiosulfate (75% weight/volume) | 180 | ml |
| Ammonium sulfite (40% weight/volume) | 50 | ml |
| Ammonium metabisulfite | 10 | g |
| Iron(III) ammonium diethylenetriaminetetraacetate | 180 | g |
| (50% weight/volume) | | |
| Diethyleneditriaminetetraacetic acid | 2.0 | g |
| pH | 6.0 | |

The total volume was brought to one liter by the addition of water and the pH was controlled by the addition of 50 percent sulfuric acid or ammonia water.

<Bleach-Fixer Working Solution>

The bleach-fixer working solution was prepared by adding 6 L of water to 9 L of the above bleach-fixer replenisher.

(Stabilizer Type A; Working Solutions A-1-A-16
and Replenishers A-1-A-16: per liter)

| | | |
|---|---|---|
| Ethylenediaminetetraacetic acid | 1.6 | g |
| 1-Hydroxyethylidene-1,1-disulfonic acid | 1.5 | g |
| Exemplified Compound (IV-9) | 1.5 | mmol |
| Compound A (the type described in Table 3) | | |
| the addition amount described in Table 3) | | |
| pH | 7.60 | |

The total volume was brought to 1 liter by the addition of water, and the pH was controlled by the addition of 50 percent sulfuric acid, potassium hydroxide, or ammonia water. Addition was performed so that the mol ratio of ammonium ions reached the ratio described in Table 3.

(Stabilizer Type B; Stabilizer Working Solutions B-1-B-16
and Replenishers B-1-B-16: per liter)

| | | |
|---|---|---|
| Ethylenediamineteteraacetic acid | 1.6 | g |
| 1-Hhydroxyethilidene-1,1-diphosphonic acid | 1.5 | g |
| Polyethylene glycol at a weight average molecular | | |
| weight of 4,000 | 0.5 | g |
| Exemplified Compound (IV-9) | 1.5 | mmol |
| Compound A (the type described in Table 3) | | |
| the addition amount described in Table 3 | | |
| Sodium 1-ctanesulfonate | 0.05 | g |
| pH | 7.60 | |

The total volume was brought to 1 liter by the addition of water, and the pH was controlled by the addition of 50 percent sulfuric acid, potassium hydroxide, or ammonia water. Addition was performed so that the mol ratio of ammonium ions reached the ratio described in Table 3.

<<Evaluation of Processed Samples>>

(Evaluation of Foreign Matter Adhesion Resistance)

After performing the 3-round process based on the above method, Sample 101, being a color paper, was subjected to wedge exposure based on a conventional method and then to photographic processing. Subsequently, the reflection density of the maximum density portion of the yellow image of each sample was determined employing X-rite 310 produced by X-rite Co. The determined density was designated as DY₁. Subsequently, foreign matter adhering onto the surface of the resulting sample was removed by rubbing the above surface, employing a cotton cloth back and forth ten times, and then the reflection density of the resulting yellow image was determined in the same manner as above. The resulting density was designated as DY₂. Subsequently, yellow image density difference ΔDY (DY₁−DY₂) prior to after wiping was obtained, and the resulting value was used as a scale of foreign matter adhesion resistance.

In the above evaluation, if adhesion of foreign matter on the surface of the sample after photographic processing increases, the degree of surface scattering increases, resulting in a decrease in determined reflection density. Consequently, a lower density variation range prior to and after wiping refers to a smaller amount of foreign matter adhered onto the surface.

(Evaluation of Image Retention Property (Stain Resistance))

After performing the 3-round process based on the above method, Sample 101, being a color paper, was subjected to wedge exposure based on a conventional method, and then to photographic processing. Subsequently, the minimum yellow density of the unexposed portion was determined employing X-rite 310, produced by X-rite Co. The determined density was designated as Dₘᵢₙ₁. Subsequently, the resulting sample was stored at 60° C. and 80 percent relative humidity for 3 weeks, and the minimum yellow density of the unexposed portion was determined and the resulting density was designated as Dₘᵢₙ₂. Minimum density variation range ΔDₘᵢₙ(Dₘᵢₙ₂−Dₘᵢₙ₁) of the unexposed portion was determined and was employed as a scale of image retention property (stain resistance).

Table 3 shows the results.

TABLE 3

| | | | | | Individual Evaluation | | |
|---|---|---|---|---|---|---|---|
| | | | | | Result | | |
| | Stabilizer Composition | | | | Foreign | | |
| | | Compound A | | | Matter | Image | |
| | | | Addition | | Adhesion | Retention | |
| | | | Amount | | Resistance | Property | Re- |
| *1 | No. | Type | (mmol) | *2 | ΔDY | ΔDₘᵢₙ | marks |
| 1-1 | A-1 | — | — | 0 | −0.12 | 0.14 | Comp. |
| 1-2 | A-2 | — | — | 23 | −0.10 | 0.12 | Comp. |
| 1-3 | A-3 | — | — | 45 | −0.11 | 0.13 | Comp. |
| 1-4 | A-4 | — | — | 55 | −0.10 | 0.12 | Comp. |
| 1-5 | A-5 | — | — | 80 | −0.09 | 0.12 | Comp. |
| 1-6 | A-6 | I-4 | 1.2 | 0 | −0.02 | 0.02 | Inv. |
| 1-7 | A-7 | I-4 | 1.2 | 23 | −0.04 | 0.04 | Inv. |
| 1-8 | A-8 | I-4 | 1.2 | 45 | −0.04 | 0.06 | Inv. |
| 1-9 | A-9 | I-4 | 1.2 | 55 | −0.09 | 0.11 | Comp. |
| 1-10 | A-10 | I-4 | 1.2 | 80 | −0.10 | 0.13 | Comp. |
| 1-11 | A-11 | I-1 | 1.2 | 45 | −0.04 | 0.07 | Inv. |
| 1-12 | A-12 | I-1 | 1.2 | 80 | −0.09 | 0.13 | Comp. |
| 1-13 | A-13 | I-6 | 1.2 | 45 | −0.05 | 0.08 | Inv. |
| 1-14 | A-14 | I-6 | 1.2 | 80 | −0.11 | 0.14 | Comp. |
| 1-15 | A-15 | I-8 | 1.2 | 45 | −0.04 | 0.07 | Inv. |
| 1-16 | A-16 | I-8 | 1.2 | 80 | −0.11 | 0.13 | Comp. |
| 1-17 | B-1 | — | — | 0 | −0.16 | 0.19 | Comp. |
| 1-18 | B-2 | — | — | 23 | −0.13 | 0.18 | Comp. |
| 1-19 | B-3 | — | — | 45 | −0.14 | 0.19 | Comp. |
| 1-20 | B-4 | — | — | 55 | −0.13 | 0.19 | Comp. |
| 1-21 | B-5 | — | — | 80 | −0.14 | 0.20 | Comp. |
| 1-22 | B-6 | I-4 | 1.2 | 0 | −0.03 | 0.01 | Inv. |
| 1-23 | B-7 | I-4 | 1.2 | 23 | −0.04 | 0.03 | Inv. |
| 1-24 | B-8 | I-4 | 1.2 | 45 | −0.05 | 0.07 | Inv. |
| 1-25 | B-9 | I-4 | 1.2 | 55 | −0.13 | 0.17 | Comp. |
| 1-26 | B-10 | I-4 | 1.2 | 80 | −0.14 | 0.18 | Comp. |
| 1-27 | B-11 | I-1 | 1.2 | 45 | −0.05 | 0.06 | Inv. |
| 1-28 | B-12 | I-1 | 1.2 | 80 | −0.15 | 0.16 | Comp. |
| 1-29 | B-13 | I-6 | 1.2 | 45 | −0.06 | 0.07 | Inv. |
| 1-30 | B-14 | I-6 | 1.2 | 80 | −0.14 | 0.19 | Comp. |
| 1-31 | B-15 | I-8 | 1.2 | 45 | −0.05 | 0.06 | Inv. |
| 1-32 | B-16 | I-8 | 1.2 | 80 | −0.15 | 0.18 | Comp. |

*1: Continuous Process No.,
*2: Ammonium Salt Ratio (%)
Inv.: Present Invention,
Comp.: Comparative Example

As can clearly be seen from the results described in Table 3, the stabilizers incorporating the compound represented by Formula (I), in which the ammonium ion ratio was at most 50 mol percent with respect to the total incorporated cations, were capable of minimizing the decrease in density of the color paper due to foreign matter adhesion caused by the composition of the stabilizer after continuous process over an extended period of time, and further were capable of markedly retarding the formation of yellow stain even after storage of the photographically processed samples at high temperature over an extended period of time.

Specifically, it can be seen that when as a preferred embodiment, the ammonium salt ratio in the stabilizer was at most 25 percent, but was more preferably 0 percent, the above targeted effects of the present invention were further exhibited.

### Example 2

<<Preparation of Stabilizer>>

(Preparation of Working Stabilizer B-17 and Replenisher B-17)

Working Stabilizer B-17 and Replenisher B-17 were prepared in the same manner as Working Stabilizer B-8 and Replenisher B-8 described in Example 1, except that Exemplified Compound (IV-9) was omitted.

(Preparation of Working Stabilizers B-18-B-20 and Replenishers B-18-B-20)

Working Stabilizers B-18-B-20 and Replenishers B-18-B-20 were prepared in the same manner as above Working Stabilizer B-17 and Replenisher B-17, except that each of the optical brightening agents described in Table 4 was added in an amount of 1.5 mmol.

Each of the optical brightening agents described in Table 4 was produced by Showa Chemical Industry Co.

(Preparation of Working Stabilizer B-21 and Replenisher B-21)

Working Stabilizer B-21 and Replenisher B-21 were prepared in the same manner as above Working Stabilizer B-10 and Replenisher B-10 described in Example 1, except that Exemplified Compound (IV-9) was omitted.

(Preparation of Working Stabilizers B-22-B-24 and Replenishers B-22-B-24)

Working Stabilizers B-22-B-24 and Replenishers B-22-B-24 were prepared in the same manner as above Working Stabilizer B-21 and Replenisher B-21, except that each of the optical brightening agents described in Table 4 was added in an amount of 1.5 mmol.

(Preparation of Working Stabilizers B-63-B-64 and Replenishers B-63-B-64)

Working Stabilizers B-63-B-64 and Replenishers B-63-B-64 were prepared in the same manner as Working Stabilizer B-3 and Replenisher B-3 in Example 1, except that compound IV-9 was replaced with 1.5 mmol of IV-15 or 1.5 mmol of V-1 as indicated in Table 4.

<<Exposure, Photographic Processing, and Evaluation>>

Sample 101 prepared in Example.1 was exposed to light employing the method described in Example 1. Thereafter, Continuous Processes 2-1-2-10 were performed in the same manner as for Example 1, except that the stabilizer was replaced with each of the stabilizers prepared as above, followed by evaluation employing the methods described in Example 1. Table 4 shows the results.

TABLE 4

| | | | | | | Individual | | |
|---|---|---|---|---|---|---|---|---|
| | | | | | | Evaluation Result | | |
| | Stabilizer Composition | | | | | Foreign | | |
| | | Compound A | | | | Matter | Image | |
| | | | Addition | | | Adhesion | Retention | |
| | | | Amount | Formula | | Resistance | Property | Re- |
| *1 | No. | Type | (mmol) | (IV) | *2 | ΔDY | ΔDₘᵢₙ | marks |
| 2-1 | B-17 | I-4 | 1.2 | — | 45 | −0.07 | 0.10 | Inv. |
| 2-2 | B-18 | I-4 | 1.2 | IV-5 | 45 | −0.05 | 0.07 | Inv. |
| 2-3 | B-19 | I-4 | 1.2 | IV-12 | 45 | −0.05 | 0.07 | Inv. |
| 2-4 | B-20 | I-4 | 1.2 | IV-15 | 45 | −0.04 | 0.07 | Inv. |
| 2-5 | B-21 | I-4 | 1.2 | — | 80 | −0.12 | 0.17 | Comp. |
| 2-6 | B-22 | I-4 | 1.2 | IV-5 | 80 | −0.13 | 0.18 | Comp. |
| 2-7 | B-23 | I-4 | 1.2 | IV-12 | 80 | −0.14 | 0.18 | Comp. |
| 2-8 | B-24 | I-4 | 1.2 | IV-15 | 80 | −0.15 | 0.18 | Comp. |
| 2-9 | B-63 | — | — | IV-15 | 45 | −0.15 | 0.18 | Comp. |
| 2-10 | B-64 | — | — | V-1 | 45 | −0.14 | 0.19 | Comp. |

*1: Continuous Process No.,
*2: Ammonium Salt Ratio (%)
Inv.: Present Invention,
Comp.: Comparative Example

(Structure of V-1)

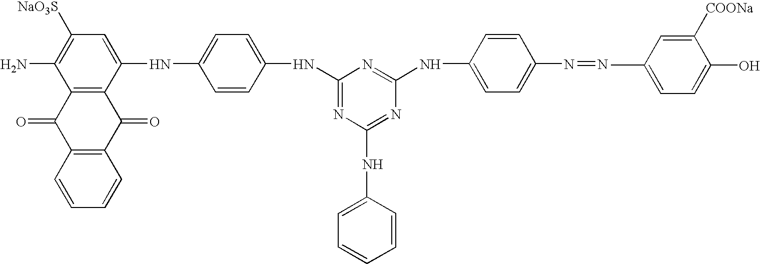

As can clearly be seen from the results described in Table 4, by incorporating the compound represented by Formula (IV) in the stabilizer incorporating the compound represented by Formula (I), in which the ammonium ion ratio was at most 50 percent with respect to the total incorporated cations, foreign matter adhesion resistance and image retention property were markedly improved.

### Example 3

Continuous processes 3-1-3-10 were performed in the same manner as Continuous Processes 1-24 and 1-26 of Example 1, except that each of the replenishment rates of Stabilizer Replenishers B-8 and B-10 was changed to the value listed in Table 5. Evaluation was carried-out employing the same methods as described in Example 1. Table 5 shows the results.

TABLE 5

| | | | | | | Individual Evaluation | | |
|---|---|---|---|---|---|---|---|---|
| | | | | | | Result | | |
| | Stabilizer Composition | | | | | Foreign | | |
| | | Compound A | | | | Matter | Image | |
| | | | Addition | | | Adhesion | Retention | |
| | | | Amount | | | Resistance | Property | Re- |
| *1 | No. | Type | (mmol) | *2 | *3 | ΔDY | ΔDₘᵢₙ | marks |
| 3-1 | B-8 | I-4 | 1.2 | 45 | 1000 | −0.04 | 0.06 | Inv. |
| 3-2 | B-8 | I-4 | 1.2 | 45 | 600 | −0.04 | 0.06 | Inv. |
| 3-3 | B-8 | I-4 | 1.2 | 45 | 400 | −0.04 | 0.07 | Inv. |
| 3-4 | B-8 | I-4 | 1.2 | 45 | 250 | −0.05 | 0.07 | Inv. |
| 3-5 | B-8 | I-4 | 1.2 | 45 | 120 | −0.04 | 0.07 | Inv. |
| 3-6 | B-10 | I-4 | 1.2 | 80 | 1000 | −0.09 | 0.09 | Comp. |
| 3-7 | B-10 | I-4 | 1.2 | 80 | 600 | −0.10 | 0.11 | Comp. |
| 3-8 | B-10 | I-4 | 1.2 | 80 | 400 | −0.13 | 0.16 | Comp. |
| 3-9 | B-10 | I-4 | 1.2 | 80 | 250 | −0.14 | 0.18 | Comp. |
| 3-10 | B-10 | I-4 | 1.2 | 80 | 120 | −0.19 | 0.24 | Comp. |

*1: Continuous Process No.,
*2: Ammonium Salt Ratio (%)
*3: Stabilizer Replenishment Rate (ml/m²)
Inv.: Present Invention,
Comp.: Comparative Example

As can clearly be seen from the results described in Table 5, even though the continuous process was performed at a low replenishment condition such as a replenishment rate of at most 400 ml/m²₁ the stabilizers of the present invention, which incorporated the compound represented by Formula (I) and in which the ammonium ion ratio was at most 50 percent with respect to the total incorporated cations, resulted in no degradation of image retention characteristics while maintaining he desired effects of foreign matter adhesion resistance, whereby stable performances were achieved even at low replenishment.

### Example 4

Working Stabilizers B-25-B-46 and Replenishers B-25-B-46 were prepared in-the same manner as Working Stabilizer B-8 and Replenisher B-8 as well as Working Stabilizer B-10 and Replenisher B-10 described in Example 1, except that Exemplified Compound I-4, being Compound A, was replaced with each of the exemplified compounds described in Table 6 in an amount of the same mol.

<<Exposure, Photographic Processing, and Evaluation>>

Sample 101 prepared in Example 1 was exposed to light employing the method described in Example 1. Thereafter,. Continuous Processes 4-1-4-25 were performed in the same manner as Example 1 employing Stabilizers 8 and 10 prepared in Example 1, as well as each of the-stabilizers prepared as above, followed by evaluation employing the methods described in Example 1. Table 6 shows the results.

TABLE 6

| | | | | | Individual | | |
|---|---|---|---|---|---|---|---|
| | | | | | Evaluation Result | | |
| | Stabilizer Composition | | | | Foreign | | |
| | | Compound A | | | Matter | Image | |
| | | | Addition | | Adhesion | Retention | |
| | | | Amount | | Resistance | Property | Re- |
| *1 | No. | Type | (mmol) | *2 | ΔDY | ΔDₘᵢₙ | marks |
| 4-1 | B-3 | — | — | 45 | −0.14 | 0.19 | Comp. |
| 4-2 | B-8 | I-4 | 1.2 | 45 | −0.05 | 0.07 | Inv. |
| 4-3 | B-10 | I-4 | 1.2 | 80 | −0.14 | 0.18 | Comp. |
| 4-4 | B-25 | I-14 | 1.2 | 45 | −0.06 | 0.08 | Inv. |
| 4-5 | B-26 | I-14 | 1.2 | 80 | −0.15 | 0.18 | Comp. |
| 4-6 | B-27 | II-3 | 1.2 | 45 | −0.04 | 0.05 | Inv. |
| 4-7 | B-28 | II-3 | 1.2 | 80 | −0.14 | 0.17 | Comp. |
| 4-8 | B-29 | II-34 | 1.2 | 45 | −0.03 | 0.05 | Inv. |
| 4-9 | B-30 | II-34 | 1.2 | 80 | −0.14 | 0.17 | Comp. |
| 4-10 | B-31 | III-1 | 1.2 | 45 | −0.04 | 0.05 | Inv. |
| 4-11 | B-32 | III-1 | 1.2 | 80 | −0.15 | 0.17 | Comp. |
| 4-12 | B-33 | III-12 | 1.2 | 45 | −0.04 | 0.04 | Inv. |
| 4-13 | B-34 | III-12 | 1.2 | 80 | −0.15 | 0.16 | Comp. |
| 4-14 | B-35 | II-1-2 | 1.2 | 45 | −0.02 | 0.02 | Inv. |
| 4-15 | B-36 | II-1-2 | 1.2 | 80 | −0.14 | 0.17 | Comp. |
| 4-16 | B-37 | II-1-10 | 1.2 | 45 | −0.02 | 0.01 | Inv . |
| 4-17 | B-38 | II-1-10 | 1.2 | 80 | −0.14 | 0.16 | Comp. |
| 4-18 | B-39 | II-2-8 | 1.2 | 45 | −0.02 | 0.02 | Inv. |
| 4-19 | B-40 | II-2-8 | 1.2 | 80 | −0.14 | 0.17 | Comp. |
| 4-20 | B-41 | II-3-3 | 1.2 | 45 | −0.02 | 0.01 | Inv. |
| 4-21 | B-42 | II-3-3 | 1.2 | 80 | −0.13 | 0.16 | Comp. |
| 4-22 | B-43 | II-3-7 | 1.2 | 45 | −0.02 | 0.02 | Inv. |
| 4-23 | B-44 | II-3-7 | 1.2 | 80 | −0.13 | 0.16 | Comp. |
| 4-24 | B-45 | II-4-2 | 1.2 | 45 | −0.01 | 0.01 | Inv. |
| 4-25 | B-46 | II-4-2 | 1.2 | 80 | −0.14 | 0.16 | Comp. |

*1: Continuous Process No.,
*2: Ammonium Salt Ratio (%)
Inv.: Present Invention,
Comp.: Comparative Example

As can clearly be seen from the results described in Table 6, even though the compound represented by Formula (I) was replaced with the compound represented by Formulas (II) and (III) or Formulas (II-1)-(II-4), excellent effects were similarly exhibited of enhanced foreign matter adhesion resistance and image retention property. Specifically, it can be seen that the use of the compound represented by Formulas (II-1)-(II-4) enhanced the above effects.

### Example 5

<<Preparation of Stabilizer>>

Stabilizers B-47-B-60 were prepared in the same manner as Stabilizers B-8 and B-10 described in Example 1, except that the type of Compound A and the addition-amount were changed as described in Table 7.

<<Evaluation of Crystallization>>

Placed in a Petri-dish (at a diameter of 60 mm) was 5 ml of each of the stabilizers prepared as above, and was dried at normal temperature (being 25° C. and 50 percent relative humidity) without covering. The formed solid state was visually observed, and crystallization was evaluated based on the criteria below.

Evaluation Criteria

A: solids were formed in the form of a layer on the bottom
B: slightly crystallized solids were uniformly formed on the bottom,
C: crystallized solids were formed on one surface
D: crystallized solids were formed and resulted in large crystals

Table 7 shows the results.

TABLE 7

| Stabilizer Composition | | | | | |
|---|---|---|---|---|---|
| | Compound A | | | | |
| | | Addition | Ammonium | | |
| | | Amount | Salt | Crystallization | |
| No. | Type | (mmol) | Ratio (%) | Evaluation | Remarks |
| B-47 | — | — | 45 | D | Comp. |
| B-48 | I-4 | 0.5 | 45 | C | Inv. |
| B-49 | I-4 | 0.5 | 80 | D | Comp. |
| B-50 | II-3 | 0.5 | 45 | B | Inv. |
| B-51 | III-1 | 0.5 | 45 | B | Inv. |
| B-52 | II-1-2 | 0.5 | 45 | A | Inv. |
| B-53 | II-2-8 | 0.05 | 45 | C | Inv. |
| B-54 | II-2-8 | 0.10 | 45 | B | Inv. |
| B-55 | II-2-8 | 0.30 | 45 | B | Inv. |
| B-56 | II-2-8 | 0.50 | 45 | A | Inv. |
| B-57 | II-2-8 | 8.0 | 45 | A | Inv. |
| B-58 | II-2-8 | 12.0 | 45 | B | Inv. |
| B-59 | II-2-8 | 18.0 | 45 | B | Inv. |
| B-60 | II-2-8 | 23.0 | 45 | C | Inv. |
| B-61 | II-3-3 | 0.5 | 45 | A | Inv. |
| B-62 | II-4-2 | 0.5 | 45 | A | Inv. |

As can clearly be seen from the results described in Table 7, the stabilizers constituted as specified by the present invention resulted in weak crystallization compared to Comparative Examples, and of these, stabilizers employing the compounds represented by Formulas (II-1)-(II-4) resulted in a low degree of crystallization. This result exhibits high correlation with the foreign matter adhesion resistance described in Table 6.

Namely, the formed state of adhesion substances of the present experiment implies that in the case of a continuous process, a decrease in maximum density results. Consequently, it is easy to judge the effects of the present invention employing the present experiments and it is also possible to monitor the state of formed solid substances of the stabilizer, which are formed on the rack boundary surface of an automatic processor, whereby the described effects of the present invention are more clearly exhibited.

Further, based on results, it is noted that the addition amount of the compounds according to the present invention is preferably 0.1 mmol-20 mmol per liter in the used state of the stabilizer, but is more preferably 0.5 mmol-10 mmol per liter.

### Example 6

Each of the stabilizer compositions (each of the additives except for water were employed) of Stabilizer Type B of the present invention described in Examples 1-4 was subjected to preparation of solid processing agents based on the following steps. As a result, it was possible to prepare a tablet-shaped solid processing agent of each of them without any problems. Further, based on the results of Example 1, even though additives (for example, polyethylene glycol) necessary for solid processing agents, were added, the effects of the present invention were sufficiently exhibited.

<Preparation of Solid Processing Agents>>

(Step 1)

In a humidity controlled room, 1,000 times the formulated amount of each additive described in Examples 1-4 was collected. Subsequently, each of the weighed additives was charged into REDIGE MIXER (registered trade name; Type M-20), produced by Matsuzaka Giken Co. and pre-mixing was performed for 30 seconds at a mixer rotation of 250 rpm and a chopper rotation of 2,500 rpm.

(Step 2)

Subsequently, while heating the REDIGE MIXER by circulating water at 70° C. in the water jacket, kneading was performed at a mixer rotation of 250 rpm so that the granulation temperature reached 55° C. to melt binders, and particles completed their growth.

(Step 3)

Subsequently, while cooling the REDIGE MIXER by circulating 20° C. water at in a water jacket, mixing was performed at a mixer rotation of 250 rpm until the granulation temperature reached 40° C., and then 200 g of sodium 1-octanesulfonate was added. Thereafter, the resulting mixture was mixed for 30 seconds at mixer rotation of 250 rpm, whereby a granulated agent was prepared.

(Step 4)

A stabilizer tablet agent for color paper was prepared by making tablets employing TOUGH PRESS COLLECT 1527HU (being a tablet machine), produced by Kikusui. Seisakusho, Ltd. The weight per tablet was set at 7.0 g. Tableting conditions were set at a main pressure of 98 MPa and a sub-pressure of 78 MPa at a turntable rotation of 10 rpm, employing 9 cylindrical pestles.

What is claimed is:

1. A stabilization processing composition for processing a silver halide light-sensitive color photographic material,
wherein the stabilization processing composition comprises a compound represented by Formula (I); and a molar ratio of ammonium ions in the stabilization processing composition to a total mole of cations in the stabilization processing composition is less than 50 mol %: 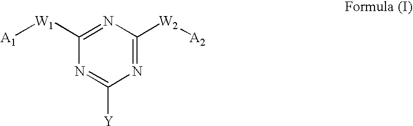
wherein A₁ and A₂ each independently represents a hydrogen atom, a halogen atom, an aryl group, a heterocyclic group, or an alkyl group; Y represents a hydrogen atom, a thiol group, a halogen atom, a carboxyl group, a sulfo group, a hydroxylamino group, —NR₁R₂, —SR₃, or —OR₃; W, represents a single bond, —O—, —S—, or —NR₄—; W₂ represents —O—, —S—, or —NR₄—; and R₁, R₂, R₃, and R₄ each independently represents a hydrogen atom, an alkyl group, an alkenyl group, an aryl group, or a heterocyclic group, provided that each pair of R₁ and R₂, R₄ and A₁, and R₄ and A₂ may be bonded to form a ring, and the compound represented by Formula (I) does not comprise an azo group or a diaminostilbene group in the molecule.

2. The stabilization processing composition of claim 1,
wherein the compound represented by Formula (I) is further represented by Formula (II) or Formula (III): 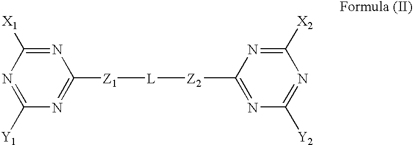
wherein X₁, X₂, Y₁ and Y₂ each independently represents —N(R₁)R₂, —OR₃, —SR₃, a heterocyclic group, a hydroxyl group, a hydroxylamino group, or a halogen atom; Z₁ and Z₂ each independently represents —NR₄—, —O—, or —S—; L represents an arylene group, an alkylene group, an alkenylene group, or a heterocyclic group; R₁ and R₂ each independently represents a hydrogen atom, an alkyl group, an aryl group, or a heterocyclic group; R₃ represents an alkyl group, an aryl group, or a heterocyclic group; and R₄ represents a hydrogen atom, an aryl group, a heterocyclic group, or an alkyl group, provided that R₁ and R₂ may be bonded to form a nitrogen-containing ring, and the compound represented by Formula (II) does not comprise an azo group or a diaminostilbene group in the molecule, 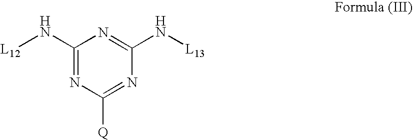
wherein L₁₂ and L₁₃ each independently represents an aryl group or a heterocyclic group; Q represents a hydrogen atom, a thiol group, a carboxyl group, a sulfo group, —NR₅R₆, —OR₇, a hydroxylamino group, or a halogen atom; and R₅, R₆ and R₇ each independently represents a hydrogen atom, an alkyl group, an aryl group, or a heterocyclic group, provided that R₅ and R₆ may be bonded to form a ring, and the compound represented by Formula (III) comprises at least-one of the groups consisting of —SO₃M, —CO₂M, and —OH, wherein M represents a hydrogen atom, an alkaline metal ion, an ammonium ion or a pyridinium ion, and the compound represented by Formula (III) does not comprise an azo group or a diaminostilbene group in the molecule.

3. The stabilization processing composition of claim 2,
wherein the compound represented by Formula (II) is further represented by one of Formulas (II-1)-(II-4): 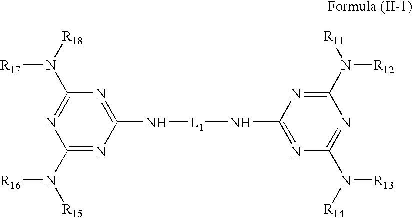
wherein R₁₁-R₁₈ each independently represents a hydrogen atom, an alkyl group, an aryl group, or a heterocyclic group; L₁ represents a phenylene group or a naphthylene group, provided that at least 3 of R₁₁-R₁₈ are aryl groups, and each pair of R₁₁ and R₁₂, R₁₃ and R₁₄, R₁₅ and R₁₆, and R₁₇ and R₁₈ may be bonded to form a ring, and the compound represented by Formula (II-1) comprises at least one of the groups consisting of —SO₃M, —CO₂M, and —OH, wherein M represents an alkaline metal ion, or an ammonium ion, and the compound represented by Formula (II-1) does not comprise an azo group or a diaminostilbene group in the molecule,. 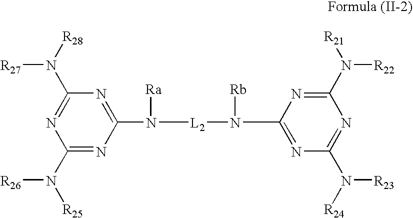
wherein R₂₁-R₂₈ each independently represent a hydrogen atom, an alkyl group, an aryl group, or a heterocyclic group; L₂ represents a phenylene group, a naphthylene group, an alkylene group, or a heterocyclic group; Ra represents an alkyl group, an aryl group, or a heterocyclic group; and Rb represents a hydrogen atom, an alkyl group, or an aryl group, provided that each pair of R₂₁ and R₂₂, R₂₃ and R₂₄, R₂₅ and R₂₆, and R₂₇ and R₂₈ may be bonded to form a ring, and the compound represented by Formula (II-2) comprises at least one of the groups consisting of —SO₃M, —CO₂M, and —OH, wherein M represents an alkaline metal ion, or an ammonium ion, and the compound represented by Formula (II-2) does not comprise an azo group or a diaminostilbene group in the molecule, 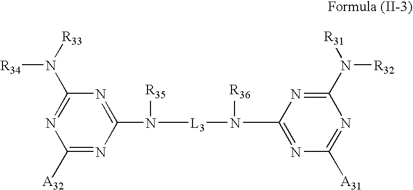
wherein R₃₁-R₃₄ each independently represents a hydrogen atom an alkyl group, an aryl group, or a heterocyclic group; L₃ represents a phenylene group, a naphthylene group, an alkylene group, or a heterocyclic group; A₃₁ and A₃₂ each independently represents an alkoxy group an aryloxy group, a heterocyclic oxy group, an alkylthio group, an arylthio group, a heterocyclic thio group, or a hydroxylamino group; and R₃₅ and R₃₆ each independently represents a hydrogen atom, an alkyl group, an aryl group or a heterocyclic group, provided that each pair of R₃₁ and R₃₂, and R₃₃ and R₃₄ may be bonded to form a ring, and the compound represented by Formula (II-3) comprises at least one of the groups consisting of —SO₃M, —CO₂M, and —OH, wherein M represents an alkaline metal ion, or an ammonium ion, and the compound represented by Formula (II-3) does not comprise an azo group or a diaminostilbene group in the molecule, 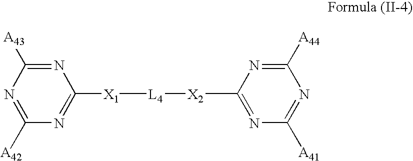
wherein L₄ represents a phenylene group, a naphthylene group, or an alkylene group; X₁ represents an oxygen atom or a sulfur atom; X₂ represents an oxygen atom, a sulfur atom, or —NH—; and A₄₁, A₄₂, A₄₃, and A₄₄ each independently represent an alkoxy group, an aryloxy group, a heterocyclic oxy group, an alkylthio group, an arylthio group, a heterocyclic thio group, a hydroxylamino group, or —NR₄₁R₄₂, R₄₁ and R₄₂ each independently representing a hydrogen atom, an alkyl group, an aryl group, or a heterocyclic group, provided that R₄₁ and R₄₂ may be bonded to form a ring, and the compound represented by Formula (II-4) comprises at least one of the groups consisting of —SO₃M, —CO₂M, and —OH, wherein M represents an alkaline metal ion, or an ammonium ion, and the compound represented by Formula (II-4) does not comprise an azo group or a diaminostilbene group in the molecule.

4. A stabilizing processing solution for a working solution, comprising the stabilization processing composition of claim 1,
wherein an amount of the compound represented by. Formula (I) is from 0.1 to 20 mmol per liter.

5. The stabilization processing composition of claim 1, further comprises a compound represented by Formula (IV): 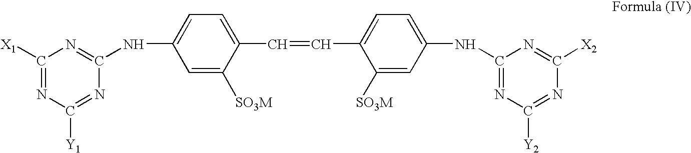
wherein X₁, X₂, Y₁, and Y₂ each represents a hydroxyl group, a halogen atom, a morpholino group, an alkoxy group, an aryloxy group, an alkyl group, an aryl group, an amino group, an alkylamino group, or an arylamino group; and M represents a hydrogen atom, sodium, potassium, ammonium, or lithium.

6. The stabilization processing composition of claim 1, wherein said stabilization processing composition is in a form of a solid processing agent.

7. A method of processing an exposed silver halide light-sensitive color photographic material comprising the steps of:
(a) developing the exposed silver halide light-sensitive color photographic material with a color developer;
(b) desilvering the developed silver halide light-sensitive color photographic material with a bleach-fixing solution, or a combination of a bleach solution and a fixing solution; and
(c) stabilizing the desilvered silver halide light-sensitive color photographic material with a stabilizing processing solution,
wherein the stabilizing processing solution comprises a compound represented by Formula (I); a molar ratio of ammonium ions in the stabilization processing solution to a total mole of cations in the stabilization processing solution is less than 50 mol %; and a replenishment rate of a stabilizer replenisher for the stabilizing step is not more than 400 ml per m² of the silver halide light-sensitive color photographic material: 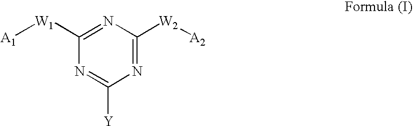
wherein A₁ and A₂ each independently represents a hydrogen atom, a halogen atom, an aryl group, a heterocyclic group, or an alkyl group; Y represents a hydrogen atom, a thiol group, a halogen atom, a carboxyl group, a sulfo group, a hydroxylamino group, —NR₁R₂, —SR₃, or —OR₃; W₁ represents a single bond, —O—, —S—, or —NR₄—; W₂ represents —O—, —S—, or —NR₄—; and R₁, R₂, R₃, and R₄ each independently represents a hydrogen atom, an alkyl group, an alkenyl group, an aryl group, or a heterocyclic group, provided that each pair of R₁ and R₂, R₄ and A₁, and R₄ and A₂ may be bonded to form a ring, and the compound represented by Formula (I) does not comprise an azo group or a diaminostilbene group in the molecule.

8. The method of a silver halide light-sensitive color photographic material of claim 7,
wherein the compound represented by Formula (I) is further represented by Formula (II) or Formula (III): 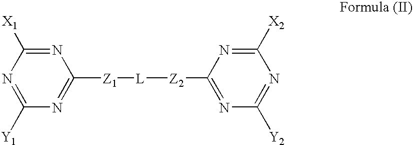
wherein X₁, X₂, Y₁ and Y₂ each independently represents —N(R₁)R₂, —OR₃, —SR₃, a heterocyclic group, a hydroxyl group, a hydroxylamino group, or a halogen atom; Z₁ and Z₂ each independently represents —NR₄—, —O—, or —S—; L represents an arylene group, an alkylene group, an alkenylene group, or a heterocyclic group; R₁ and R₂ each independently represents a hydrogen atom, an alkyl group, an aryl group, or a heterocyclic group; R₃ represents an alkyl group, an aryl group, or a heterocyclic group; and R₄ represents a hydrogen atom, an aryl group, a heterocyclic group, or an alkyl group, provided that R₁ and R₂ may be bonded to form a nitrogen-containing ring, and the compound represented by Formula (II) does not comprise an azo group or a diaminostilbene group in the molecule, 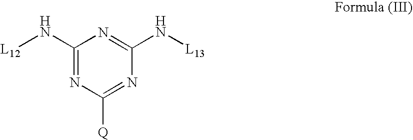
wherein L₁₂ and L₁₃ each independently represents an aryl group or a heterocyclic group; Q represents a hydrogen atom, a thiol group, a carboxyl group, a sulfo group, —NR₅R₆, —OR₇, a hydroxylamino group, or a halogen atom; and R₅, R₆ and R₇ each independently represents a hydrogen atom, an alkyl group, an aryl group, or a heterocyclic group, provided that R₅ and R₆ may be bonded to form a ring, and the compound represented by Formula (III) comprises at least one of the groups consisting of —SO₃M, —CO₂M, and —OH, wherein M represents a hydrogen atom, an alkaline metal ion, an ammonium ion or a pyridinium ion, and the compound represented by Formula (III) does not comprise an azo group or a diaminostilbene group in the molecule.

9. The method of a silver halide light-sensitive color photographic material of claim 8,
wherein the compound represented by Formula (II) is further represented by one of Formulas (II-1)-(II-4,): 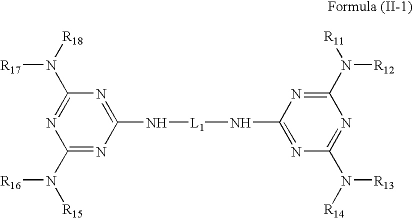
wherein R₁₁-R₁₈ each independently represents a hydrogen atom, an alkyl group, an aryl group, or a heterocyclic group; L₁ represents a phenylene group or a naphthylene group, provided that at least 3 of R₁₁-R₁₈ are aryl groups, and each pair of R₁₁ and R₁₂, R₁₃ and R₁₄, R₁₅ and R₁₆, and R₁₇ and R₁₈ may be bonded to form a ring, and the compound represented by Formula (II-1) comprises at least-one of the groups consisting of —SO₃M, —CO₂M, and —OH, wherein M represents an alkaline metal ion, or an ammonium ion, and the compound represented by Formula (II-1) does not comprise an azo group or a diaminostilbene group in the molecule, 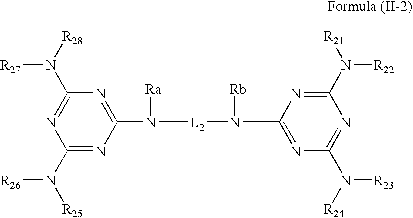
wherein R₂₁-R₂₈ each independently represent a hydrogen atom, an alkyl group, an aryl group, or a heterocyclic group; L₂ represents a phenylene group, a naphthylene group, an alkylene group, or a heterocyclic group; Ra represents an alkyl group, an aryl group, or a heterocyclic group; and Rb represents a hydrogen atom, an alkyl group, or an aryl group, provided that each pair of R₂₁ and R₂₂, R₂₃ and R₂₄, R₂₅ and R₂₆, and R₂₇ and R₂₈ may be bonded to form a ring, and the compound represented by Formula (II-2) comprises at least one of the groups consisting of —SO₃M, —CO₂M, and —OH, wherein M represents an alkaline metal ion, or an ammonium ion, and the compound represented by Formula (II-2) does not comprise an azo group or a diaminostilbene group in the molecule, 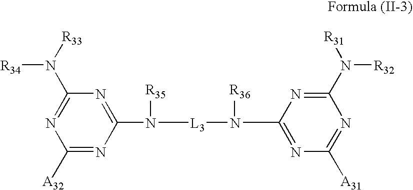
wherein R₃₁-R₃₄ each independently represents a hydrogen atom, an alkyl group, an aryl group, or a heterocyclic group; L₃ represents a phenylene group, a naphthylene group, an alkylene group, or a heterocyclic group; A₃₁ and A₃₂ each independently represents an alkoxy group, an aryloxy group, a heterocyclic oxy group, an alkylthio group, an arylthio group, a heterocyclic thio group, or a hydroxylamino group; and R₃₃ and R₃₆ each *independently represents a hydrogen atom, an alkyl group, an aryl group or a heterocyclic group, provided that each pair of R₃₁ and R₃₂, and R₃₃ and R₃₄ may be bonded to form a ring, and the compound represented by Formula (II-3) comprises at least one of the groups consisting of —SO₃M, —CO₂M, and —OH, wherein M represents an alkaline metal ion, or an ammonium ion, and the compound represented by Formula (II-3) does not comprise an azo group or a diaminostilbene group in the molecule, 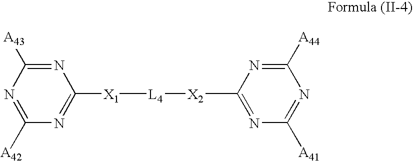
wherein L₄ represents a phenylene group, a naphthylene group, or an alkylene group; X₁ represents an oxygen atom or a sulfur atom; X₂ represents an oxygen atom, a sulfur atom, or —NH—; and A₄₁, A₄₂, A₄₃, and A₄₄ each independently represent an alkoxy group, an aryloxy group, a heterocyclic oxy group, an alkylthio group, an arylthio group, a heterocyclic thio group, a hydroxylamino group, or —NR₄₁R₄₂, R₄₁ and R₄₂ each independently representing a hydrogen atom, an alkyl group, an aryl group, or a heterocyclic group, provided that R₄₁ and R₄₂ may be bonded to form a ring, and the compound represented by Formula (II-4) comprises at least one of the groups consisting of —SO₃M, —CO₂M, and —OH, wherein M represents an alkaline metal ion, or an ammonium ion, and the compound represented by Formula (II-4) does not comprise an azo group or a diaminostilbene group in the molecule.
